(19) United States
(12) Patent Application Publication
(10) Pub. No.: US 2013/0184462 A1
(43) Pub. Date: Jul. 18, 2013

(54) METHOD FOR PREDICTING AND MODELING ANTI-PSYCHOTIC ACTIVITY USING VIRTUAL SCREENING MODEL

(71) Applicants: Santosh Kumar Srivastava, Lucknow (IN); Feroz Khan, Lucknow (IN); Shikha Gupta, Lucknow (IN); Dharmendra K. Yadav, Lucknow (IN); Vinay Kumar Khanna, Lucknow (IN)

(72) Inventors: Santosh Kumar Srivastava, Lucknow (IN); Feroz Khan, Lucknow (IN); Shikha Gupta, Lucknow (IN); Dharmendra K. Yadav, Lucknow (IN); Vinay Kumar Khanna, Lucknow (IN)

(73) Assignee: COUNCIL OF SCIENTIFIC & INDUSTRIAL RESEARCH, New Delhi (IN)

(21) Appl. No.: 13/876,658

(22) PCT Filed: Sep. 30, 2011
(86) PCT No.: PCT/IN11/00681

§ 371 Date: Mar. 28, 2013

(30) Foreign Application Priority Data
Sep. 30, 2010 (IN) 0768/DEL/2010

(51) Int. Cl. G06F 19/00

(52) U.S. Cl. CPC G06F 19/701
USPC 546/48; 703/2

(57) ABSTRACT

The present invention relates to the development of a virtual screening model for predicting antipsychotic activity using quantitative structure activity relationship (QSAR), molecular docking, oral bioavailability, ADME and Toxicity studies. The present invention also relates to the development of QSAR model using forward stepwise method of multiple linear regression with leave-one-out validation approach. QSAR model showed activity-descriptors relationship correlating measure (r²) 0.87 (87%) and predictive accuracy of 81% (rCV²=0.81). The present invention specifically showed strong binding affinity of the untested (unknown) novel compounds against anti-psychotic targets viz., Dopamine D2 and Serotonin (5HT_{2A}) receptors through molecular docking approach. Theoretical results were in accord with the in vitro and in vivo experimental data. The present invention further showed compliance of Lipinski's rule of five for oral bioavailability and toxicity risk assessment for all the active Yohimbine derivatives. Therefore, use of developed virtual screening model will definitely facilitate the screening of more effective antipsychotic leads/drugs with improved antipsychotic activity and also reduced the drug discovery cost and duration.

### FIELD OF THE INVENTION

The present invention relates to a method for predicting and modeling anti-psychotic activity using virtual screening model.

The present invention further relates to molecular modeling and drug design by quantitative structure activity relationship (QSAR) and molecular docking studies to explore the anti-psychotic compound from derivatives of plant molecules.

### BACKGROUND AND PRIOR ART OF THE INVENTION

Psychosis is one of the most dreaded disease of the 20^{th} century and spreading further with continuance and increasing incidences in 21^{st} century. Psychosis means abnormal condition of the mind. People suffering from psychosis are said to be psychotic. A wide variety of central nervous system diseases, from both external toxins, and from internal physiologic illness, can produce symptoms of psychosis. It is considered as an adversary of modernization and advanced pattern of socio-cultured life dominated by western medicine. Multidisciplinary scientific investigations are making best efforts to combat this disease, but the sure-shot perfect cure is yet to be brought in to world of medicine.

References may be made to patent application PCT/IN2010/000208, wherein Srivastava et. al. reported antipsychotic activity of some yohimbine group of alkaloids and here they wish to report virtual screening model for predicting antipsychotic activity. An explanation of conventional drug discovery processes and their limitations is useful for understanding the present invention.

Discovering a new drug to treat or cure some biological condition, is a lengthy and expensive process, typically taking on average 12 years and $800 million per drug, and taking possibly up to 15 years or more and $1 billion to complete in some cases. The process may include wet lab testing/experiments, various biochemical and cell-based assays, animal models, and also computational modeling in the form of computational tools in order to identify, assess, and optimize potential chemical compounds that either serve as drugs themselves or as precursors to eventual drug molecules. In order to avoid unnecessary animal scarifies in animal testing for drug discovery it is the need of hour to switch to virtual screening. Apart from saving animal life, cost, and time this is very fast, reliable and has become one of the essential component of modern drug discovery.

The first goal of a drug discovery process is to identify and characterize a chemical compound or ligand, i.e., binder, biomolecule, that affects the function of one or more other biomolecules (i.e., a drug “target”) in an organism, usually a receptor, via a potential molecular interaction or combination. Herein the term receptor refers to anti-psychotic receptors dopamine D2 and Seratonin (5HT_{2A}) and the term biomolecule refers to a chemical entity that comprises one or more of a organic chemical compound, including, but not limited to, synthetic, medicinal, drug-like, or natural compounds, or any portions or fragments thereof.

Prior to this invention, there have been no systematic methods for precisely and effectively predicting antipsychotic activity of organic compounds and their derivatives on a computer based bioassay system.

### OBJECTIVE OF THE INVENTION

Main objective of the present invention is to provide a method for predicting and modeling anti-psychotic activity using virtual screening model.

Another objective of the present invention is to provide pharmaceutical composition comprising of an antipsychotic agents in an amount effective to control psychosis.

Yet another objective of the present invention is to provide the yohimbine derivatives exhibit antipsychotic activity against dopaminergic-D₂ and Serotonergic (5HT_{2A}) receptors as well as amphetamine induced hyperactive mouse model.

Yet another objective of the present invention is to provide a process for the preparation of yohimbine derivatives.

### SUMMARY OF THE INVENTION

Accordingly, the present invention provides a computer aided method for predicting and modeling anti-psychotic activity of a test compound wherein the said method comprising:
i. validating training set descriptors comprising chemical and structural information of the known antipsychotic drugs/compounds through quantitative structure activity relationship (QSAR) model using the equation: Predicted log IC₅₀ (nM)=−0.124236×M+0.0305374×P+1.0651×V−0.0639271×AH−0.380434×AO+9.12642 Where in, M=Dipole Vector Z (debye), P=Steric Energy (kcal/mole), V=Group Count (ether) (V), AH=Molar Refractivity and AO=Shape Index (basic kappa, order 3) in a computational modeling system.
ii. providing training set descriptors comprising chemical and structural information of the training set compounds and experimental antipsychotic activity against selective antipsychotic targets to the computational modeling system of step (i) and obtaining virtual antipsychotic activity value (Log IC₅₀) of the test (known) and untested (unknown) compounds.
iii. performing molecular docking studies of the unknown novel compounds exhibiting anti psychotic activity as evaluated in step (ii) against antipsychotic targets using the computational modeling system of step (i).
iv. evaluating toxicity risk and physicochemical properties of the untested (unknown) compounds as evaluated in step (ii) using the computational modeling system of step (i).
v. evaluating oral bioavailability, absorption, distribution, metabolism and excretion (ADME) values of the untested (unknown) compounds evaluated in step (ii) using the computational modeling system of step (i) for drug likeness.
vi. outputting the values obtained in step (ii) to (v) to a computer recordable medium to predict anti-psychotically active untested compound.

In an embodiment of the present invention, the test compounds are selected from the group consisting of formula 1, formula 2, formula 3, formula 4 or formula 5

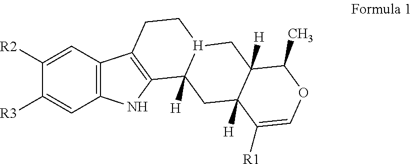

wherein R1 in formula 1=COOCH3(methyl ester);

R2 in formula 1 is selected from the group consisting of H, OH, OCH3, OCH2CH2CH3,

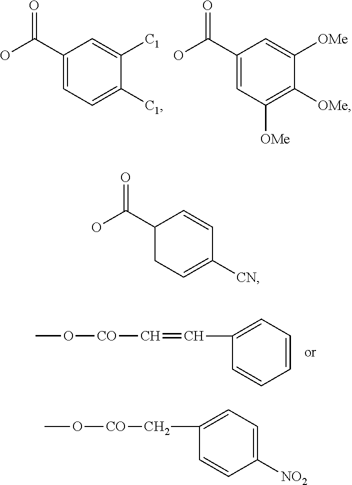

R3 in formula 1 is selected from the group consisting of H, OCO(CH2)10CH3, OCO(CH2)14CH3, OCO(CH)(CH3)3,

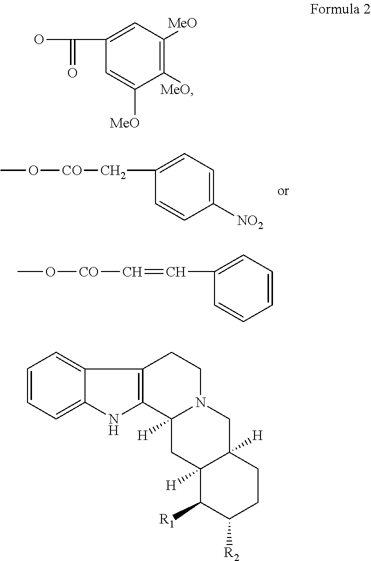

Wherein R₁ in formula 2 is selected from the group consisting of
—COOH, —COO—CH₃, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH —CO—NH—CH₂—CH₂—OCOCH₃, —CO—NH—CH₂—CH₂—OH, —CO—NH—CH₂—COO—CH₃, —CONH—CH₂—COO—CH₃, —CONH—CH₂—COOH, —CONH—CH₂—CH₂—OCOCH₃, —CONH—CH₂—CH₂—OH

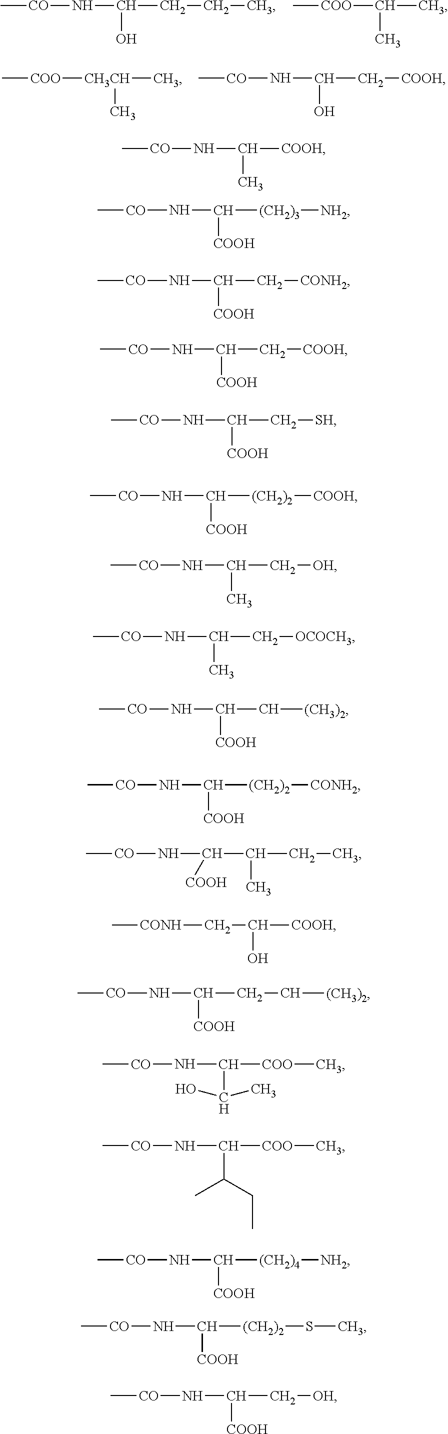

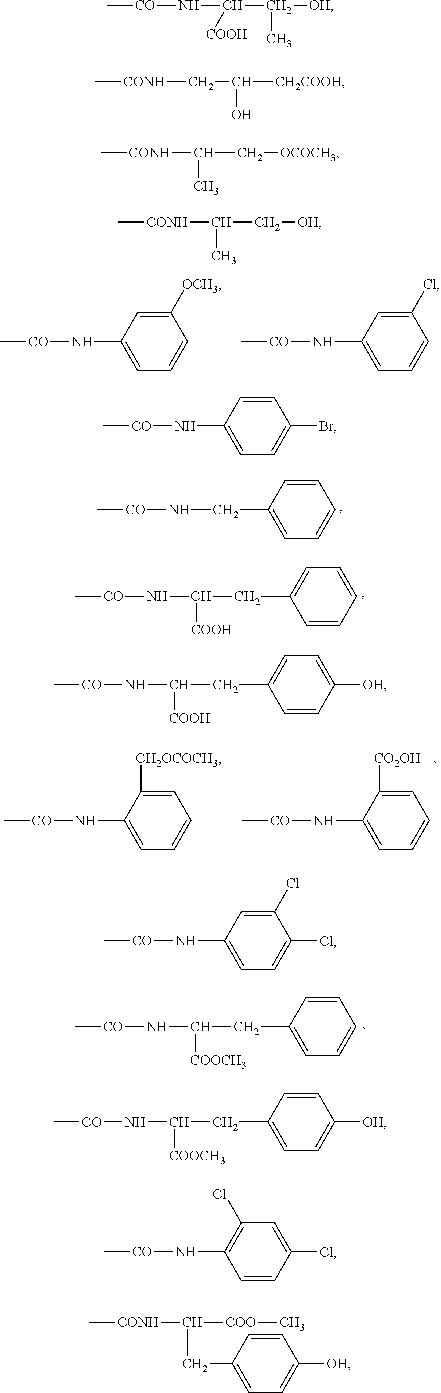

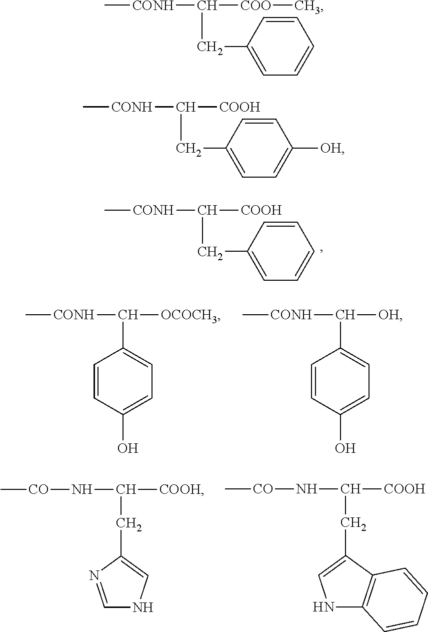

R₂ in formula 2 is selected from the group consisting of
—OH, —OCOCH₃, —OCOCH₂CH₃, —O—CH₂—CH₂—CO—Cl, —OCO—CH₂—(CH₂)₉—CH₃, —OCO—CH₂—(CH₂)₁₃—CH₃, —OCO—CH—(CH₃)₃, —OCO—COO—CH₂—CH₃, —OCO—CO—OH, —OCO—CH₂—CH₂—CH₂—CH₃, —OCO—CH₂—CH₂—CH₂—CH₂—CH₃, —OCO—CH₂—CH₂—CH₂—COOH, —OCO—CH₂—CH₂—CH₂—CH₂—NH₂, —OCO—CH₂—CH₂—SH, —OCO—CH₂—CH₂—COOH, —OCO—CH₂—CH₂—CONH₂, —OCO—CH₂—(CH₂)₄—NH₂, —OCO—CH₂—CH₂—CH₂—S—CH₃, —OCO—CH₂—CH₂—OCO—CH₃, —OCO—CH₂—CH₂—OH, —OCO—CH₂—COO—CH₃,

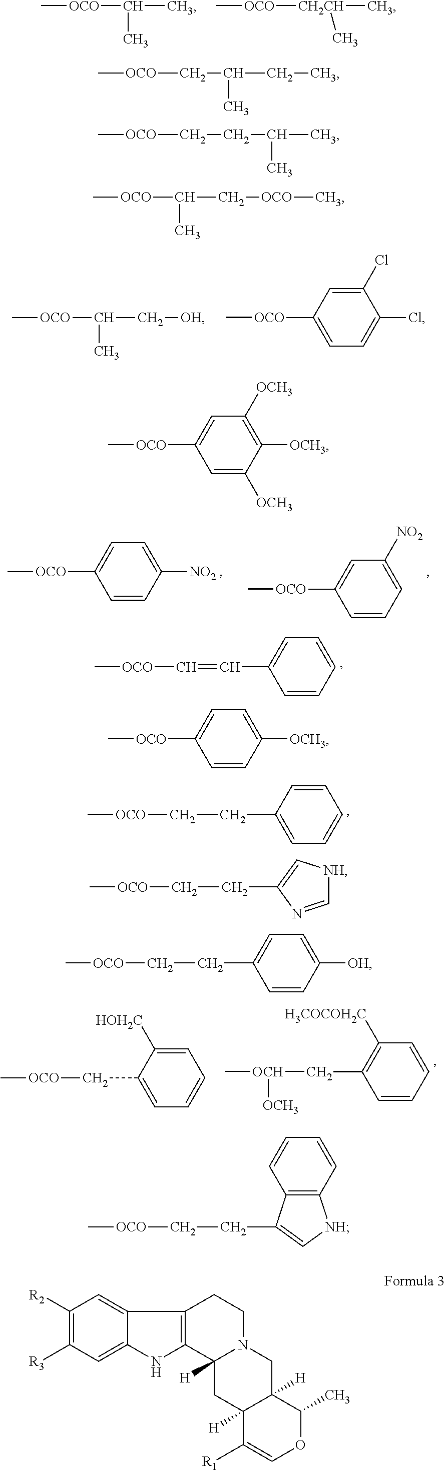

Wherein R₁ in formula 3 is selected from the group consisting of
—COOCH₃, —COOH, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH, —CO—NH—CH₂—CH₂—OCOCH₃, —CO—NH—CH₂—CH₂—OH, —CO—NH—CH₂—COO—CH₃,

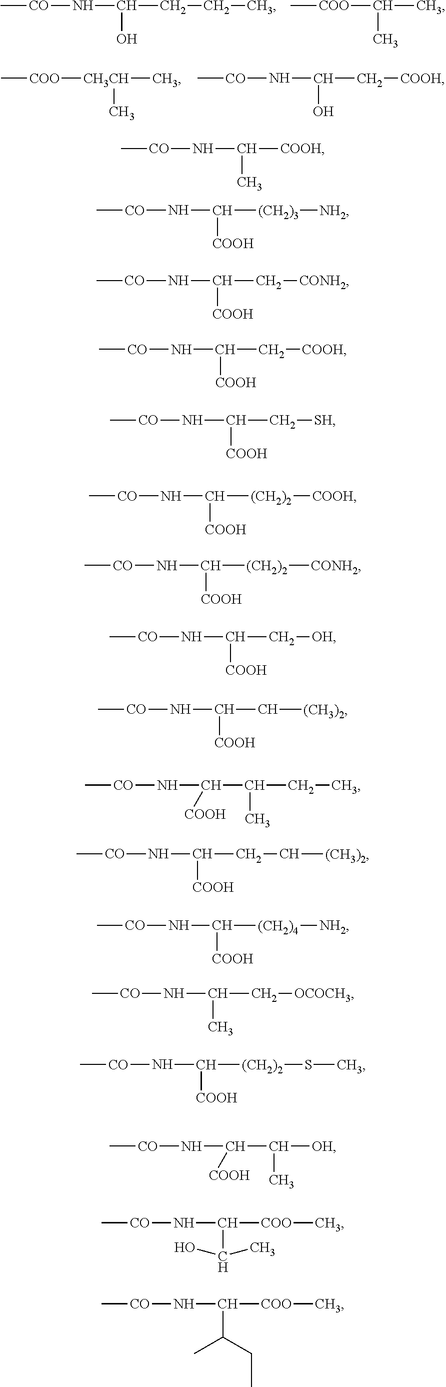

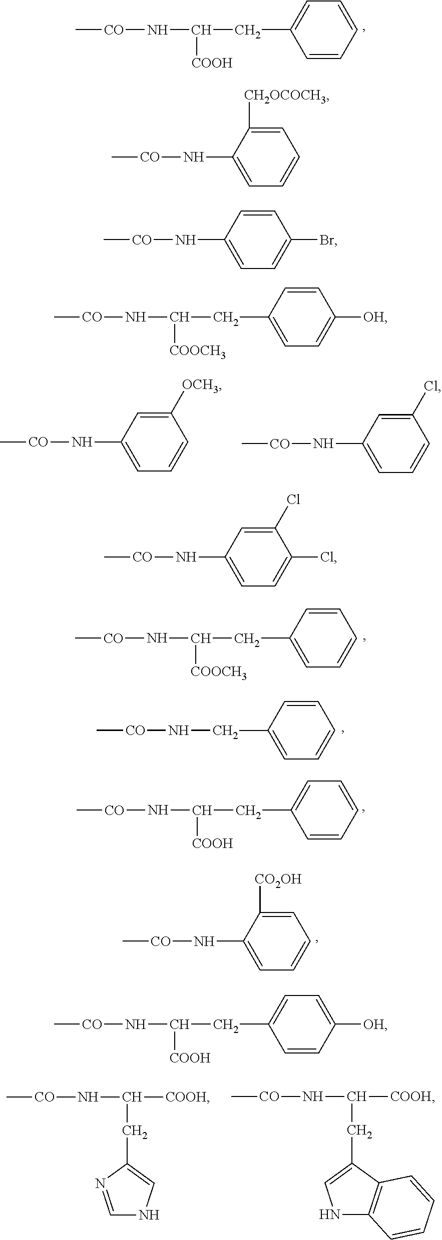

wherein R₂ in formula 3 is selected from the group consisting of
—OH, —OCH₃, —OCO—CH₂—(CH₂)₉—CH₃, —OCO—CH₂—(CH₂)₁₂—CH₃, —OCO—CH—(CH₃)₃, —OCO—CH₂—CH₂—CH₃,

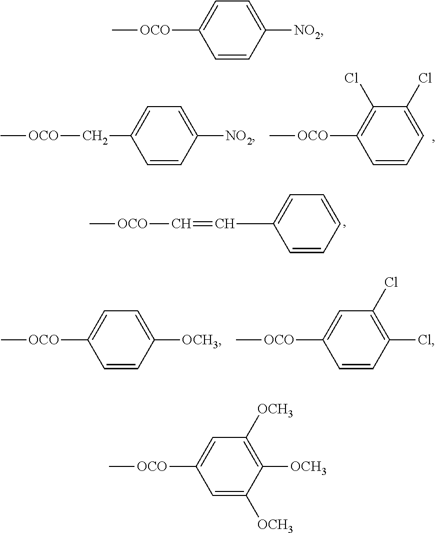

wherein R₃ in formula 3 is selected from the group consisting of
—OH, —OCH₃, —OCO—CH₂—(CH₂)₉—CH₃, —OCO—CH₂—(CH₂)₁₃—CH₃, —OCO—CH—(CH₃)₃—OCO—CH₂—CH₂—CH₃,

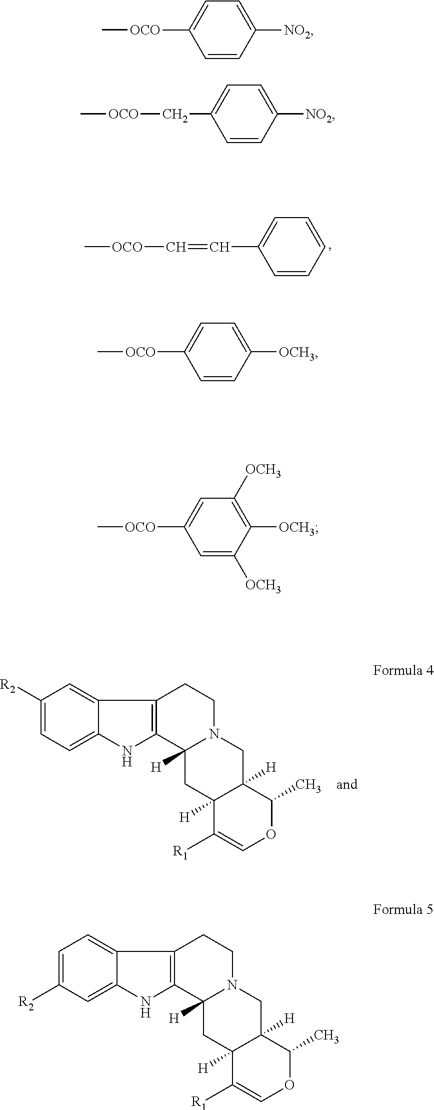

wherein R1 in formulae 4 and 5 is selected from the group consisting of
—COOCH₃, —COOH, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH, —CO—NH—CH₂—CH₂—OCOCH₃, —CO—NH—CH₂—CH₂—OH, —CO—NH—CH₂—COO—CH₃,

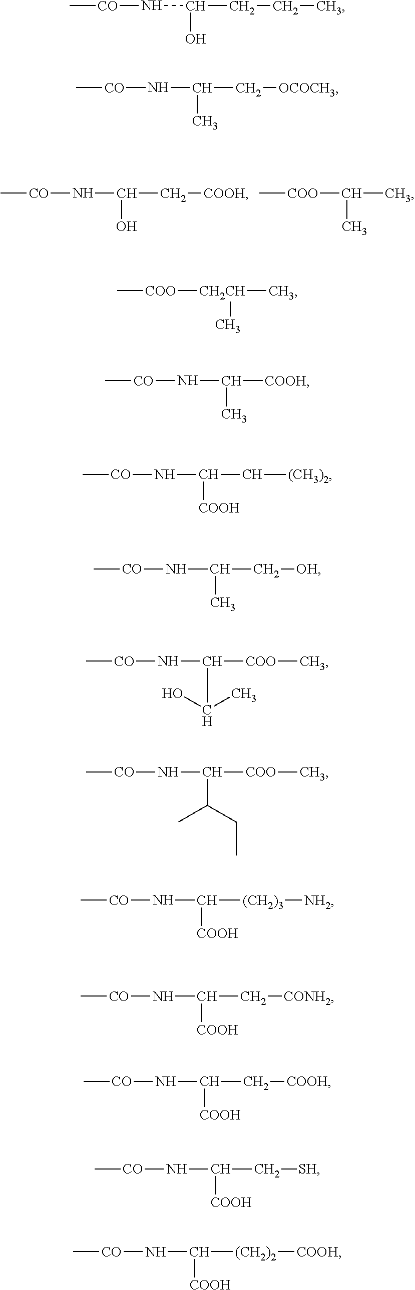

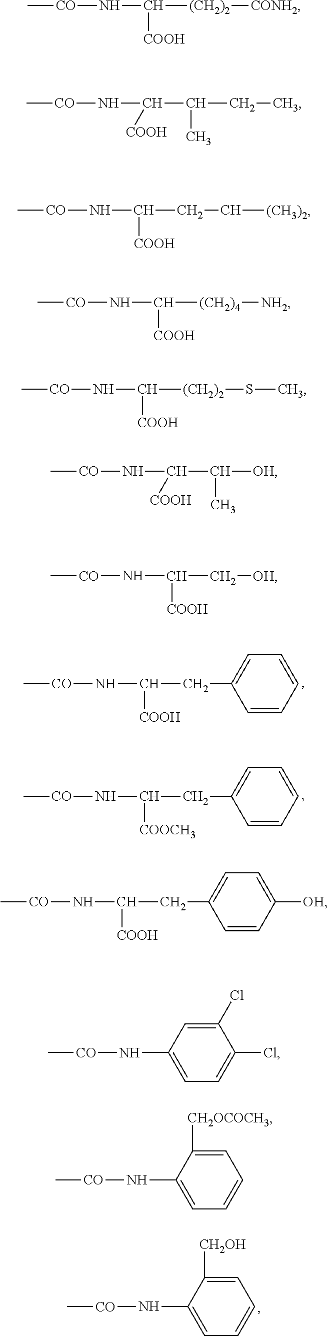

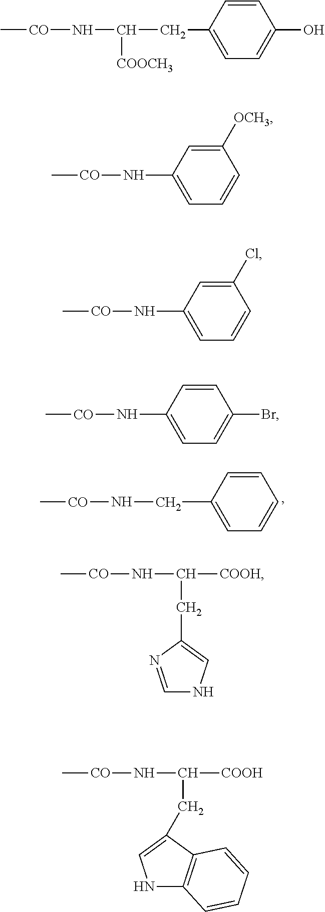

wherein R2 in formulae 4 and 5 is selected from the group consisting of
—OH, —OCH₃, —OCO—CH₂—CH₂—CH₃, —OCO—CH₂—(CH₂)₉—CH₃, —OCO—CH₂—(CH₂)₁₃—CH₃, —OCO—CH—(CH₃)₃,

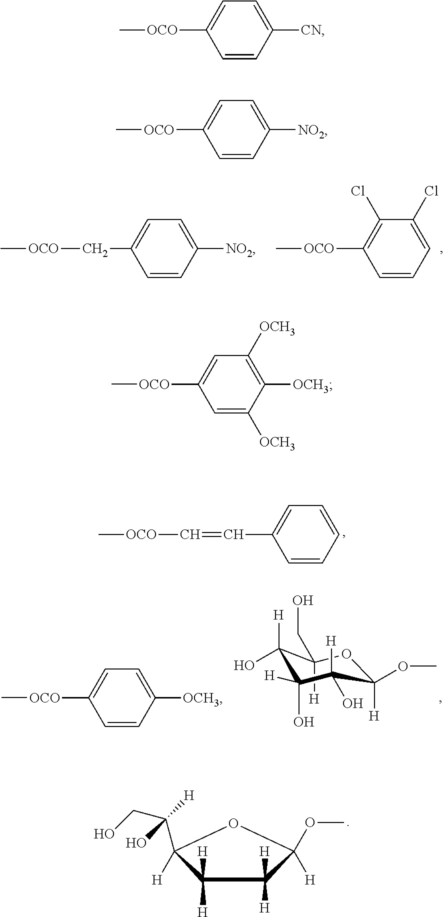

Yet another embodiment of the invention provides a compound of general formula 1 predicted and tested for antipsychotic activity by the method of the present invention is representated by:

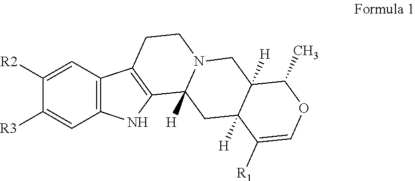

wherein R1=COOCH3(methyl ester);

### R2=H, OH, OCH3, OCH2CH2CH3,

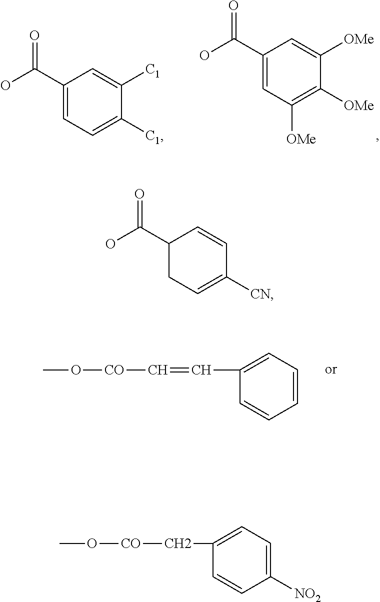

### R3=H, OCO(CH2)10CH3, OCO(CH2)14CH3, OCO(CH)(CH3)3,

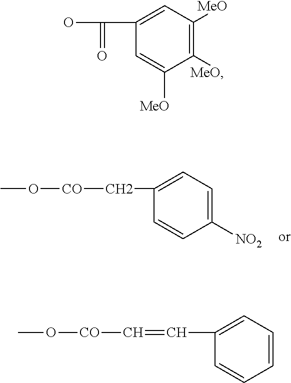

In yet another embodiment of the present invention, the predicted log(nM) IC₅₀ value of the compounds of general formula 1 is in the range of 3.154 to 4.589 showing antipsychotic activity and drug likeness similar to Clozapine.

In yet another embodiment of the present invention, training sets descriptors are selected from the group consisting of atom Count (all atoms), Bond Count (all bonds), Formal Charge, Conformation Minimum Energy (kcal/mole), Connectivity Index (order 0, standard), Dipole Moment (debye), Dipole Vector (debye), Electron Affinity (eV), Dielectric Energy (kcal/mole), Steric Energy (kcal/mole), Total Energy (Hartree), Group Count (aldehyde), Heat of Formation (kcal/mole), highest occupied molecular orbital (HOMO) Energy (eV), Ionization Potential (eV), Lambda Max Visible (nm), Lambda Max UV-Visible (nm), Log PLUMO Energy (eV), Molar Refractivity, Molecular Weight Polarizability, Ring Count (all rings), Size of Smallest Ring, Size of Largest Ring, Shape Index (basic kappa, order 1) and Solvent Accessibility Surface Area (angstrom square). In yet another embodiment of the present invention, known antipsychotic drugs are selected from the group consisting of Bepridil, Cisapride, Citalopram, Desipramine, Dolasetron, Droperidol, E-4031, Flecainide, Fluoxetine, Granisetron, Haloperidol, Imipramine, Mesoridazine, Prazosin, Quetiapine, Risperidone, Gatifloxacin, Terazosin, Thioridazine, Vesnarinone, Mefloquine, Sparfloxacin, Ziprasidone, Norastemizole, Tamsulosinc levofloxacin, Moxifloxacin, Cocaine, Clozapine, Doxazosin.

In yet another embodiment of the present invention, antipsychotic targets are selected from Dopamine D2 and Serotonin (5HT_{2A}) receptors.

In yet another embodiment of the present invention, the risk assessment includes mutagenicity, tumorogenicity, irritation and reproductive toxicity.

In yet another embodiment of the present invention, physiochemical properties are ClogP, solubility, drug likeness and drug score.

In yet another embodiment of the present invention, test compounds show >60% inhibition in amphetamine induced hyperactivity mice model at 25 mg/kg.

### BRIEF DESCRIPTION OF THE DRAWINGS

FIG. 1: Multiple linear regression plot for yohimbine alkaloid derivatives showing comparison of QSAR model based predicted and experimental antipsychotic activities.

FIG. 2: Antipsychotic activity of isolated yohimbine alkaloids (K001 to K006) from the leaves of Rauwolfia tetraphylla.

FIG. 3: In-vitro antipsychotic activity of semi-synthetic derivatives (K001A to K001G) of α yohimbine wherein values are mean of three assays in each case.

FIG. 4: In-vivo antipsychotic activity of semi-synthetic derivatives (K001A to K001G) of α-yohimbine wherein values are mean of five animals in each group. % Inhibition calculated with respect to amphetamine induced hyperactivity and no EPS observed at any of the dose.

FIG. 5: In-vitro antipsychotic activity of semi-synthetic derivatives of α-yohimbine (K001A, K001C and K001F) at 12 to 100 μg concentrations.

FIG. 6: In-vivo antipsychotic activity of semi-synthetic derivatives of α-yohimbine (K001A, K001C and K001F) at 6.25 to 12.5 mg/kg concentrations.

### DETAILED DESCRIPTION OF THE INVENTION

The present invention provides a computer aided method for predicting and modeling anti-psychotic activity of a test compound using virtual screening model. Molecular modeling and drug design to explore the anti-psychotic compound from derivatives of plant molecules, a quantitative structure activity relationship (QSAR) and molecular docking studies were performed. Theoretical results are in accord with the in vivo experimental data. Anti-psychotic activity was predicted through QSAR model developed by forward stepwise method of multiple linear regression using leave-one-out validation approach. Relationship correlating measure i.e., regression coefficient (r²) of developed QSAR model was 0.87 and predictive accuracy was 81%, refer by cross validation coefficient (rCV²=0.81). QSAR studies indicate that dipole vector Z (debye), steric energy (kcal/mole), ether group count, molar refractivity and shape index (basic kappa, order 3) correlates well with biological activity. Dipole vector, molar refractivity and shape index showed negative correlation with activity, while steric energy and ether group count showed positive. All the active derivatives showed compliance with Lipinski's rule of five for oral bioavailability and toxicity risk assessment parameters namely, mutagenicity, tumorogenicity, irritation and reproductive toxicity. Molecular docking studies also showed strong binding affinity to anti-psychotic receptors e.g., D2 dopamine and serotonin (5HT_{2A}) receptors.

For the development of a virtual screening prediction model for antipsychotic activity, potential anti-psychotic compounds are screened out from the library of plant molecules and their derivatives through quantitative structure activity relationship (QSAR), molecular docking and in silico ADMET studies. On the basis of binding affinity (docking score) possible anti-psychotic receptors were proposed as potential drug targets. For activity prediction, a multiple linear regression analysis based QSAR model was developed which successfully establishes the anti-psychotic activity of selected derivatives in accord with the experimental data. QSAR model also furnishes the activity dependent chemical descriptors and predicted the inhibitory concentration (IC₅₀) of derivatives to suggest the possible toxicity range. Relationship correlating measure for QSAR model was indicated by regression coefficient (r²), which was 0.87 and prediction accuracy of developed QSAR model referred by cross validation coefficient (rCV²) which was 0.81. Active derivatives followed the standard computational pharmacokinetic parameters (ADMET) of drug likeness and oral bioavailability. QSAR study indicate that dipole vector Z (debye), steric energy (kcal/mole), ether group count, molar refractivity and shape index (basic kappa, order 3) correlates well with anti-psychotic activity. All the active derivatives showed compliance with Lipinski's rule of five for oral bioavailability. Neurotransmitter such as dopamine-D₂ and Serotonin (5HT_{2A}) are significantly, involved in psychotic behavior (Creese I, et al., 1976). Hence forth effect of test samples of yohimbine alkaloids and their semi-synthetic derivatives were tested on these two receptors using molecular docking experiment with the help of available crystal structure or homology model to further support the molecular interaction. Docking study also showed strong binding affinity to anti-psychotic receptors e.g., D2 dopamine receptor (PDB: 2HLB) and Serotonin (5HT_{2A}) (no crystal structure available, thus developed homology based 3D model) receptor. Finally, predicted results were correlated with in vitro and in vivo experimental data which were in complete agreement with the theoretical results.

This virtual screening and antipsychotic activity prediction model may be of immense importance in understanding mechanism and directing the molecular design of lead compound with improved anti-psychotic activity.

Present invention provides pharmaceutical usefulness of antipsychotic agents in an amount effective to control psychosis.

Present invention provides experimental support that yohimbine derivatives exhibit antipsychotic activity against dopaminergic-D₂ and Serotonergic (5HT_{2A}) receptors as well as amphetamine induced hyperactive mouse model. 25 mg/kg concentrations of 17-O-acetyl-α-yohimbine (K001A) and 17-O-(3″)-nitrobenzoyl-α-yohimbine (K001C) showed >72% inhibition in amphetamine induced hyperactivity mice model.

Development of predictive QSAR model as a virtual screening tool for in vitro antipsychotic activity has also been described.

Virtual screening method for prediction of antipsychotic activity typically consists of following sub-steps:

### 1. Development of Quantitative Structure Activity Relationship (QSAR) Based Model

i. Preparing training set of known antipsychotic drugs. (Table 34)
ii. Calculations of chemical structural descriptors.
iii. Multiple linear regression statistical analysis using forward stepwise validation approach.
iv. Development of predictive QSAR models indicated in the form of derived multiple linear regression equations.
v. Selection of statistically validated (high r² and rCV²) best predictive QSAR model for antipsychotic activity of Yohimbine derivatives.
vi. Evaluation of selected QSAR model for predictive accuracy by using Test data set (known antipsychotic compounds not included in Training set). (Table 31)
vii. Prediction of in vitro antipsychotic activity of known, unknown and novel compounds and their derivatives through developed QSAR model.

### 2. Virtual Screening for Target Binding Affinity Through Molecular Docking

viii. Molecular docking study of active molecules predicted through developed QSAR model against human antipsychotic targets e.g. Dopamine D2 and Serotonin (5HT_{2A}) receptors.
3. Virtual Screening for ADME and Toxicity Risk Assessment
ix. Evaluation of ADME properties of predicted active molecules for oral bioavailability and drug likeness.
x. Toxicity risk assessment evaluation of active molecules predicted through developed QSAR model.

### Example-1

### Molecular Modeling, Energy Minimization and Docking

The molecular structures of yohimbine derivatives were constructed through Scigress Explorer v7.7.0.47 (formerly CaChe) (Fujitsu). The optimization of the cleaned molecules was done through MO-G computational application that computes and minimizes an energy related to the heat of formation. The MO-G computational application solves the Schrodinger equation for the best molecular orbital and geometry of the ligand molecules. The augmented Molecular Mechanics (MM2/MM3) parameter was used for optimizing the molecules up to its lowest stable energy state. This energy minimization is done until the energy change is less than 0.001 kcal/mol or else the molecules get updated almost 300 times. However, the chemical structures of known drugs were retrieved through the PubChem database of NCBI server, USA (www.pubchem.ncbi.nlm.nih.gov). Crystallographic 3D structures of target proteins were retrieved through Brookhaven protein/ligand databank (www.pdb.org). The valency and hydrogen bonding of the ligands as well as target proteins were subsequently satisfied through the Workspace module of Scigress Explorer software. Hydrogen atoms were added to protein targets for correct ionization and tautomeric states of amino acid residues such as His, Asp, Ser and Glu etc. Molecular docking of the drugs and the active derivatives with the anti-psychotic receptors was performed by using the Fast-Dock-Manager and Fast-Dock-Compute engines available with the Scigress Explorer. For automated docking of ligands into the active sites we used genetic algorithm with a fast and simplified Potential of Mean Force (PMF) scoring scheme (Muegge I., 2000; Martin C., 1999). PMF uses atom types which are similar to the empirical force-field's used in Mechanics and Dynamics. A minimization is performed by the Fast-Dock engine which uses a Lamarkian Genetic Algorithm (LGA) so that individuals adapt to the surrounding environment. The best fits are sustained through analyzing the PMF scores of each chromosome and assigning more reproductive opportunities to the chromosomes having lower scores. This process repeats for almost 3000 generations with 500 individuals and 100,000 energy evaluations. Other parameters were left to their default values. Structure based screening involves docking of candidate ligands into protein targets, followed by applying a PMF scoring function to estimate the likelihood that ligand will bind to the protein with high affinity or not (Martin C., 1999; Sanda et al., 2008).

### Example-2

### Selection of Chemical Descriptors for QSAR Modeling

Quantitative structure-activity relationship (QSAR) analysis is a mathematical procedure by which chemical structures of molecules is quantitatively correlated with a well defined parameter, such as biological activity or chemical reactivity. For example, biological activity can be expressed quantitatively as in the concentration of a substance required to give a certain biological response. Additionally, when physicochemical properties or structures are expressed by numbers, one can form a mathematical relationship or QSAR, between the two. The mathematical expression can then be used to predict the biological response of other chemical structures (Yadav et al., 2010). Before the novel compounds could be used as potential drugs, the prediction of toxicity/activity ensures the calculation of risk factor associated with the administration of that particular compound/drug. A QSAR model ultimately helps in predicting these important parameters e.g., IC₅₀ or ED₅₀ values. For identifying the anti-psychotic activity of the derivatives, QSAR study was performed. A total of 39 chemical descriptors and training data set of 30 anti-psychotic & other CNS (central nervous system) related drugs/compounds with activity were used for development of QSAR model. Inhibitory concentration (IC₅₀) was considered as the biological (antipsychotic) activity parameter of the compounds. Forward stepwise multiple linear regression mathematical expression was then used to predict the biological response of other derivatives.

### Example-3

### In Silico Screening: Compliance with Pharmacokinetic Properties (ADMET)

The ideal oral drug is one that is rapidly and completely absorbed from the gastrointestinal track, distributed specifically to its site of action in the body, metabolized in a way that does not instantly remove its activity, and eliminated in a suitable manner, without causing any harm. It is reported that around half of all drugs in development fail to make it to the market because of poor pharmacokinetic (PK) (Hodgson, 2001). The PK properties depend on the chemical properties of the molecule. PK properties such as absorption, distribution, metabolism, excretion and toxicity (ADMET) are important in order to determine the success of the compound for human therapeutic use (Voet & Voet, 2004; Ekins et al., 2005; Norinder & Bergstrom, 2006). Polar surface area considered as a primary determinant of fraction absorption (Stenberg et al., 2001). Low molecular weight of compound has been considered for oral absorption (Van de Waterbeemd et al., 2001). The distribution of the compound in the human body depends on factors such as blood-brain barrier (BBB), permeability, volume of distribution and plasma protein binding (Reichel & Begley, 1998), thus these parameters have been calculated for studied compounds. The octanol-water partition coefficient (LogP) has been implicated in the BBB penetration and permeability prediction, and so is the polar surface area (Pajouhesh & Lenz, 2005). It has been reported that excretion process which eliminates the compound from human body depends on the molecular weight and octanol-water partition coefficient (Lombardo et al., 2003). Rapid renal clearance is associated with small and hydrophilic compounds. The metabolism of most drugs that takes place in the liver is associated with large and hydrophobic compounds (Lombardo et al., 2003). Higher lipophilicity of compounds leads to increased metabolism and poor absorption, along with an increased probability of binding to undesired hydrophobic macromolecules, thereby increasing the potential for toxicity (Pajouhesh & Lenz, 2005). In spite of the some observed exceptions to Lipinski's rule, the property values of the vast majority (90%) of the orally active compounds are within their cut-off limits (Lipinski et al., 1997, 2001). Molecules violating more than one of these rules may have problems with bioavailability. For studying PK properties Lipinski's ‘Rule of Five’ screening was used so that to assess the drug likeness properties of active derivatives. Briefly, this rule is based on the observation that most orally administered drugs have a molecular weight (MW) of 500 or less, a LogP no higher than 5, five or fewer hydrogen bond donor sites and 10 or fewer hydrogen bond acceptor sites (N and O atoms).

### Example 4

### In Silico Screening: Compliance with Oral Bioavailability and Toxicity Risk Assessment Parameters

In addition, the oral bioavailability of active derivatives was assessed through topological polar surface area. We calculated the polar surface area (PSA) by using method based on the summation of tabulated surface contributions of polar fragments termed as topological PSA (TPSA) (ChemAxon-Marvinview 5.2.6:PSA plugin (Ertl et al., 2000). PSA is formed by polar atoms of a molecule. This descriptor was shown to correlate well with passive molecular transport through membranes and therefore, allows prediction of transport properties of drugs and has been linked to drug bioavailability. The percentage of the dose reaching the circulation is called the bioavailability. Generally, it has been seen that passively absorbed molecules with a PSA>140 Å² are thought to have low oral bioavailability (Norinder et al., 1999; Ertl et al., 2000). Besides, number of rotatable bonds is also a simple topological parameter used by researchers under extended Lipinki's rule of five as measure of molecular flexibility. It has been shown to be a very good descriptor of oral bioavailability of drugs (Veber et al., 2002). Rotatable bond is defined as any single non-ring bond, bounded to non-terminal heavy (i.e., non-hydrogen) atom. Amide C—N bonds are not considered because of their high rotational energy barrier. Moreover, some researchers also included sum of H-bond donors and H-bond acceptors as a secondary determinant of fraction absorption. The primary determinant of fraction absorption is polar surface area (Clark, 1999; Stenberg et al., 2001). According to extended rule the sum of H-bond donors and acceptors should be less then or equal to 12 or polar surface area should be less then or equal to 140 A², and number of rotatable bonds should be less then or equal to 10 (Veber et al., 2002). Calculations of other important ADME/T properties of studied compounds were performed through QikProp (QP), version 3.2, Schrodinger, LLC, New York, USA (2009). We screened all the active compounds through Jorgensen Rule of three (Shrodinger, 2009), which state that for orally available molecule, QP logS should be more then −5.7, QP PCaco should be more then 22 nm/s, number of primary metabolites should be less then 7. Moreover, toxicity risks (mutagenicity, tumorogenicity, irritation, reproduction) and associated physicochemical properties (ClogP, solubility, drug-likeness and drug-score) of compounds (G3-G13) were calculated by Osiris calculator (Parvez et al., 2010; Abdul Rauf et. al. 2010). Toxicity risks and physicochemical properties of compounds (G3-G13) were calculated through Osiris software (Parvez et al., 2010).

### Example-5

### Biological Activity Prediction Through QSAR Modeling

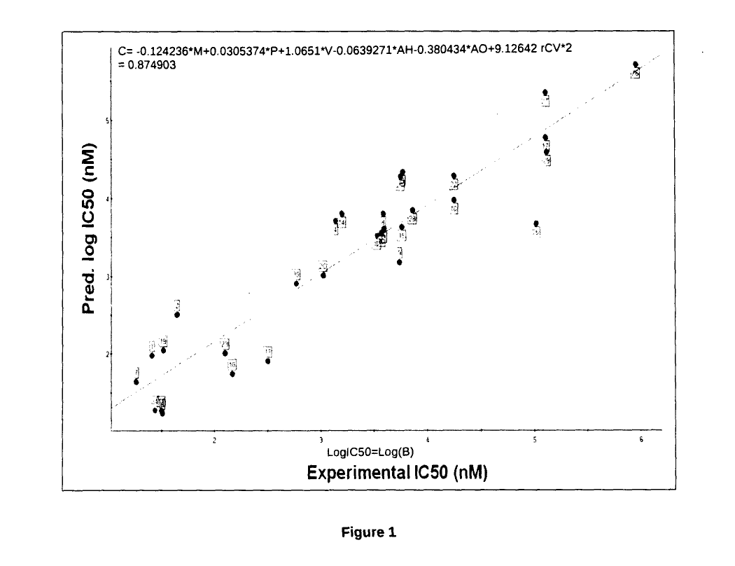

Structure activity relationship has been denoted by QSAR model showing significant activity-descriptors relationship and activity prediction accuracy. Only five chemical structural descriptors (2D and 3D structural properties) showed good correlation with antipsychotic activity (Table 1). A forward stepwise multiple linear regression QSAR model was developed using leave-one-out validation approach for the prediction of in vitro antipsychotic activity of organic compounds and its derivatives. Anti-psychotic drugs fit well into this correlation, which seems very reasonable one in the regression plot (FIG. 1). Relationship correlating measure (refer by regression coefficient r²) of QSAR model was 0.87 (87%) and predictive accuracy (refer by cross validation coefficient rCV²) was 0.81 (81%). QSAR study indicate that dipole vector Z (debye), steric energy (kcal/mole), ether group count, molar refractivity and shape index (basic kappa, order 3) correlates well with antipsychotic activity. Dipole vector Z, molar refractivity and shape index showed negative correlation, while steric energy and ether group count showed positive. The QSAR mathematical model equation derived through multiple linear regression method is given below showing good relationship between experimental activity i.e., in vitro inhibitory concentration (IC₅₀) (nM) and chemical descriptors. Predictive performance of best fit developed QSAR model was comparable to experimental antipsychotic activity.

QSAR model equation:

Predicted log IC₅₀(nM)=−0.124236×Dipole Vector Z(debye)(M)+0.0305374×Steric Energy(kcal/mole)(P)+1.0651×Group Count(ether)(V)−0.0639271×Molar Refractivity(AH)−0.380434×Shape Index(basic kappa,order 3)(AO)+9.12642

### Antipsychotic Activity Prediction of Natural Yohimbine Alkaloids Through QSAR Modeling

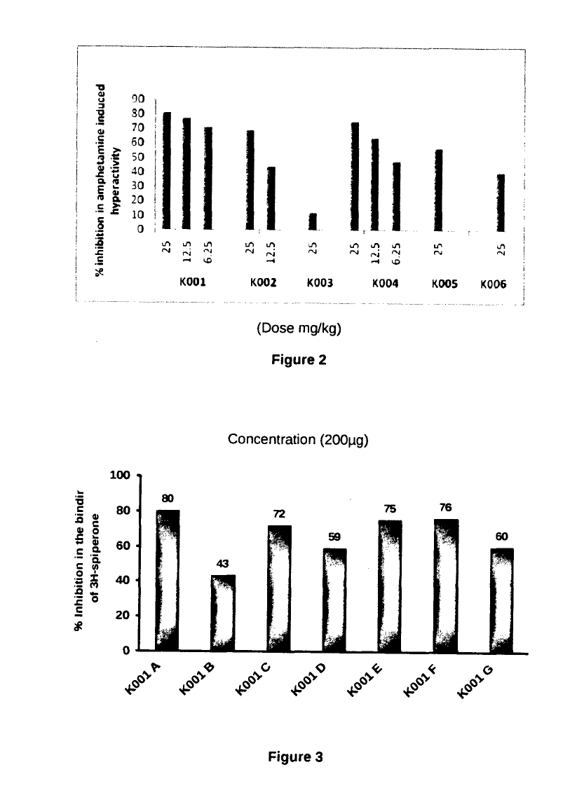

Natural yohimbine alkaloids K001, K002, K003, K004A, K004B, K005 and K006 were subjected for the prediction of antipsychotic activity through QSAR modeling and the results showed that out of studied molecules and derivatives K001, K002, K003, K004A, K004B, K005 and K006, compound K001, K002, K004A and K004B indicate high antipsychotic activity comparable to Clozapine (Table 1). Later these theoretical results were found comparable to the experimental in vivo activity (FIG. 2) reported by us for these compounds ((Srivastava et. al. WO PCT/IN2010/000208). Besides, all the active compounds showed clearance of toxicity risk assessment parameters namely, mutagenicity, tumorogenicity, irritation, reproduction along with physicohemical properties related to drug likeness such as ClogP, solubility and drug-score. Moreover, all the active compounds showed high binding affinity to anti-psychotic receptors e.g., dopamine D2 receptor and serotonin (5HT_{2A}) receptor (Table 2-3). Besides, we also checked the compliance of compounds to Lipinski's rule-of-five for drug likeness (Table 24). Results indicate that active compounds followed most of the ADMET properties. Moreover, when we calculated the topological polar surface area (TPSA) of active compounds as chemical descriptor for passive molecular transport through membranes, results showed compliance with standard range i.e., TPSA>140 Å², thus indicate good oral bioavailability.

### Example-6

### Preparation of Synthetic Derivatives of α-Yohimbine (K001)

The various derivatives of α-yohimbine (K001) were prepared according to Formula 2 as given below:

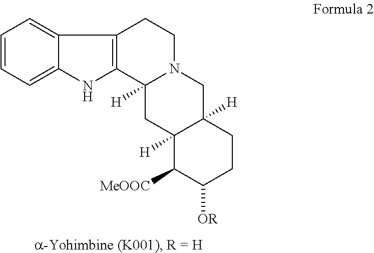

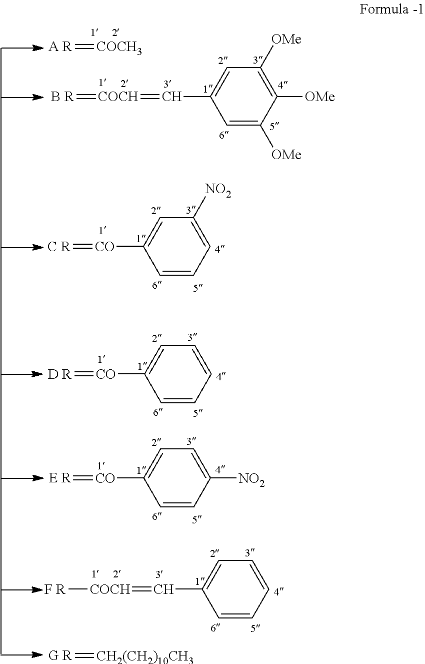

### Example A

Dissolving α-yohimbine (K001) in dry pyridine (2 ml) and reacting it with acetic anhydride in 1:1.5 ratios along with 5 mg of 4-dimethyl amino pyridine (DMAP) for 16 hours at 40° C. After completion of the reaction, crushed ice was added to the reaction mixture and extracted the resultant mixture with chloroform followed by washing with water until neutralization. The product was purified by known method, which afforded 17-O-acetyl α-yohimbine (K001A) in 94% yield.

### Example B

Dissolving α-yohimbine (K001) in dry dichloromethane (10 ml) and reacting it with 3,4,5 trimethoxy cinnamic acid in 1:2 ratio along with N,N′-Dicyclohexylcarbodiimide (45.3 mg) in presence of DMAP (4 mg) for 16 hours at a 40° C. After completion of the reaction, crushed ice was added to the reaction mixture and extracted the resultant mixture with chloroform followed by washing with water until neutralization. The product was purified by known method, which afforded 17-O-(3″,4″,5″)-trimethoxy cinnamoyl α-yohimbine (K001B) in 75% yield.

### Example C

Dissolving K001 in dry dichloromethane (10 ml) and reacting it with desired acid chloride (such as 4-nitrobenzoyl chloride, cinnamoyl chloride and lauroyl chloride etc.) in 1:1.5 ratios along with 5 mg of 4-dimethyl amino pyridine (DMAP) for 16 hours at 40° C. After completion of the reaction, crushed ice was added to the reaction mixture and extracted the resultant mixture with chloroform followed by washing with water until neutralization. The product was purified by known method, which afforded the desired products 17-O-(4″)-nitrobenzoyl-α-yohimbine (K001E), 17-O-cinnamoyl α-yohimbine (K001F), 17-O-lauroyl α-yohimbine (K001G) in 87, 91 and 93% yields.

### Example 7

### Antipsychotic Activity Prediction of α-Yohimbine Derivatives Through QSAR Modeling

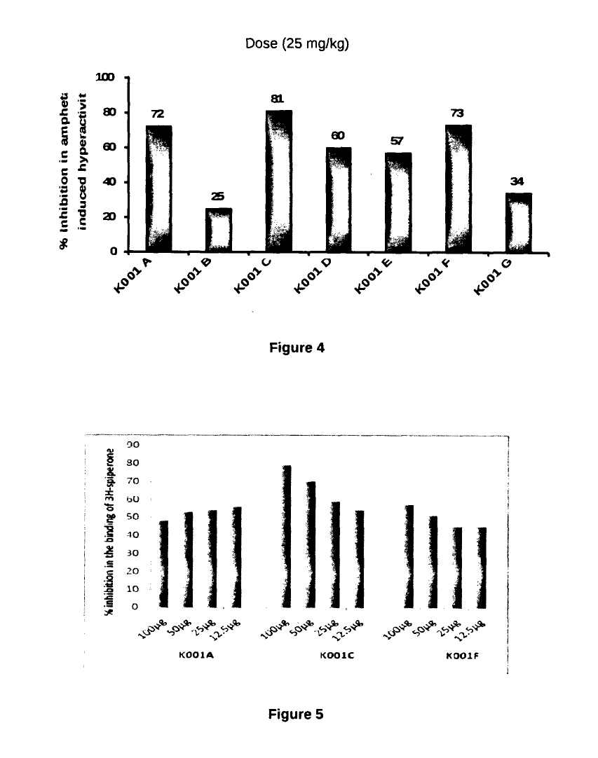

The α-yohimbine derivatives K001A, K001B, K001C, K001D, K001E, K001F and K001G, on QSAR activity prediction showed that derivatives K001A, K001C, K001E and K001F indicate high antipsychotic activity comparable to Clozapine (Table 4). However, compound K001C and K001E revealed high risk of mutagenicity under toxicity risk assessment studies, thus rejected. On the other hand, compound K001F indicate activity higher then Haloperidol (i.e. IC₅₀=1.5 nM), thus expected to be sensitive for strong early and late extrapyramidal side effects, thus not considered for further studies or derivatization. Predicted results were found comparable to experimental in vitro and in vivo activity (FIG. 3-4). Besides, active compound K001A showed compliance with physicohemical properties related to drug likeness such as ClogP, solubility and drug-score (Table 23). Moreover, active compounds K001A also showed high binding affinity to both anti-psychotic receptors e.g., dopamine D2 and serotonin (5HT_{2A}) (Table 5-6), thus considered for further derivatization. Further validation of active compound K001A for drug likeness was checked through Lipinski's rule-of-five (Lipinski et al., 2001), which was also found comparable to standard drugs. Results indicate that active compounds followed most of the ADMET properties. This helped in establishing the pharmacological activity of studied compounds for their use as potential antipsychotic lead. Moreover, when we calculated the topological polar surface area (TPSA) of active compounds as chemical descriptor for passive molecular transport through membranes, results showed compliance with standard range i.e., TPSA>140 Å², thus indicate oral bioavailability.

### Example-8

### In-Vitro and In-Vivo Antipsychotic Activity Evaluation of α-Yohimbine Derivatives

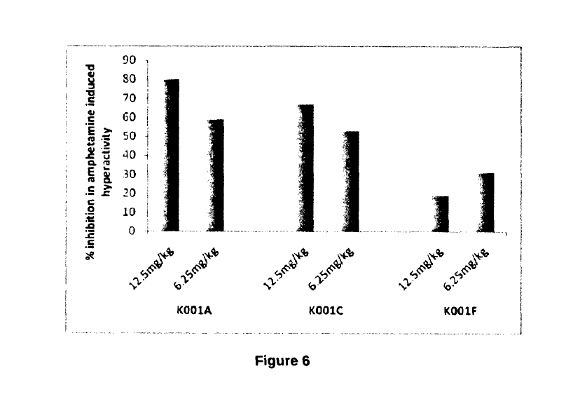

All the derivatives of α-yohimbine: 17-O-acetyl α-yohimbine (K001A), 17-O-(3″,4″,5″)-trimethoxy cinnamoyl α-yohimbine (K001B), 17-O-(3″)-nitrobenzoyl α-yohimbine (K001C), 17-O-benzoyl α-yohimbine (K001D), 17-O-(4″)-nitrobenzoyl-α-yohimbine (K001E), 17-O-cinnamoyl α-yohimbine (K001F), 17-O-lauryl α-yohimbine (K001G) as shown in Formula 2 were evaluated in-vitro and in-vivo for their antipsychotic potentials and the results are presented in the FIGS. 3 and 4 respectively. Although all the derivatives showed antipsychotic activity but the derivatives K001A, K001C, K001E, and K001F showed potential antipsychotic activity and were further evaluated for their antipsychotic potential in-vitro and in-vivo at lower doses and the results are presented in FIGS. 5 and 6 respectively.

### Example-9

### Preparation of Virtual Derivatives of Yohimbine Alkaloids

In order to get the potential antipsychotic agent, various virtual derivatives of yohimbine alkaloids, α-yohimbine (K001, Y series Y1 to Y100 of Formula 2 Table 27), reserpiline (K002, R series, R1 to R68 of Formula 3 Table 28), 11-demethoxyreserpiline (K004A, 11DR series, 11DR1 to 11DR21 of Formula 4 Table 29) and 10-demethoxyreserpiline (K004B, 10DR series, 10DR1 to 10DR59 of Formula 5 Table 30) were prepared.

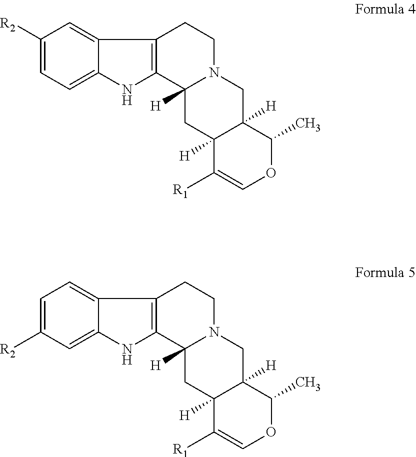

### Example-10

### Antipsychotic Activity Prediction of α-Yohimbine (K001) Derivatives Through QSAR Modeling

The QSAR modeling results showed that out of studied hundred derivatives (of which four derivatives broken) of K001, i.e., Y1 to Y100, compound Y69, Y61, Y64, Y73, Y68 and Y71 indicate very close antipsychotic activity and drug likeness properties similar to Clozapine (Table 7-8). However, compound Y52, Y1, Y75, Y3, Y51, Y2, Y74, Y96 and Y10 revealed moderate antipsychotic activity and druglikeness properties comparable to Clozapine. Lastly, compound Y58, Y63, Y82, Y76, Y5, Y32, Y97, Y86, Y40, Y14, Y77, Y41, Y25, Y100, Y33, Y78 showed high activity but low druglikeness due to strong early and late extrapyramidal side effects similar to Haloperidol. However, compound Y14 showed probability of irritation side effect under toxicity risk assessment studies thus rejected. Besides, active compounds showed compliance with physicohemical properties related to drug likeness such as ClogP, solubility and drug-score (Table 23). Moreover, all the active compounds (high, moderate and close) also showed high binding affinity to both anti-psychotic receptors e.g., dopamine D2 and serotonin (5HT_{2A}) (Table 9-10), thus considered as anti-psychotic lead molecules. Further validation of active compounds for drug likeness was checked through Lipinski's rule-of-five (Lipinski et al., 2001), which was also found comparable to standard drug Clozapine. Results indicate that active compounds followed most of the ADMET properties.

Predicted log IC50 and IC50 value of virtual derivatives of Yohimbane alkaloids and isolated Yohimbane alkaloids and semi-synthetic derivatives of α-yohimbine by virtual screening model is mentioned in table 33 and 32 respectively.

### Example-11

### Antipsychotic Activity Prediction of Reserpiline (K002, Formula 3) Derivatives Through Qsar Modeling

The QSAR modeling results showed that out of studied sixty eight derivatives of K002, i.e., R1 to R68, compound R40, R61, R58, R51, R68, R13, R12, R43, R62, R57, R41, R5, R16, R25, R32, R26, R14, R36, R18, R37, R1, R53, R33, R15, R10, R23, R49, R7, R6, R22, R63, R27, and R48 indicate very close antipsychotic activity and drug likeness properties similar to Clozapine (Table 11-12). However, compound R21, R28, R4, R24, R30, R30, R38, R20, R8, R11, R42, R19, R29, and R39 revealed moderate antipsychotic activity and druglikeness properties comparable to Clozapine. Lastly, compound R34, R35, R31, and R9 showed high activity but low druglikeness due to strong early and late extrapyramidal side effects similar to Haloperidol. Besides, active compounds showed compliance with physicohemical properties related to drug likeness such as ClogP, solubility and drug-score (Table 23). Moreover, the entire active compounds (high, moderate and close) showed binding affinity to anti-psychotic receptors e.g., dopamine D2 and serotonin (5HT_{2A}) (Table 13-14), thus considered as anti-psychotic lead molecules.

### Example-12

### Antipsychotic Activity Prediction of 11demethoxyreserpiline (K004A, Formula 4) Derivatives Through QSAR Modeling

The QSAR modeling results showed that out of studied twenty one derivatives of K004A, i.e., 11DR1 to 11DR21, compound 11DR3, 11DR2, 11DR1, 11DR12, 11DR14, 11DR18, 11DR13, 11DR16, 11DR10, and 11DR15 indicate very close antipsychotic activity and drug likeness properties similar to Clozapine (Table 15-16). However, compound 11DR8, 11DR5, 11DR4, 11DR6, 11DR11, 11DR20, 11DR21, 11DR7, 11DR19, and 11DR17 revealed moderate antipsychotic activity and drug likeness properties comparable to

Clozapine. Lastly, compound 11DR9 showed high activity but low drug likeness due to strong early and late extrapyramidal side effects similar to Haloperidol. Besides, active compounds showed compliance with physiochemical properties related to drug likeness such as ClogP, solubility and drug-score (Table 23). Moreover, the entire active compounds (high, moderate and close) showed binding affinity to anti-psychotic receptors e.g., dopamine D2 and serotonin (5HT_{2A}) (Table 17-18), thus considered as anti-psychotic lead molecules.

### Example-13

### Antipsychotic Activity Prediction of 10Demethoxyreserpiline (K004B, Formula 5) Derivatives Through QSAR Modeling

The QSAR modeling results showed that out of studied fifty nine derivatives of K004B, i.e., 10DR1 to 10DR59, compound 10DR22, 10DR3, 10DR40, 10DR41, 10DR45, 10DR33, 10DR25, 10DR12, 10DR16, 10DR13, 10DR32, 10DR37, 10DR18, 10DR36, 10DR43, 10DR14, and 10DR10 indicate very close antipsychotic activity and drug likeness properties similar to Clozapine (Table 19-20). However, compound 10DR26, 10DR59, 10DR15, 10DR5, 10DR46, 10DR4, 10DR6, 10DR11, 10DR21, 10DR38, 10DR48, 10DR27, 10DR20, 10DR7, 10DR53, 10DR29, 10DR8, 10DR28, 10DR52, 10DR24, and 10DR58 revealed moderate antipsychotic activity and druglikeness properties comparable to Clozapine. Lastly, compound 10DR17, 10DR42, 10DR23, 10DR19, 10DR30, 10DR39, and 10DR47 showed high activity but low druglikeness due to strong early and late extrapyramidal side effects similar to Haloperidol. Besides, active compounds showed compliance with physicohemical properties related to drug likeness such as ClogP, solubility and drug-score (Table 23). Moreover, all active compounds (high, moderate and close) showed binding affinity to anti-psychotic receptors e.g., dopamine D2 and serotonin (5HT_{2A}) (Table 21-22), thus considered as anti-psychotic lead molecules.

### Example-14

### Toxicity Risks Assessment, Drug Likeness and Drug Score of Yohimbine Alkaloids Derivatives

Now it is possible to predict toxicity risk parameter through Osiris calculator (Parvez et al., 2010; Abdul Rauf et. al. 2010). In the studied work, we screened all the studied compounds for toxicity risks parameters namely, mutagenicity, tumorogenicity, irritation, reproduction and quantitative data related to physicohemical properties namely, ClogP, solubility, drug-likeness and drug-score. The toxicity risk predictor locates fragments within a molecule which indicate a potential toxicity risk. From the data evaluated indicates that, all rejected compounds showed one or the more toxicity parameter such as mutagenicity and irritation side effect when run through the toxicity risk assessment system but as far as tumorogenicity and reproduction effects are concerned, all the compounds indicate no risk. The logP value is a measure of the compound's hydrophilicity. Low hydrophilicity and therefore high logP values may cause poor absorption or permeation. It has been shown for compounds to have a reasonable probability of being well absorb their logP value must not be greater than 5.0. On this basis, all the compounds are in acceptable limit. Similarly, the aqueous solubility (logS) of a compound significantly affects its absorption and distribution characteristics. Typically, a low solubility goes along with a bad absorption and therefore the general aim is to avoid poorly soluble compounds. Our estimated logS value is a unit stripped logarithm (base 10) of a compound's solubility measured in mol/liter. There are more than 80% of the drugs on the market have an (estimated) logS value greater than −4. On this basis, all the active compounds are in acceptable limit. Similarly, all the studied active compounds showed compliance with other drug likeness parameters e.g., Lipinski's rule, Jorgenson's rule, bioavailability etc. At last we have calculated overall drug-score for all the studied compounds and compared with that of standard antipsychotic compound Clozapine. The drug-score combines drug-likeness, ClogP, logS, molecular weight, and toxicity risks in one handy value in Table 23 that may be used to judge the compound's overall potential to qualify for a drug.

### Example-15

### In Vitro Antipsychotic Screening

### Radioligand Receptor Binding Assay Using Multi Probe II Ex Robotics Liquid Handling System

Neurotransmitter such as dopamine-D₂ and Serotonin (5HT_{2A}) are significantly, involved in psychotic behaviour (Creese I, et al., 1976). Hence forth effect of test samples of α-yohimbine semi-synthetic derivatives were tested on these two receptors using in vitro receptor binding assay with the help of specific radioligand.

### Preparation of Crude Synaptic Membrane

Rat was killed by decapitation; Brain was removed and dissected the discrete brain regions in cool condition following the standard protocol (Glowinski and Iverson 1966). Crude synaptic membrane from corpus striatum and frontal cortex brain region was prepared separately following the procedure of Khanna et al 1994. Briefly, the brain region was weighed and homogenized in 19 volumes of 5 mM Tris—Hcl buffer (pH 7.4) (5% weight of tissue). The homogenate was centrifuged at 50,000×g for 20 minutes at 4° C. The supernatant was removed and the pellet was dispersed in same buffer pH 7.4, centrifuged at 50,000×g for 20 minutes at 4° C. again. This step helps in remaining endogenous neurotransmitter and also helps in neuronal cell lyses. The pellet obtained was finally suspended in same volume of 40 mM Tris—HCI Buffer (pH 7.4) and used as a source of receptor for in vitro receptor binding screening of the samples for Dopaminergic and Serotonergic (5HT_{2A}) receptor. Protein estimation was carried out following the method of Lowry et al 1951.

### Receptor Binding Assay

In vitro receptor binding assay for dopamine-D₂ and Serotonin (5HT_{2A}) was carried out in 96 well multi screen plate (Millipore, USA) using specific radioligands 3H-Spiperone for DAD2 and 3H-Ketanserin for 5HT_{2A} and synaptic membrane prepared from corpus striatal and frontal cortex region of brain as source of receptor detail discussed in Table 25 following the method of Khanna et al. (1994). Reaction mixture of total 250 μl was prepared in triplicate in 96 well plates as detail given in Table 26. The reaction mixture were mixed thoroughly and incubated for 15 min. at 37° C. After incubation of 15 min. the content of each reaction was filtered under vacuum manifold attached with liquid handling system. Washed twice with 250 μl cold tris—HCI buffer, dried for 16 hours, 60 μl scintillation fluid (Microscint ‘O’, Packard, USA) was added to each well followed by counting of radio activity in terms of count per minute (CPM) on plate counter (Top Count—NXT, Packard, USA). Percent inhibition of receptor binding was calculated in presence and absence of test sample.

$$\% Inhibition in binding = \frac{Binding in presence of test sample}{Total binding obtained in absence of test sample} \times 100$$

The inhibition potential of various semi-synthetic derivatives on the binding of 3H-Spiperone to corpus striatal and 3H-Ketanserin to frontocortical membranes were in-vitro screened and IC₅₀ values were determined.

### Example-16

### In Vivo Antipsychotic Screening

In order to assess the antipsychotic potential of semi-synthetic derivatives of yohimbine alkaloids, amphetamine induced hyper activity mouse model was used following the method of Szewczak et at (1987). Adult Swiss mice of either sex (25±2 g body weight) obtained from the Indian Institute of Toxicology Research (IITR), Lucknow, India animal-breeding colony were used throughout the experiment. The animals were housed in plastic polypropylene cages under standard animal house conditions with a 12 hours light/dark cycle and temperature of 25±2° C. The animals had adlibitum access to drinking water and pellet diet (Hindustan Lever Laboratory Animal Feed, Kolkata, India). The Animal Care and Ethics Committee of IITR approved all experimental protocols applied to animals.

### Antipsychotic Activity

The mice randomly grouped in batches of seven animals per group. The basal motor activity (distance traveled) of each mouse was recorded individually using automated activity monitor (TSE, Germany). After basal activity recording, a group of seven animals were challenged with amphetamine [5.5 mg/kg, intra peritoneal (i.p) dissolved in normal saline]. After 30 min. amphetamine injection, motor activity was recorded for individual animal for 5 min. In order to assess the anti-psychotic activity of semi-synthetic derivatives of α-yohimbine, already acclimatized animals were pre-treated with test sample (suspended in 2% gum acacia at a dose of 25, 12.5, 6.25 mg/kg given orally by gavage. One hour after sample treatment, each mouse were injected 5.5 mg/kg amphetamine i.p. 30 minutes after amphetamine treatment, motor activity was recorded of individual mouse for 5 min.

The difference in motor activity as indicated by distance traveled in animals with amphetamine alone treated and animals with samples plus amphetamine challenge was recorded as inhibition in hyper activity caused by amphetamine and data presented as percent inhibition in amphetamine induced hyperactivity.

### Example-17

### Human Dose Calculation

The minimum dose at which an antipsychotic semi-synthetic derivative showed >60% inhibition in amphetamine induced hyperactivity mice model was taken for human dose calculation.

The human dose of antipsychotic is 1/12 of the mice dose. Taking 60 Kg as an average weight of a healthy human, human doses for semi-synthetic derivatives of α-yohimbine were calculated as shown below.

$$Human dose = \frac{{M}^{*} \times {60}^{ @}}{{12}^{\$}}$$

M*Dose in amphetamine induced hyperactivity mice model
@Average weight of a healthy human
^{$}Human dose is 1/12 of the mice

In FIG. 5, K001A and K001C at 25 mg/Kg showed >60% inhibition in amphetamine induced hyperactivity mice model. Hence the human dose of K001A and K001C will be

$$\frac{25 \times 60}{12} = 125 mg$$

TABLE 1
Comparison of experimental and predicted in vitro activity (IC50 (M) data calculated through
developed QSAR model based on correlated chemical descriptors of yohimbane alkaloids.

| | | Steric | Group | | Shape Index | | |
|---|---|---|---|---|---|---|---|
| Chemical | Dipole Vector | Energy | Count | Molar | (basic kappa, | Predicted | Experimental |
| Sample | Z (debye) | (kcal/mole) | (ether) | Refractivity | order 3) | log IC50 (nM) | log IC₅₀ (nM) |
| Haloperidol | −1.456 | 23.252 | 0 | 1.2.592 | 393.948 | 1.271 | 1.5 |
| Clozapine | −0.669 | 95.173 | 0 | 96.773 | 3.52 | 4.59 | 5.12 |
| K001 | 0.88 | 58.703 | 0 | 98.572 | 2.951 | 3.386 | |
| K002 | −1.028 | 43.611 | 3 | 111.435 | 3.665 | 5.263 | |
| K003 | −1.132 | 36.673 | 2 | 104.972 | 3.353 | 4.531 | |
| K004 A | 0.972 | 54.061 | 2 | 104.972 | 3.353 | 4.801 | |
| K004 B | −0.788 | 35.173 | 2 | 104.972 | 3.353 | 4.443 | |
| K005 | 0.577 | 48.461 | 3 | 111.435 | 3.665 | 5.212 | |
| K006 | −0.618 | 40.86 | 1 | 98.509 | 2.951 | 4.096 | |

Experimental log IC50 value of Haloperidol and Clozapine are just used for comparison purpose only.

TABLE 2
Details of binding affinity of Antipsychotic derivative and its
binding pocked residue docked on D2 dopamine receptor
(PDB ID: 2HLB)

| | | Docking | Binding pocket residues (4 Å) |
|---|---|---|---|
| | | energy | (hydrogen bonded residues are |
| S. No | Ligand | (Kcal/mol) | highlighted in bold) |
| 1 | K001 | −60.157 | TRP-5, PHE-8, LEU-9. |
| 2 | K002 | −60.473 | SER-1, VAL-3, THR-4, TRP-5, PHE-8, |
| | | | LEU-9, GLU-11. |
| 3 | K003 | −61.651 | TRP-5, PHE-8, LEU-9, ASP-12. |
| 4 | K004 A | −58.624 | SER-1, VAL-3, TRP-5, PHE-8, LEU-9, |
| | | | GLU-11. |
| 5 | K004 B | −61.672 | VAL-3, TRP-5, PHE-8, LEU-9, GLU-11 |
| 6 | K005 | −68.706 | TRP-5, PHE-8, LEU-9. |
| 7 | K006 | −58.794 | TRP-5, PHE-8, LEU-9. |

TABLE 3
Details of binding affinity of Antipsychotic derivative and its
binding pocked residue docked on Serotonin receptor (5HT_{2A})
(developed homology based 3D model)

| | | Docking | Binding pocket residues (4 Å) |
|---|---|---|---|
| | | energy | (hydrogen bonded residues are |
| S. No | Ligand | (Kcal/mol) | highlighted in bold) |
| 1 | K001 | −51.946 | VAL-174, PHE-178, ILE-181, LYS-182, |
| | | | lys-246, PHE-253, LEU-254, VAL-256, |
| | | | VAL-257 |
| 2 | K002 | −39.336 | LEU-170, VAL-174, TYR-177, PHE-178, |
| | | | ILE-181, LYS-246, ILE-250, PHE-253, |
| | | | LEU-254, VAL-256, VAL-257 |
| 3 | K003 | −47.854 | LEU-170, THR-171, VAL-174, PHE-178, |
| | | | ILE-181, LYS-182, LYS-246, ILE-250, |
| | | | PHE-253, VAL-256, VAL-257, CYS-260 |
| 4 | K004 A | −23.786 | PHE-218, VAL-247, ILE-250, VAL-298, |
| | | | LEU-301, VAL-302, TYR-303, THR-304, |
| | | | ARG-311 |
| 5 | K004 B | −25.82 | PHE-218, ILE-250, LEU-254, MET-258, |
| | | | LEU-294, VAL-298, LEU-301, VAL-302, |
| | | | TYR-303, THR-304, ARG-311 |
| 6 | K005 | −18.162 | PHE-218, VAL-247, ILE-250, LEU-254, |
| | | | MET-258, LEU-294, VAL-298, LEU-301, |
| | | | VAL-302, TYR-303, THR-304, ARG-311 |
| 7 | K006 | −25.319 | PHE-218, VAL-298, LEU-301, VAL-302, |
| | | | TYR-303, THR-304, ARG-311 |

TABLE 4
Comparison of experimental and predicted in vitro activity (IC50) data calculated through developed
QSAR model based on correlated chemical descriptors of yohimbine (K001) derivatives

| | | Steric | Group | | Shape Index | | |
|---|---|---|---|---|---|---|---|
| Chemical | Dipole Vector | Energy | Count | Molar | (basic kappa, | Predicted | Experimental |
| Sample | Z (debye) | (kcal/mole) | (ether) | Refractivity | order 3) | log IC50 (nM) | log IC₅₀ (nM) |
| Haloperidol | −1.456 | 23.252 | 0 | 1.2.592 | 393.948 | 1.271 | 1.5 |
| Clozapine | −0.669 | 95.173 | 0 | 96.773 | 3.52 | 4.59 | 5.12 |
| K001 | 0.88 | 58.703 | 0 | 98.572 | 2.951 | 3.386 | |
| K001 A | −0.23 | 63.288 | 0 | 107.724 | 3.755 | 2.773 | |
| K001 B | −2.945 | 57.497 | 3 | 157.529 | 6.497 | 1.901 | |
| K001 C | −26.675 | 67.389 | 0 | 135.554 | 5.254 | 3.834 | |
| K001 D | −2.737 | 66.746 | 0 | 127.896 | 4.608 | 1.576 | |
| K001 E | −3.62 | 69.571 | 0 | 135.554 | 5.254 | 1.036 | |
| K001 F | −0.997 | 56.628 | 0 | 138.14 | 5.406 | 0.092 | |
| K001 G | −1.163 | 89.91 | 1 | 154.004 | 7.088 | 0.54 | |

TABLE 5
Details of binding affinity of Antipsychotic derivative and its
binding pocked residue docked on D2 dopamine receptor
(PDB ID: 2HLB)

| | | Docking | Binding pocket residues (4 Å) |
|---|---|---|---|
| | | energy | (hydrogen bonded residues are |
| S. No | Ligand | (Kcal/mol) | highlighted in bold) |
| 1 | K001 | −60.157 | TRP-5, PHE-8, LEU-9. |
| 2 | K001 A | −63.771 | SER-1, VAL-3, TRP-5, PHE-8, |
| | | | LEU-9. |
| 3 | K001 B | −103.988 | SER-1, VAL-3, TRP-5, PHE-8, |
| | | | LEU-9, GLU-11 |
| 4 | K001 C | −71.776 | SER-1, VAL-3, THR-4, TRP-5, |
| | | | PHE-8, LEU-9, GLU-11. |
| 5 | K001 D | −75.797 | SER-1, VAL-3, THR-4, TRP-5, |
| | | | PHE-8, LEU-9, GLU-11. |
| 6 | K001 E | −34.621 | SER-1, VAL-3, TRP-5, PHE-8, |
| | | | LEU-9, GLU-11. |
| 7 | K001 F | −76.36 | THR-4, TRP-5, TYR-6, ASP-7. |
| 8 | K001 G | −90.677 | SER-1, VAL-3, TRP-5, PHE-8, |
| | | | LEU-9, GLU-11. |

TABLE 6
Details of binding affinity of Antipsychotic derivative and its binding pocked residue
docked on Serotonin receptor (5HT_{2A}) (developed homology based 3D model)

| | | | Binding pocket | | A. A residue | | |
|---|---|---|---|---|---|---|---|
| | | Docking | residues(4 Å) (hydrogen | Atoms of Ligand | involved in | Length of | No. of |
| S. | | energy | bonded residues are | involved in | Docking | hydrogen | Hydrogen |
| No | Ligand | (Kcal/mol) | highlighted in bold) | Docking | interaction | bond (Å) | Bond (H)* |
| 1 | K001 | + | — | — | — | — | — |
| 2 | K001 A | −64.529 | PHE-218, ILE-250, LEU- | — | — | — | — |
| | | | 254, MET-258, LEU-294, | | | | |
| | | | ALA-297, VAL-298, LEU- | | | | |
| | | | 301, VAL-302 | | | | |
| 3 | K001 B | −74.38 | ASN-15, VAL-18, LEU-39, | — | — | — | — |
| | | | ALA-40, ASP-43, PHE-81, | | | | |
| | | | SER-85, LEU-89, ILE-92, | | | | |
| | | | VAL-251, PHE-252, LEU- | | | | |
| | | | 254, PHE-255, TRP-259, | | | | |
| | | | TYR-293, SER-295, SER- | | | | |
| | | | 296, ASN-299, PRO-300, | | | | |
| | | | VAL302, TYR-303, THR- | | | | |
| | | | 304, LEU-305, TYR-310, | | | | |
| | | | PHE-314 | | | | |
| 4 | K001 C | −90.25 | PHE-218, ILE-250, LEU- | — | — | — | — |
| | | | 254, MET-258, LEU-294, | | | | |
| | | | VAL-298, LEU-301, VAL- | | | | |
| | | | 302, TYR-303, ARG-311 | | | | |
| 5 | K001 D | −77.182 | VAL-7, LEU-10, VAL-257, | — | — | — | — |
| | | | ILE-250, LEU-254, MET- | | | | |
| | | | 258, LEU-294, VAL-298, | | | | |
| | | | LEU-301, VAL-302, TYR- | | | | |
| | | | 303 ARG-311 | | | | |
| 6 | K001 E | −19.551 | LEU-3, VAL-7, ILE-8, MET- | H5240-O75 | THR-11 | 2.082 | 1 |
| | | | 51, LEU-254, MET-258, | | | | |
| | | | TRP-290, ILE-291, TYR- | | | | |
| | | | 293, LEU-294, SER-296, | | | | |
| | | | ALA-297, VAL-298, | | | | |
| 7 | K001 F | −87.239 | PHE-167, LEU-170, VAL- | — | — | — | — |
| | | | 174, TYR-177, PHE-178, | | | | |
| | | | ILE-181, ILE-222, LYS- | | | | |
| | | | 246, PHE-253, VAL-256, | | | | |
| | | | VAL257, CYS-260, ILE- | | | | |
| | | | 264, | | | | |
| 8 | K001 G | −82.704 | THR-32, PHE-35, LEU-36, | — | — | — | — |
| | | | LEU-39, ALA-42, ASP-43, | | | | |
| | | | LEU-46, PHE-81, ALA-84, | | | | |
| | | | SER-85, ILE-86, HIS-88, | | | | |
| | | | LEU-89, ILE-92, SER-93, | | | | |
| | | | ARG-96, ARG-108, TYR- | | | | |
| | | | 177, CYS-245, LEU-248, | | | | |
| | | | VAL-251, PHE-252, LEU- | | | | |
| | | | 254, PHE-255, TRP-259, | | | | |
| | | | GLY-292, TYR-293, SER- | | | | |
| | | | 295, SER-296, VAL-298, | | | | |
| | | | ASN-299, LEU-305 | | | | |

TABLE 7
Predicted Antipsychotic activity of α-yohimbine derivatives

| S. No. | Compound Name | Pred. log IC50 (nM) | Pred. IC50 (nM) |
|---|---|---|---|
| (1) | Y1 | 3.748 | 5597.58 |
| (2) | Y2 | 2.878 | 755.09 |
| (3) | Y3 | 3.062 | 1153.45 |
| (4) | Y4 | 0.353 | 2.25 |
| (5) | Y5 | 1.876 | 75.16 |
| (6) | Y6 | 0.06 | 1.15 |
| (7) | Y7 | 0.358 | 2.28 |
| (8) | Y8 | 0.553 | 3.57 |
| (9) | Y9 | 0.402 | 2.52 |
| (10) | Y10 | 2.095 | 124.45 |
| (11) | Y11 | 0.208 | 1.61 |
| (12) | Y12 | 1.202 | 15.92 |
| (13) | Y13 | 1.228 | 16.90 |
| (14) | Y14 | 1.635 | 43.15 |
| (15) | Y15 | 1.097 | 12.50 |
| (16) | Y16 | 0.885 | 7.67 |
| (17) | Y17 | −0.012 | 0.97 |
| (18) | Y18 | 1.407 | 25.53 |
| (19) | Y19 | 0.083 | 1.21 |
| (20) | Y20 | −0.043 | 0.91 |
| (21) | Y21 | 0.479 | 3.01 |
| (22) | Y22 | 1.367 | 23.28 |
| (23) | Y23 | 0.094 | 1.24 |
| (24) | Y24 | −0.437 | 0.37 |
| (25) | Y25 | 1.534 | 34.20 |
| (26) | Y26 | −0.41 | 0.39 |
| (27) | Y27 | 0.789 | 6.15 |
| (28) | Y28 | 0.644 | 4.41 |
| (29) | Y29 | −0.208 | 0.62 |
| (30) | Y30 | 0.367 | 2.33 |
| (31) | Y31 | −0.745 | 0.18 |
| (32) | Y32 | 1.818 | 65.77 |
| (33) | Y33 | 1.476 | 29.92 |
| (34) | Y34 | −1.187 | 0.07 |
| (35) | Y35 | −0.696 | 0.20 |
| (36) | Y36 | 0.476 | 2.99 |
| (37) | Y37 | 0.785 | 6.10 |
| (38) | Y38 | 0.708 | 5.11 |
| (39) | Y39 | −0.717 | 0.19 |
| (40) | Y40 | 1.641 | 43.75 |
| (41) | Y41 | 1.612 | 40.93 |
| (42) | Y42 | −0.279 | 0.53 |
| (43) | Y43 | 1.014 | 10.33 |
| (44) | Y44 | −0.751 | 0.1.8 |
| (45) | Y45 | 0.857 | 7.19 |
| (46) | Y46 | 0.365 | 2.32 |
| (47) | Y47 | 0.057 | 1.14 |
| (48) | Y48 | 0.34 | 2.19 |
| (49) | Y49 | −0.269 | 0.54 |
| (50) | Y50 | 0.998 | 9.95 |
| (51) | Y51 | 2.904 | 801.68 |
| (52) | Y52 | 3.917 | 8260.38 |
| (53) | Y53 | 1.11 | 12.88 |
| (54) | Y54 | 0.513 | 3.26 |
| (55) | Y55 | −0.376 | 0.42 |
| (56) | Y56 | −0.827 | 0.15 |
| (57) | Y57 | −1.984 | 0.01 |
| (58) | Y58 | 1.985 | 96.61 |
| (59) | Y60 | −0.763 | 0.17 |
| (60) | Y61 | 4.803 | 63533.09 |
| (61) | Y62 | −0.921 | 0.12 |
| (62) | Y63 | 1.945 | 88.10 |
| (63) | Y64 | 4.539 | 34593.94 |
| (64) | Y65 | 0.663 | 4.60 |
| (65) | Y66 | −0.4 | 0.40 |
| (66) | Y67 | −0.778 | 0.17 |
| (67) | Y68 | 4.523 | 33342.64 |
| (68) | Y69 | 4.807 | 64120.96 |
| (69) | Y70 | −1.002 | 0.10 |
| (70) | Y71 | 4.517 | 32885.16 |
| (71) | Y72 | −0.861 | 0.14 |
| (72) | Y73 | 4.529 | 33806.48 |
| (73) | Y74 | 2.814 | 651.63 |
| (74) | Y75 | 3.712 | 5152.29 |
| (75) | Y76 | 1.878 | 75.51 |
| (76) | Y77 | 1.623 | 41.98 |
| (77) | Y78 | 1.445 | 27.86 |
| (78) | Y79 | 1.161 | 14.49 |
| (79) | Y80 | 1.33 | 21.38 |
| (80) | Y81 | 0.365 | 2.32 |
| (81) | Y82 | 1.923 | 83.75 |
| (82) | Y83 | 0.966 | 9.25 |
| (83) | Y84 | 0.81 | 6.46 |
| (84) | Y85 | 0.797 | 6.27 |
| (85) | Y86 | 1.707 | 50.93 |
| (86) | Y87 | 1.065 | 11.61 |
| (87) | Y88 | 1.191 | 15.52 |
| (88) | Y89 | 0.502 | 3.18 |
| (89) | Y90 | 0.572 | 3.73 |
| (90) | Y93 | 0.502 | 3.18 |
| (91) | Y95 | 0.812 | 6.49 |
| (92) | Y96 | 2.339 | 218.27 |
| (93) | Y97 | 1.78 | 60.26 |
| (94) | Y98 | −0.398 | 0.40 |
| (95) | Y99 | 1.119 | 13.15 |
| (96) | Y100 | 1.492 | 31.05 |

TABLE 8
Predicted Antipsychotic activity of α-yohimbine derivatives

| Compd | Activity | Status |
|---|---|---|
| Y69 | 4.807 | Close activity and drug likeness |
| Y61 | 4.803 | similar to Clozapine |
| Y64 | 4.539 | |
| Y73 | 4.529 | |
| Y68 | 4.523 | |
| Y71 | 4.517 | |
| Y52 | 3.917 | Moderate activity and drug likeness |
| Y1 | 3.748 | then Clozapine |
| Y75 | 3.712 | |
| Y3 | 3.062 | |
| Y51 | 2.904 | |
| Y2 | 2.878 | |
| Y74 | 2.814 | |
| Y96 | 2.339 | |
| Y10 | 2.095 | |
| Y58 | 1.985 | High activity but low drug likeness |
| Y63 | 1.945 | due to high extrapyramidal symptoms |
| Y82 | 1.923 | similar to Haloperidol |
| Y76 | 1.878 | |
| Y5 | 1.876 | |
| Y32 | 1.818 | |
| Y97 | 1.78 | |
| Y86 | 1.707 | |
| Y40 | 1.641 | |
| Y148* | 1.635 | |
| Y77 | 1.623 | |
| Y41 | 1.612 | |
| Y25 | 1.534 | |
| Y100 | 1.492 | |
| Y33 | 1.476 | |
| Y78 | 1.445 | |

*Irritation

TABLE 9
Details of binding affinity of α-yohimbine derivatives and its
binding pocked residue docked on dopamine D2 receptor (PDB ID: 2HLB)

| | | | Binding pocket | | A. A residue | | |
|---|---|---|---|---|---|---|---|
| | | Docking | residues(4 Å) (hydrogen | Atoms of Ligand | involved in | Length of | No. of |
| S. | | energy | bonded residues are | involved in | Docking | hydrogen | Hydrogen |
| No | Ligand | (Kcal/mol) | highlighted in bold) | Docking | interaction | bond (Å) | Bond (H)* |
| 1. | Y1 | −62.361 | SER-1, VAL-3, TRP-5, PHE-8, LEU-9, | — | — | — | — |
| | | | GLU-11 | | | | |
| 2. | Y2 | −61.625 | VAL-3, TRP-5, PHE-8, LEU-9 | — | — | — | — |
| 3. | Y3 | + | — | — | — | — | — |
| 4. | Y4 | −56.135 | VAL-3, THR-4, TRP-5, PHE-8, LEU-9 | — | — | — | — |
| 5. | Y5 | −29.992 | TRP-5, PHE-8, LEU-9 | — | — | — | — |
| 6. | Y6 | −66.561 | SER-1, VAL-3, TRP-5, ASP-7, PHE-8, | — | — | — | — |
| | | | LEU-9, GLU-11 | | | | |
| 7. | Y7 | −69.439 | VAL-3, THR-4, TRP-5, PHE-8, LEU-9, | — | — | — | — |
| | | | GLU-11 | | | | |
| 8. | Y8 | −65.497 | SER-1, VAL-3, TRP-5, PHE-8, LEU-9, | — | — | — | — |
| | | | GLU-11 | | | | |
| 9. | Y9 | + | — | — | — | — | — |
| 10. | Y10 | + | — | — | — | — | — |
| 11. | Y11 | −69.537 | SER-1, ARG-2, VAL-3, TRP-5, PHE-8, | — | — | — | — |
| | | | LEU-9, GLU-11 | | | | |
| 12. | Y12 | −68.453 | SER-1, VAL-3, TRP-5, PHE-8, LEU-9, | — | — | — | — |
| | | | GLU-11 | | | | |
| 13. | Y13 | −64.254 | VAL-3, THR-4, TRP-5, PHE-8, LEU-9, | — | — | — | — |
| | | | GLU-11 | | | | |
| 14. | Y14 | −9.781 | SER-1, VAL-3, THR-4, TRP-5, PHE-8, | — | — | — | — |
| | | | LEU-9, GLU-11 | | | | |
| 15. | Y15 | −65.324 | VAL-3, THR-4, TRP-5, PHE-8, LEU-9, | — | — | — | — |
| 16. | Y16 | −66.462 | SER-1, ARG-2, VAL-3, THR-4, TRP-5, | — | — | — | — |
| | | | PHE-8, LEU-9, GLU-11 | | | | |
| 17. | Y17 | −61.195 | SER-1, VAL-3, THR-4, TRP-5, ASP-7, | — | — | — | — |
| | | | PHE-8, GLU-11 | | | | |
| 18. | Y18 | + | — | — | — | — | — |
| 19. | Y19 | −61.895 | SER-1, ARG-2, VAL-3, TRP-5, PHE-8, | — | — | — | — |
| | | | LEU-9, GLU-11, | | | | |
| 20. | Y20 | −55.434 | SER-1, VAL-3, TYR-6, ASP-7, PHE-8, | — | — | — | — |
| | | | MET-10, GLU-11 | | | | |
| 21. | Y21 | −60.017 | SER-1, VAL-3, THR-4, TRP-5, PHE-8, | — | — | — | — |
| | | | LEU-9, GLU-11 | | | | |
| 22. | Y22 | −65.909 | SER-1, ARG-2, VAL-3, TRP-5, PHE-8, | — | — | — | — |
| | | | LEU-9, GLU-11 | | | | |
| 23. | Y23 | −66.311 | SER-1, ARG-2, VAL-3, TRP-5, PHE-8, | — | — | — | — |
| | | | LEU-9, GLU-11 | | | | |
| 24. | Y24 | −70.978 | SER-1, VAL-3, TRP-5, PHE-8, LEU-9, | — | — | — | — |
| | | | GLU-11 | | | | |
| 25. | Y25 | −53.796 | SER-1, VAL-3, TYR-6, ASP-7, PHE-8, | — | — | — | — |
| | | | MET-10, GLU-11 | | | | |
| 26. | Y26 | −70.139 | SER-1, VAL-3, THR-4, TRP-5, ASP-7, | — | — | — | — |
| | | | PHE-8, MET-10, GLU-11 | | | | |
| 27. | Y27 | −67.464 | SER-1, VAL-3, THR-4, TRP-5, ASP-7, | H59-O2854 | GLU-11 | 1.969 | 1 |
| | | | PHE-8, LEU-9, GLU-11 | | | | |
| 28. | Y28 | −51.885 | SER-1, VAL-3, THR-4, TRP-5, PHE-8, | — | — | — | — |
| | | | LEU-9, GLU-11 | | | | |
| 29. | Y29 | −62.368 | TRP-5, PHE-8, LEU-9, | — | — | — | — |
| 30. | Y30 | −66.209 | SER-1, VAL-3, THR-4, TRP-5, ASP-7, | — | — | — | — |
| | | | PHE-8, GLU-11 | | | | |
| 31. | Y31 | −66.25 | SER-1, ARG-2, VAL-3, THR-4, TRP-5, | — | — | — | — |
| | | | PHE-8, LEU-9, GLU-11 | | | | |
| 32. | Y32 | −65.332 | SER-1, VAL-3, TRP-5, PHE-8, LEU-9, | — | — | — | — |
| | | | GLU-11 | | | | |
| 33. | Y33 | −60.23 | VAL-3, THR-4, TRP-5, PHE-8, LEU-9, | — | — | — | — |
| | | | GLU-11 | | | | |
| 34. | Y34 | −76.54 | SER-1, ARG-2, VAL-3, TRP-5, PHE-8, | — | — | — | — |
| | | | LEU-9, GLU-11 | | | | |
| 35. | Y35 | −64.371 | VAL-3, THR-4, TRP-5, PHE-8, LEU-9, | — | — | — | — |
| | | | GLU-11 | | | | |
| 36. | Y36 | −55.672 | SER-1, VAL-3, ASP-7, PHE-8, MET-10, | — | — | — | — |
| | | | GLU-11 | | | | |
| 37. | Y37 | −64.218 | SER-1, VAL-3, THR-4, ASP-7, PHE-8, | — | — | — | — |
| | | | GLU-11 | | | | |
| 38. | Y38 | + | — | — | — | — | — |
| 39. | Y39 | −69.431 | SER-1, ARG-2, VAL-3, THR-4, TRP-5, | — | — | — | — |
| | | | PHE-8, LEU-9, GLU-11 | | | | |
| 40. | Y40 | −48.727 | SER-1, VAL-3, THR-4, TYR-6, ASP-7. | — | — | — | — |
| 41. | Y41 | −62.264 | SER-1, ARG-2, VAL-3, TRP-5, PHE-8, | — | — | — | — |
| | | | LEU-9, GLU-11 | | | | |
| 42. | Y42 | −61.929 | SER-1, ARG-2, VAL-3, TRP-5, PHE-8, | — | — | — | — |
| | | | LEU-9, GLU-11 | | | | |
| 43. | Y43 | −57.496 | VAL-3, TRP-5, PHE-8, LEU-9, GLU-11 | — | — | — | — |
| 44. | Y44 | −62.146 | VAL-3, TRP-5, PHE-8, LEU-9, | — | — | — | — |
| 45. | Y45 | −66.132 | SER-1, ARG-2, VAL-3, TRP-5, PHE-8, | — | — | — | — |
| | | | LEU-9, GLU-11 | | | | |
| 46. | Y46 | −64.544 | SER-1, VAL-3, TRP-5, PHE-8, LEU-9, | — | — | — | — |
| | | | GLU-11 | | | | |
| 47. | Y47 | −40.518 | VAL-3, THR-4, TRP-5, PHE-8, LEU-9, | — | — | — | — |
| | | | GLU-11 | | | | |
| 48. | Y48 | −49.712 | VAL-3, THR-4, TRP-5, PHE-8, LEU-9, | — | — | — | — |
| 49. | Y49 | −56.505 | SER-1, ARG-2, VAL-3, THR-4, TRP-5, | — | — | — | — |
| | | | ASP-7, PHE-8, GLU-11 | | | | |
| 50. | Y50 | −63.351 | VAL-3, THR-4, TRP-5, PHE-8, LEU-9, | — | — | — | — |
| | | | GLU-11 | | | | |
| 51. | Y51 | −89.968 | ARG-2, VAL-3, THR-4, TRP-5, TYR-6, | — | — | — | — |
| | | | ASP-7, | | | | |
| 52. | Y52 | −76.155 | THR-4, TRP-5, TYR-6, ASP-7. | — | — | — | — |
| 53. | Y53 | −75.042 | SER-1, VAL-3, TRP-5, PHE-8, LEU-9, | — | — | — | — |
| | | | GLU-11 | | | | |
| 54. | Y54 | −70.542 | SER-1, ARG-2, VAL-3, TRP-5, PHE-8, | — | — | — | — |
| | | | LEU-9, GLU-11 | | | | |
| 55. | Y55 | −75.21 | SER-1, VAL-3, TRP-5, PHE-8, LEU-9, | — | — | — | — |
| 56. | Y56 | −86.514 | SER-1, VAL-3, TRP-5, PHE-8, LEU-9, | — | — | — | — |
| | | | GLU-11 | | | | |
| 57. | Y57 | −73.805 | SER-1, TRP-5, PHE-8, LEU-9, GLU-11 | — | — | — | — |
| 58. | Y58 | −81.94 | VAL-3, THR-4, TRP-5, TYR-6, ASP-7, | — | — | — | — |
| 59. | Y60 | −63.811 | ARG-2, VAL-3, THR-4, TRP-5, PHE-8, | — | — | — | — |
| | | | LEU-9, | | | | |
| 60. | Y61 | −56.749 | SER-1, VAL-3, TRP-5, PHE-8, LEU-9, | — | — | — | — |
| | | | GLU-11 | | | | |
| 61. | Y62 | −70.328 | VAL-3, TRP-5, PHE-8, LEU-9, GLU-11 | — | — | — | — |
| 62. | Y63 | −66.032 | SER-1, ARG-2, VAL-3, TRP-5, PHE-8, | — | — | — | — |
| | | | LEU-9, GLU-11 | | | | |
| 63. | Y64 | −59.312 | THR-4 TRP-5, TYR-6, ASP-7 | — | — | — | — |
| 64. | Y65 | −63.064 | SER-1, ARG-2, VAL-3, TRP-5, PHE-8, | — | — | — | — |
| | | | LEU-9, GLU-11 | | | | |
| 65. | Y66 | −82.837 | SER-1, VAL-3, THR-4, TRP-5, PHE-8, | — | — | — | — |
| | | | LEU-9, | | | | |
| 66. | Y67 | −80.545 | VAL-3, THR-4, TRP-5, PHE-8, LEU-9 | — | — | — | — |
| 67. | Y68 | −61.815 | THR-4,, TRP-5, TYR-6, ASP-7 | — | — | — | — |
| 68. | Y69 | −64.747 | THR-4, TRP-5, TYR-6, ASP-7, | — | — | — | — |
| 69. | Y70 | −82.067 | THR-4, TYR-6, ASP-7,, MET-10, GLU-11 | H67-O2811, | TYR-6, | 2.081, | 2 |
| | | | | H68-2819 | ASP-7 | 1.970 | |
| 70. | Y71 | −60.827 | THR-4, TRP-5, TYR-6, ASP-7 | — | — | — | — |
| 71. | Y72 | −49.618 | VAL-3, TRP-5, PHE-8, LEU-9, | — | — | — | — |
| 72. | Y73 | −61.032 | THR-4, TRP-5, TYR-6, ASP-7 | — | — | — | — |
| 73. | Y74 | −78.512 | THR-4, TRP-5, TYR-6, ASP-7, MET-10, | — | — | — | — |
| | | | GLU-11 | | | | |
| 74. | Y75 | −69.276 | SER-1, VAL-3, TRP-5, PHE-8, LEU-9, | — | — | — | — |
| | | | GLU-11 | | | | |
| 75. | Y76 | −72.747 | THR-4, TRP-5, TYR-6, ASP-7,, MET-10 | — | — | — | — |
| 76. | Y77 | + | — | — | — | — | — |
| 77. | Y78 | −55.621 | SER-1, VAL-3, TYR-6, ASP-7, MET-10 | — | — | — | — |
| 78. | Y79 | −73.119 | SER-1, VAL-3, TRP-5, PHE-8, LEU-9, | — | — | — | — |
| | | | GLU-11 | | | | |
| 79. | Y80 | −56.108 | SER-1, ARG-2, VAL-3, TRP-5, PHE-8, | — | — | — | — |
| | | | LEU-9, | | | | |
| 80. | Y81 | −74.071 | SER-1, VAL-3, THR-4, TRP-5, PHE-8, | — | — | — | — |
| | | | LEU-9, GLU-11 | | | | |
| 81. | Y82 | −64.819 | VAL-3, THR-4, TRP-5, PHE-8, LEU-9, | — | — | — | — |
| | | | ASP-12 | | | | |
| 82. | Y83 | −80.42 | SER-1, VAL-3, TRP-5, PHE-8, LEU-9, | — | — | — | — |
| | | | GLU-11 | | | | |
| 83. | Y84 | −75.188 | SER-1, ARG-2, VAL-3, TRP-5, ASP-7, | — | — | — | — |
| | | | PHE-8, LEU-9, GLU-11 | | | | |
| 84. | Y85 | −69.754 | SER-1, VAL-3, THR-4, TRP-5, PHE-8, | — | — | — | — |
| | | | LEU-9, | | | | |
| 85. | Y86 | −75.272 | SER-1, VAL-3, TRP-5, PHE-8, LEU-9, | — | — | — | — |
| | | | GLU-11 | | | | |
| 86. | Y87 | −70.373 | SER-1, VAL-3, TRP-5, PHE-8, LEU-9, | — | — | — | — |
| | | | GLU-11 | | | | |
| 87. | Y88 | −78.238 | THR-4, TRP-5, TYR-6, ASP-7, MET-10 | — | — | — | — |
| 88. | Y89 | −75.968 | SER-1, VAL-3, THR-4, TRP-5, PHE-8, | — | — | — | — |
| | | | LEU-9, GLU-11 | | | | |
| 89. | Y90 | −68.038 | SER-1, VAL-3, THR-4, TRP-5, PHE-8, | — | — | — | — |
| | | | LEU-9, GLU-11, ASP-12 | | | | |
| 90. | Y93 | −29.958 | VAL-3, TRP-5, PHE-8, LEU-9, | — | — | — | — |
| 91. | Y95 | −76.438 | SER-1, ARG-2, VAL-3, TRP-5, PHE-8, | — | — | — | — |
| | | | LEU-9, GLU-11 | | | | |
| 92. | Y96 | −76.993 | THR-4, TRP-5, TYR-6, ASP-7. | — | — | — | — |
| 93. | Y97 | −65.088 | VAL-3, TRP-5, PHE-8, LEU-9, GLU-11 | — | — | — | — |
| 94. | Y98 | −75.825 | SER-1, ARG-2, VAL-3, TRP-5, PHE-8, | — | — | — | — |
| | | | LEU-9, GLU-11 | | | | |
| 95. | Y99 | −83.905 | SER-1, VAL-3, THR-4, TRP-5, ASP-7, | — | — | — | — |
| | | | PHE-8, LEU-9, GLU-11 | | | | |
| 96. | Y100 | −73.24 | SER-1, ARG-2, VAL-3, TRP-5, PHE-8, | — | — | — | — |
| | | | LEU-9, GLU-11 | | | | |

TABLE 10
Details of α-yohimbine derivatives which showed binding affinity and their binding
pocked residue docked on Serotonin receptor (5HT2A) (developed homology based 3D model)

| | | | | Atoms of | A. A residue | | |
|---|---|---|---|---|---|---|---|
| | | Docking | Binding pocket residues(4 Å) | Ligand | involved in | Length of | No. of |
| S. | | energy | (hydrogen bonded residues are | involved in | Docking | hydrogen | Hydrogen |
| No | Ligand | (Kcal/mol) | highlighted in bold) | Docking | interaction | bond (Å) | Bond (H)* |
| 1 | Y1 | −62.361 | LEU-3, VAL-7, LEU-254, MET- | — | — | — | — |
| | | | 258, VAL-287, TRP-290, ILE-291, | | | | |
| | | | LEU-294, VAL-298, LEU-301. | | | | |
| 2 | Y2 | −61.625 | PHE-218, LYS-246, VAL-247, ILE- | — | — | — | — |
| | | | 250, LEU-294, VAL-298, LEU-301, | | | | |
| | | | VAL-302, TYR-303. | | | | |
| 3 | Y6 | −66.561 | LEU-170, VAL-174, PHE-253, | — | — | — | — |
| | | | VAL-256, VAL-257, CYS-260, | | | | |
| | | | PRO-261, ILE-264, | | | | |
| 4 | Y7 | −69.439 | PHE-218, LYS-246, VAL-247, ILE- | — | — | — | — |
| | | | 250, LEU-254, VAL-298, LEU-301, | | | | |
| | | | VAL-302, TYR-303, THR-304, | | | | |
| | | | ARG-311. | | | | |
| 5 | Y12 | −68.453 | LEU-3, VAL-7, LEU-254, MET- | — | — | — | — |
| | | | 258, VAL-287, TRP-290, ILE-291, | | | | |
| | | | LEU-294, VAL-298, LEU-301. | | | | |
| 6 | Y26 | −70.139 | PHE-218, VAL-247, ILE-250, | — | — | — | — |
| | | | LEU-254, MET-258, LEU-294, | | | | |
| | | | VAL-298, LEU-301, VAL-302, | | | | |
| | | | TYR-303. THR-304, | | | | |
| 7 | Y44 | −62.146 | PHE-218, LYS-246, ILE-250, | — | — | — | — |
| | | | LEU-254, MET-258, LEU-294, | | | | |
| | | | VAL-298, LEU-301, VAL-302, | | | | |
| | | | TYR-303. THR-304,. | | | | |
| 8 | Y52 | −75.21 | PHE-218, VAL-247, ILE-250, | — | — | — | — |
| | | | LEU-254, LEU-294, VAL-298, | | | | |
| | | | LEU-301, VAL-302, TYR-303. | | | | |
| | | | THR-304, | | | | |
| 9 | Y55 | −86.514 | ILE-250, LEU-254, LEU-294, VAL- | — | — | — | — |
| | | | 298, LEU-301, VAL-302, TYR-303. | | | | |
| 10 | Y56 | −81.94 | LEU-174, VAL-174, PHE-178, ILE- | — | — | — | — |
| | | | 181, LYS-182, CYS-245, LYS-246, | | | | |
| | | | GLY-249, ILE-250, PHE-253, VAL- | | | | |
| | | | 256, VAL-257, CYS-260, PRO- | | | | |
| | | | 261, ILE-264, | | | | |
| 11 | D58 | −63.811 | VAL-7, PHE-218, ILE-250, LEU- | — | — | — | — |
| | | | 254, MET-258,, LEU-294, VAL- | | | | |
| | | | 298, LEU-301. VAL-302, | | | | |
| 12 | Y60 | −62.361 | PHE-218, LYS-246, VAL-247, | — | — | — | — |
| | | | ILE-250, LEU-254, LEU-294, VAL- | | | | |
| | | | 298, LEU-301, VAL-302, TYR-303. | | | | |
| | | | THR-304, | | | | |
| 13 | Y 61 | −56.749 | PHE-167, LEU-170, THR-171, | — | — | — | — |
| | | | VAL-174, PHE-253, VAL-256, | | | | |
| | | | VAL-257, CYS-260, ILE-264. | | | | |
| 14 | Y64 | −59.312 | LEU-170, VAL-174, PHE-178, ILE- | — | — | — | — |
| | | | 181, LYS-182, PHE-253, VAL- | | | | |
| | | | 256, VAL-257, CYS-260, | | | | |
| 15 | Y68 | −61.815 | PHE-167, LEU-170, THR-171, | — | — | — | — |
| | | | VAL-174, PHE-178, PHE-253, | | | | |
| | | | VAL-256, VAL-257, CYS-260, ILE- | | | | |
| | | | 264. | | | | |
| 16 | Y69 | −64.747 | PHE-167, LEU-170, THR-171, | — | — | — | — |
| | | | VAL-174, PHE-178, PHE-25e3, | | | | |
| | | | VAL-256, VAL-257, CYS-260, ILE- | | | | |
| | | | 264. | | | | |
| 17 | Y70 | −82.067 | PHE-218, LYS-246, ILE-250, LEU- | — | — | — | — |
| | | | 254, MET-258, LEU-294, VAL- | | | | |
| | | | 298, LEU-301, VAL-302, TYR-303. | | | | |
| | | | THR-304 | | | | |
| 18 | Y71 | −60.827 | LEU-170, VAL-174, PHE-178, ILE- | — | — | — | — |
| | | | 181, LYS-182, PHE-253, VAL- | | | | |
| | | | 256, VAL-257, | | | | |
| 19 | Y73 | −61.032 | LEU-170, VAL-174, PHE-178, ILE- | — | — | — | — |
| | | | 181, LYS-182, PHE-253, VAL- | | | | |
| | | | 256, VAL-257, | | | | |
| 20 | Y74 | −78.512 | PHE-218, LYS-246, VAL-247 ILE- | — | — | — | — |
| | | | 250, LEU-254, MET-258, LEU- | | | | |
| | | | 294, VAL-298, LEU-301, VAL-302, | | | | |
| | | | TYR-303. THR-304 | | | | |
| 21 | Y75 | −69.276 | PHE-218, LYS-246, ILE-250, LEU- | — | — | — | — |
| | | | 254, LEU-294, VAL-298, LEU- | | | | |
| | | | 301, VAL-302, TYR-303. THR-304 | | | | |
| 22 | Y78 | −55.621 | LEU-3, THR-4, VAL-7, MET-51, | — | — | — | — |
| | | | LEU-254, MET-258, TRP-290, | | | | |
| | | | ILE-291, TYR-293, LEU-294, ALA- | | | | |
| | | | 297, VAL-298, LEU-301, | | | | |
| 23 | Y83 | −80.42 | LEU-170, VAL-174, PHE-178, | — | — | — | — |
| | | | PHE-253, VAL-256, VAL-257, | | | | |
| | | | PRO-261, ILE-264, | | | | |
| 24 | Y84 | −75.188 | LEU-3, THR-4, VAL-7, MET-51, | H5133- | TRP-90 | 2.005 | 1 |
| | | | LEU-254, MET-258, TRP-290, | O2246 | | | |
| | | | ILE-291, TYR-293, LEU-294, VAL- | | | | |
| | | | 298, LEU-301, | | | | |
| 25 | Y86 | −75.272 | LEU-170, VAL-174, PHE-178, ILE- | — | — | — | — |
| | | | 182, LYS-182, PHE-253, VAL- | | | | |
| | | | 256, VAL-257, CYS-260, PRO- | | | | |
| | | | 261, ILE-264 | | | | |
| 26 | Y96 | −76.993 | PHE-218, VAL-247 ILE-250, LEU- | — | — | — | — |
| | | | 254, MET-258, LEU-294, VAL- | | | | |
| | | | 298, LEU-301, VAL-302, THR-304 | | | | |

TABLE 11
Predicted Antipsychotic activity of risperidone derivatives

| | Compound | Pred. log | Pred. |
|---|---|---|---|
| S. No. | Name | IC50 (nM) | IC50(nM) |
| 1 | R1 | 3.477 | 2999.16 |
| 2 | R2 | 5.695 | 495450.19 |
| 3 | R4- | 2.894 | 783.43 |
| 4 | R5 | 3.913 | 8184.65 |
| 5 | R6 | 3.189 | 1545.25 |
| 6 | R7 | 3.198 | 1577.61 |
| 7 | R8 | 2.727 | 533.33 |
| 8 | R9 | 1.658 | 45.50 |
| 9 | R10 | 3.295 | 1972.42 |
| 10 | R11 | 2.7 | 501.19 |
| 11 | R12 | 4.262 | 18281.00 |
| 12 | R13 | 4.276 | 18879.91 |
| 13 | R14 | 3.704 | 5058.25 |
| 14 | R15 | 3.332 | 2147.83 |
| 15 | R16 | 3.871 | 7430.19 |
| 16 | R18 | 3.604 | 4017.91 |
| 17 | R19 | 2.517 | 328.85 |
| 18 | R20 | 2.733 | 540.75 |
| 19 | R21 | 2.906 | 805.38 |
| 20 | R22 | 3.184 | 1527.57 |
| 21 | R23 | 3.24 | 1737.80 |
| 22 | R24 | 2.887 | 770.90 |
| 23 | R25 | 3.854 | 7144.96 |
| 24 | R26 | 3.713 | 5164.16 |
| 25 | R27 | 3.087 | 1221.80 |
| 26 | R28 | 2.905 | 803.53 |
| 27 | R29 | 2.392 | 246.60 |
| 28 | R30 | 2.882 | 762.08 |
| 29 | R31 | 1.66 | 45.71 |
| 30 | R32 | 3.716 | 5199.96 |
| 31 | R33 | 3.434 | 2716.44 |
| 32 | R34 | 1.979 | 95.28 |
| 33 | R35 | 1.844 | 69.82 |
| 34 | R36 | 3.67 | 4677.35 |
| 35 | R37 | 3.548 | 3531.83 |
| 36 | R38 | 2.815 | 653.13 |
| 37 | R39 | 2.299 | 199.07 |
| 38 | R40 | 5.259 | 181551.57 |
| 39 | R41 | 3.948 | 8871.56 |
| 40 | R42 | 2.582 | 381.94 |
| 41 | R43 | 4.218 | 16519.62 |
| 42 | R44 | 7.424 | 26546055.62 |
| 43 | R45 | 9.458 | 2870780582.02 |
| 44 | R47 | 5.972 | 937562.01 |
| 45 | R48 | 3.033 | 1078.95 |
| 46 | R49 | 3.22 | 1659.59 |
| 47 | R50 | 25.443 | Out of range |
| 48 | R51 | 4.441 | 27605.78 |
| 49 | R52 | 17.384 | Out of range |
| 50 | R53 | 3.442 | 2766.94 |
| 51 | R54 | 15.771 | Out of range |
| 52 | R55 | 1.27 | 18.62 |
| 53 | R56 | 0.21 | 1.62 |
| 54 | R57 | 3.968 | 9289.66 |
| 55 | R58 | 4.543 | 34914.03 |
| 56 | R59 | 18.704 | Out of range |
| 57 | R60 | 26.078 | Out of range |
| 58 | R61 | 4.838 | 68865.23 |
| 59 | R62 | 4.121 | 13212.96 |
| 60 | R63 | 3.094 | 1241.65 |
| 61 | R64 | 15.049 | Out of range |
| 62 | R65 | 1.432 | 27.04 |
| 63 | R66- | 12.075 | Out of range |
| 64 | R67 | 17.601 | Out of range |
| 65 | R68 | 4.302 | 20044.72 |

TABLE 12
Predicted Antipsychotic activity of active riserpinine derivatives

| Compd | Activity | Status |
|---|---|---|
| R49 | 3.22 | Close activity and drug likeness |
| R7 | 3.198 | similar to Clozapine |
| R6 | 3.189 | |
| R22 | 3.184 | |
| R63 | 3.094 | |
| R27 | 3.087 | |
| R48 | 3.033 | |
| R21 | 2.906 | Moderate activity and druglikeness |
| R28 | 2.905 | then Clozapine |
| R4 | 2.894 | |
| R24 | 2.887 | |
| R30 | 2.882 | |
| R30 | 2.882 | |
| R38 | 2.815 | |
| R20 | 2.733 | |
| R8 | 2.727 | |
| R11 | 2.7 | |
| R42 | 2.582 | |
| R19 | 2.517 | |
| R29 | 2.392 | |
| R39 | 2.299 | |
| R34 | 1.979 | High activity but low druglikeness |
| R35 | 1.844 | dur to high extrapyramidal symptoms |
| R31 | 1.66 | similar to Haloperidol |
| R9 | 1.658 | |

TABLE 13
Details of binding affinity of risperidone derivative and its binding
pocked residue docked on Dopamine D2 receptor: (PDB ID: 2HLB)

| | | Docking energy | Binding pocket residues(4 Å) (hydrogen |
|---|---|---|---|
| S. No | Ligand | (Kcal/mol) | bonded residues are highlighted in bold) |
| 1 | R1 | −57.257 | SER-1, VAL-3, THR- 4, TRP-5, PHE-8, GLU-11 |
| 2 | R2 | −69.166 | SER-1, VAL-3, THR- 4, TRP-5, PHE-8, LEU-9, GLU-11 |
| 3 | R4 | −64.415 | VAL-3, TRP-5, PHE-8, LEU-9 |
| 4 | R5 | −68.626 | THR- 4, TRP-5, TYR-6, ASP-7, MET- 10, GLU- 11 |
| 5 | R6 | −78.129 | ARG-2, VAL-3, TRP-5, PHE-8, LEU-9, GLU-11 |
| 6 | R7 | −73.308 | SER-1, VAL-3, THR- 4, TRP-5, PHE-8, LEU-9, GLU-11 |
| 7 | R8 | −51.754 | SER-1, ARG-2, VAL-3, THR- 4, TYR-6, ASP-7, PHE-8, GLU-11 |
| 8 | R9 | −66.593 | SER-1, VAL-3, THR- 4, TRP-5, ASP-7, PHE-8, LEU-9, MET- 10, |
| | | | GLU-11 |
| 9 | R10 | −68.53 | ARG-2, VAL-3, TRP-5, PHE-8, LEU-9, GLU-11 |
| 10 | R11 | −63.635 | SER-1, VAL-3, THR- 4, TRP-5, ASP-7, PHE-8, LEU-9, GLU-11 |
| 11 | R12 | −59.29 | SER-1, ARG-2, VAL-3, TRP-5, PHE-8, LEU-9, GLU-11 |
| 12 | R13 | −73.589 | SER-1, VAL-3, THR- 4, TRP-5, PHE-8, LEU-9, GLU-11 |
| 13 | R14 | −67.478 | SER-1, VAL-3, TRP-5, PHE-8, LEU-9, GLU-11 |
| 14 | R15 | −68.461 | SER-1, VAL-3, TRP-5, PHE-8, LEU-9, GLU-11 |
| 15 | R16 | −58.394 | SER-1, ARG-2, VAL-3, TRP-5, PHE-8, LEU-9, GLU-11 |
| 16 | R18 | −51.141 | SER-1, VAL-3, THR-4, TRP-5, ASP-7, PHE-8, GLU-11 |
| 17 | R19 | −58.32 | SER-1, VAL-3, THR-4, TRP-5, ASP-7, PHE-8, GLU-11 |
| 18 | R20 | −68.987 | SER-1, VAL-3, THR-4, TRP-5, PHE-8, LEU-9, GLU-11 |
| 19 | R21 | −68.301 | SER-1, ARG-2, VAL-3, TRP-5, PHE-8, LEU-9, GLU-11 |
| 20 | R22 | −64.974 | VAL-3, THR-4, TRP-5, TYR-6, ASP-7, |
| 21 | R23 | −72.472 | VAL-3, TRP-5, PHE-8, LEU-9, GLU-11 |
| 22 | R24 | −77.404 | SER-1, ARG-2, VAL-3, TRP-5, PHE-8, LEU-9, GLU-11 |
| 23 | R25 | −60.435 | TRP-5, PHE-8, LEU-9 |
| 24 | R26 | −77.841 | VAL-3, THR-4, TRP-5, PHE-8, LEU-9 |
| 25 | R27 | −70.436 | VAL-3, TRP-5, PHE-8, LEU-9 |
| 26 | R28 | −59.733 | SER-1, ARG-2, VAL-3, TRP-5, PHE-8, LEU-9, GLU-11 |
| 27 | R29 | −66.103 | SER-1, VAL-3, TRP-5, PHE-8, LEU-9, GLU-11 |
| 28 | R30 | −59.664 | SER-1, VAL-3, THR-4, TRP-5, ASP-7, PHE-8, LEU-9, GLU-11 |
| 29 | R31 | −67.961 | SER-1, ARG-2, VAL-3, TRP-5, PHE-8, LEU-9 |
| 30 | R32 | −60.701 | SER-1, VAL-3, THR-4, TRP-5, PHE-8, LEU-9, GLU-11 |
| 31 | R33 | −62.66 | SER-1, ARG-2, VAL-3, TRP-5, PHE-8, LEU-9 |
| 32 | R34 | −61.825 | SER-1, VAL-3, TRP-5, PHE-8, GLU-11 |
| 33 | R35 | −59.14 | ARG-2, VAL-3, THR- 4, TRP-5, PHE-8, LEU-9, GLU-11 |
| 34 | R36 | −62.484 | VAL-3, THR-4, TRP-5, PHE-8, LEU-9 |
| 35 | R37 | −66.094 | SER-1, ARG-2, VAL-3, TRP-5, PHE-8, LEU-9, GLU-11 |
| 36 | R38 | −46.689 | TRP-5, PHE-8, LEU-9, GLU-11 |
| 37 | R39 | −77.679 | SER-1, ARG-2, VAL-3, TRP-5, PHE-8, LEU-9, GLU-11 |
| 38 | R40 | −65.642 | SER-1, ARG-2, VAL-3, THR-4, TRP-5, PHE-8, LEU-9, GLU-11 |
| 39 | R41 | −53.354 | SER-1, VAL-3, THR-4, TRP-5, PHE-8, LEU-9, GLU-11 |
| 40 | R42 | −63.746 | SER-1, VAL-3, THR-4, TRP-5, PHE-8, LEU-9, GLU-11 |
| 41 | R43 | −69.228 | VAL-3, TRP-5, PHE-8, LEU-9 |
| 42 | R44 | −67.006 | SER-1, VAL-3, TRP-5, PHE-8, LEU-9, GLU-11 |
| 43 | R45 | −70.496 | SER-1, ARG-2, VAL-3, TRP-5, PHE-8, LEU-9, GLU-11 |
| 44 | R47 | −70.007 | ARG-2, VAL-3, TRP-5, PHE-8, LEU-9 |
| 45 | R48 | −68.35 | SER-1, ARG-2, VAL-3, TRP-5, PHE-8, LEU-9, GLU-11 |
| 46 | R49 | −73.165 | SER-1, VAL-3, THR-4, TRP-5, PHE-8, LEU-9, GLU-11 |
| 47 | R50 | −74.755 | SER-1, VAL-3, THR-4, TRP-5, ASP-7, PHE- 8, MET- 10, GLU- |
| | | | 11 |
| 48 | R51 | −67.105 | SER-1, VAL-3, THR-4, TRP-5, PHE-8, LEU-9, GLU-11 |
| 49 | R52 | −83.198 | SER-1, VAL-3, TRP-5, PHE-8, LEU-9, GLU-11 |
| 50 | R53 | −84.867 | SER-1, ARG-2, VAL-3, TRP-5, PHE-8, LEU-9, GLU-11 |
| 51 | R54 | −99.516 | SER-1, VAL-3, TRP-5, PHE-8, LEU-9, GLU-11 |
| 52 | R55 | −67.386 | SER-1, VAL-3, TRP-5, ASP-7, PHE-8, GLU-11 |
| 53 | R56 | −59.88 | SER-1, VAL-3, THR-4, TRP-5, TYR- 6, ASP-7, PHE-8, MET- 10, |
| | | | GLU-11 |
| 54 | R57 | −78.352 | SER-1, ARG-2, VAL-3, THR-4, TRP-5, PHE-8, LEU-9 |
| 55 | R58 | −64.778 | SER-1, VAL-3, THR- 4, TRP-5, PHE-8, GLU-11 |
| 56 | R59 | −75.029 | SER-1, VAL-3, THR- 4, TRP-5, PHE-8, LEU-9, GLU-11 |
| 57 | R60 | −71.309 | SER-1, ARG-2, VAL-3, THR- 4, ASP-7, PHE-8, GLU-11 |
| 58 | R61 | −59.475 | TRP-5, PHE-8, LEU-9, GLU-11 |
| 59 | R62 | −80.136 | SER-1, VAL-3, THR- 4, TRP-5, PHE-8, LEU-9, GLU-11 |
| 60 | R63 | −95.228 | SER-1, VAL-3, TRP-5, PHE-8, LEU-9, GLU-11 |
| 61 | R64 | −59.228 | VAL-3, THR-4, TYR-6, ASP-7, MET- 10, GLU- 11 |
| 62 | R65 | −82.799 | SER-1, VAL-3, THR- 4, TRP-5, ASP-7, PHE-8, LEU-9, GLU-11 |
| 63 | R66- | −81.759 | SER-1, ARG-2, VAL-3, TRP-5, TYR-6, ASP-7, PHE-8, MET- 10, |
| | | | GLU- 11 |
| 64 | R67 | −86.806 | SER-1, VAL-3, TRP-5, PHE-8, LEU-9, GLU-11, ASP- 12 |
| 65 | R68 | −61.144 | TRP-5, PHE-8, LEU-9, GLU-11 |

TABLE 14
Details of binding affinity of risperidone derivatives and its binding pocked residue
docked on Serotonin receptor (5HT_{2A}) (developed homology based 3D model)

| | | Docking energy | Binding pocket residues(4 Å) (hydrogen |
|---|---|---|---|
| S. No | Ligand | (Kcal/mol) | bonded residues are highlighted in bold) |
| 1 | R1 | −57.257 | PHE-218, LYS-246, VAL- 247, ILE- 250, VAL-298, LEU-301, |
| | | | VAL-302, TYR- 303, THR- 304, ARG- 311 |
| 2 | R2 | −69.166 | VAL- 174, PHE- 253, VAL- 256, VAL- 257, CYS- 260, PRO- 261, |
| | | | ILE- 264 |
| 3 | R8 | −51.754 | ILE- 250, PHE- 253, LEU- 254, MET- 258, LEU- 294, VAL- 298, |
| | | | LEU- 301, VAL- 302 |
| 4 | R11 | −63.635 | LEU- 3, VAL- 7, LEU- 254, VAL - 257, MET- 258, TRP-290, ILE- |
| | | | 291, LEU- 294, VAL- 298, LEU- 301 |
| 5 | R12 | −59.29 | PHE-218, LYS-246, VAL- 247, ILE- 250, LEU- 254, VAL- 298, |
| | | | LEU- 301, VAL-302, TYR- 303, THR- 304, ARG- 311 |
| 6 | R18 | −51.141 | PHE-218, LYS-246, VAL- 247, ILE- 250, LEU- 254, VAL- 298, |
| | | | LEU- 301, VAL-302, TYR- 303, THR- 304, ARG- 311 |
| 7 | R22 | −64.974 | VAL- 247, ILE- 250, PHE- 253, LEU- 254, VAL - 257, VAL- 298, |
| | | | LEU- 301, VAL-302, TYR- 303 THR- 304 |
| 8 | R25- | −60.435 | ILE- 250, LEU- 254, MET- 258, LEU- 294, VAL- 298, LEU- 301, |
| | | | VAL- 302, TYR- 303, ARG- 311 |
| 9 | R28 | −59.733 | PHE-218, LYS-246, VAL- 247, ILE- 250, LEU- 254, VAL - 257, |
| | | | MET- 258, LEU- 294, VAL- 298, LEU- 301, VAL- 302, TYR- 303 |
| 10 | R30 | −59.664 | PHE-218, VAL- 247, ILE- 250, LEU- 254, VAL - 257, MET- 258, |
| | | | LEU- 294, VAL- 298, LEU- 301, VAL- 302, TYR- 303 |
| 11 | R31 | −67.961 | VAL- 247, ILE- 250, PHE- 253, LEU- 254, VAL - 257, MET- 258, |
| | | | LEU- 294, VAL- 298, LEU- 301, VAL- 302, TYR- 303, THR- 304 |
| 12 | R32 | −60.701 | PHE-218, LYS-246, VAL- 247, ILE- 250, LEU- 254, LEU- 294, |
| | | | VAL- 298, LEU- 301, VAL- 302, TYR- 303, THR- 304, ARG- 311 |
| 13 | R34 | −61.825 | PHE-218, ILE- 250, PHE- 253, LEU- 254, VAL - 257, MET- 258, |
| | | | LEU- 294, ALA-297, VAL- 298, LEU- 301, VAL- 302, TYR- 303, |
| | | | THR- 304 |
| 14 | R37 | −66.094 | PHE-218, VAL- 247, ILE- 250, PHE- 253, LEU- 254, VAL - 257, |
| | | | VAL- 298, LEU- 301, VAL- 302, TYR- 303, THR- 304 |
| 15 | R49 | −73.165 | PHE-218, LYS-246, VAL- 247, ILE- 250, LEU- 254, MET 258, |
| | | | LEU- 294, VAL- 298, LEU- 301, VAL- 302, TYR- 303, THR- 304, |
| 16 | R51 | −67.105 | ILE- 250, LEU- 254, MET 258, LEU- 294, VAL- 298, LEU- 301, |
| | | | VAL- 302, TYR- 303, ARG-311 |
| 17 | R61 | −59.475 | LEU- 10, PHE-218, LYS-246, VAL- 247, ILE- 250, LEU- 294, |
| | | | ALA- 297,, VAL- 298, LEU- 301, VAL- 302, TYR- 303, THR- |
| | | | 304, |
| 18 | R67 | −86.806 | VAL- 7, ILE- 250, LEU- 254, MET 258, ILE- 291, LEU- 294, VAL- |
| | | | 298, LEU- 301, VAL- 302, TYR- 303 |

TABLE 15
Predicted Antipsychotic activity of K004A derivatives

| | Compound | Pred. log | Pred. |
|---|---|---|---|
| S. No. | Name | IC50 (nM) | IC50 (nM) |
| 1 | 11DR1 | 3.76 | 5754.40 |
| 2 | 11DR2 | 4.018 | 10423.17 |
| 3 | 11DR3 | 4.589 | 38815.04 |
| 4 | 11DR4 | 2.681 | 479.73 |
| 5 | 11DR5 | 2.843 | 696.63 |
| 6 | 11DR6 | 2.575 | 375.84 |
| 7 | 11DR7 | 2.178 | 150.66 |
| 8 | 11DR8 | 2.962 | 916.22 |
| 9 | 11DR9 | 1.515 | 32.73 |
| 10 | 11DR10 | 3.261 | 1823.90 |
| 11 | 11DR11 | 2.568 | 369.83 |
| 12 | 11DR12 | 3.692 | 4920.40 |
| 13 | 11DR13 | 3.438 | 2741.57 |
| 14 | 11DR14 | 3.559 | 3622.43 |
| 15 | 11DR15 | 3.154 | 1425.61 |
| 16 | 11DR16 | 3.359 | 2285.60 |
| 17 | 11DR17 | 2.082 | 120.78 |
| 18 | 11DR18 | 3.465 | 2917.43 |
| 19 | 11DR19 | 2.125 | 133.35 |
| 20 | 11DR20 | 2.393 | 247.17 |
| 21 | 11DR21 | 2.275 | 188.36 |
| 22 | 11DR23 | 2.219 | 165.58 |
| 23 | 11DR24 | 2.295 | 197.24 |
| 24 | 11DR25 | 3.729 | 5357.97 |
| 25 | 11DR26 | 2.439 | 274.79 |
| 26 | 11DR27 | 2.469 | 294.44 |
| 27 | 11DR28 | 2.131 | 135.21 |
| 28 | 11DR29 | 1.854 | 71.45 |
| 29 | 11DR32 | 3.377 | 2382.32 |
| 30 | 11DR34 | 1.58 | 38.02 |
| 31 | 11DR35 | 1.142 | 13.87 |
| 32 | 11DR36 | 2.821 | 662.22 |
| 33 | 11DR37 | 2.715 | 518.80 |
| 34 | 11DR38 | 3.104 | 1270.57 |
| 35 | 11DR39 | 1.052 | 11.27 |
| 36 | 11DR40 | 4.026 | 10616.96 |
| 37 | 11DR41 | 3.879 | 7568.33 |
| 38 | 11DR42 | 2.388 | 244.34 |
| 39 | 11DR43 | 2.895 | 785.24 |
| 40 | 11DR44 | 0.945 | 8.81 |
| 41 | 11DR45 | 3.331 | 2142.89 |
| 42 | 11DR45 | 3.331 | 2142.89 |
| 43 | 11DR46 | 2.147 | 140.28 |
| 44 | 11DR47 | 0.838 | 6.89 |
| 45 | 11DR48 | 1.672 | 46.99 |
| 46 | 11DR49 | 1.672 | 46.99 |
| 47 | 11DR50 | 3.297 | 1981.53 |
| 48 | 11DR51 | 2.482 | 303.39 |
| 49 | 11DR52 | 1.888 | 77.27 |
| 50 | 11DR53 | 1.97 | 93.33 |
| 51 | 11DR54- | 0.633 | 4.30 |
| 52 | 11DR55 | −0.669 | 0.21 |
| 53 | 11DR56 | −2.278 | 0.01 |
| 54 | 11DR57 | 1.898 | 79.07 |
| 55 | 11DR58 | 2.383 | 241.55 |
| 56 | 11DR59 | 1.654 | 45.08 |
| 57 | 11DR60 | 2.208 | 161.44 |
| 58 | 11DR61 | 5.578 | 378442.58 |
| 59 | 11DR62 | 5.281 | 190985.33 |

TABLE 16
Predicted Antipsychotic activity of active K004A derivatives:-

| COMPD | ACTIVITY | STATUS |
|---|---|---|
| 11DR3 | 4.589 | Close activity and drug likeness |
| 11DR2 | 4.018 | similar to Clozapine |
| 11DR1 | 3.76 | |
| 11DR12 | 3.692 | |
| 11DR14 | 3.559 | |
| 11DR18 | 3.465 | |
| 11DR13 | 3.438 | |
| 11DR16 | 3.359 | |
| 11DR10 | 3.261 | |
| 11DR15 | 3.154 | |
| 11DR8 | 2.962 | Moderate activity and druglikeness |
| 11DR5 | 2.843 | then Clozapine |
| 11DR4 | 2.681 | |
| 11DR6 | 2.575 | |
| 11DR11 | 2.568 | |
| 11DR20 | 2.393 | |
| 11DR21 | 2.275 | |
| 11DR7 | 2.178 | |
| 11DR19 | 2.125 | |
| 11DR17 | 2.082 | |
| 11DR9-KOO4a | 1.515 | high activity but low drug likeness |
| | | to high extrapyramidal symptoms |
| | | similar to Haloperidol |

TABLE 17
Details of binding affinity of K001A derivative and its binding
pocked residue docked on Dopamine D2 receptor (PDB ID: 2HLB)

| | | | | Atoms of | A. A residue | | |
|---|---|---|---|---|---|---|---|
| | | Docking | Binding pocket residues(4 Å) | Ligand | involved in | Length of | No. of |
| S. | | energy | (hydrogen bonded residues are | involved in | Docking | hydrogen | Hydrogen |
| No | Ligand | (Kcal/mol) | highlighted in bold) | Docking | interaction | bond (Å) | Bond (H)* |
| 1 | 11DR1 | −61.795 | VAL-3, THR-4, TRP- | — | — | — | — |
| | | | 5, PHE-8, LEU-9 | | | | |
| 2 | 11DR2 | −72.819 | THR-4, TRP-5, TYR- | — | — | — | — |
| | | | 6, ASP-7 | | | | |
| 3 | 11DR3 | −69.717 | THR-4, TRP-5, TYR- | — | — | — | — |
| | | | 6, ASP-7 | | | | |
| 4 | 11DR4 | −65.299 | SER-1, VAL-3, TRP- | — | — | — | — |
| | | | 5, PHE-8, LEU-9, GLU-11 | | | | |
| 5 | 11DR5 | −63.64 | SER-1, VAL-3, TRP- | — | — | — | — |
| | | | 5, PHE-8, LEU-9, GLU-11 | | | | |
| 6 | 11DR6 | −71.869 | SER-1, VAL-3, THR- | — | — | — | — |
| | | | 4, TRP-5, PHE-8, LEU-9 | | | | |
| 7 | 11DR7 | −59.719 | SER-1, ARG-2, VAL- | — | — | — | — |
| | | | 3, TRP-5, PHE-8, LEU-9 | | | | |
| 8 | 11DR8 | −66.139 | SER-1, ARG-2, VAL- | — | — | — | — |
| | | | 3, THR-4, TRP-5, PHE- | | | | |
| | | | 8, LEU-9, GLU-11 | | | | |
| 9 | 11DR9 | −63.576 | SER-1, VAL-3, THR- | — | — | — | — |
| | | | 4, TRP-5, PHE-8, LEU- | | | | |
| | | | 9, GLU-11 | | | | |
| 10 | 11DR10 | −61.781 | SER-1, VAL-3, THR- | — | — | — | — |
| | | | 4, TRP-5, PHE-8, LEU-9 | | | | |
| 11 | 11DR11 | −47.804 | VAL-3, THR-4, TYR- | — | — | — | — |
| | | | 4, TYR-6, ASP-7, MET- | | | | |
| | | | 10, GLU-11 | | | | |
| 12 | 11DR12 | −68.987 | SER-1, VAL-3, TRP- | — | — | — | — |
| | | | 5, PHE-8, LEU-9, GLU-11 | | | | |
| 13 | 11DR13 | −63.547 | SER-1, VAL-3, TRP- | — | — | — | — |
| | | | 5, PHE-8, LEU-9, GLU-11 | | | | |
| 14 | 11DR14 | −58.85 | VAL-3, THR-4, TRP- | — | — | — | — |
| | | | 5, PHE-8, LEU-9 | | | | |
| 15 | 11DR15 | −52.104 | SER-1, VAL-3, THR- | — | — | — | — |
| | | | 4, TRP-5, PHE-8, GLU-11 | | | | |
| 16 | 11DR16 | −62.946 | SER-1, VAL-3, THR- | — | — | — | — |
| | | | 4, TRP-5, PHE-8, LEU- | | | | |
| | | | 9, GLU-11 | | | | |
| 17 | 11DR17 | −67.259 | SER-1, VAL-3, TRP- | — | — | — | — |
| | | | 5, PHE-8, LEU-9, GLU-11 | | | | |
| 18 | 11DR18 | −53.191 | SER-1, ARG-2, VAL- | — | — | — | — |
| | | | 3, TRP-5, PHE-8, LEU- | | | | |
| | | | 9, GLU-11 | | | | |
| 19 | 11DR19 | −63.166 | SER-1, VAL-3, TRP- | — | — | — | — |
| | | | 5, PHE-8, LEU-9, GLU-11 | | | | |
| 20 | 11DR20 | −63.154 | SER-1, VAL-3, THR- | — | — | — | — |
| | | | 4, TRP-5, PHE-8, LEU-9 | | | | |
| 21 | 11DR21 | −64.436 | SER-1, VAL-3, THR- | — | — | — | — |
| | | | 4, TRP-5, PHE-8, LEU-9 | | | | |
| 22 | 11DR22 | −62.243 | SER-1, VAL-3, THR- | — | — | — | — |
| | | | 4, TRP-5, PHE-8, LEU-9 | | | | |
| 23 | 11DR23 | −59.626 | SER-1, VAL-3, THR- | — | — | — | — |
| | | | 4, TRP-5, PHE-8, LEU-9 | | | | |
| 24 | 11DR24 | −72.687 | SER-1, VAL-3, THR- | — | — | — | — |
| | | | 4, TRP-5, PHE-8, LEU-9 | | | | |
| 25 | 11DR25 | −64.582 | VAL-3, THR-4, TRP- | — | — | — | — |
| | | | 5, PHE-8, LEU-9 | | | | |
| 26 | 11DR26 | −69.857 | SER-1, VAL-3, TRP- | — | — | — | — |
| | | | 5, PHE-8, LEU-9, GLU-11 | | | | |
| 27 | 11DR27 | −64.334 | SER-1, VAL-3, THR- | — | — | — | — |
| | | | 4, TRP-5, PHE-8, LEU- | | | | |
| | | | 9, GLU-11 | | | | |
| 28 | 11DR28 | −64.689 | SER-1, VAL-3, THR- | — | — | — | — |
| | | | 4, TRP-5, PHE-8, LEU- | | | | |
| | | | 9, GLU-11 | | | | |
| 29 | 11DR29 | −63.593 | VAL-3, TRP-5, PHE- | — | — | — | — |
| | | | 8, LEU-9 | | | | |
| 30 | 11DR32 | −67.877 | SER-1, ARG-2, VAL- | — | — | — | — |
| | | | 3, THR-4, TRP-5, PHE- | | | | |
| | | | 8, LEU-9 | | | | |
| 31 | 110R34 | −77.701 | SER-1, VAL-3, THR- | — | — | — | — |
| | | | 4, TRP-5, PHE-8, LEU- | | | | |
| | | | 9, GLU-11 | | | | |
| 32 | 11DR35 | −72.083 | SER-1, VAL-3, TRP- | — | — | — | — |
| | | | 5, PHE-8, LEU-9 | | | | |
| 33 | 11DR36 | −62.834 | SER-1, VAL-3, TRP- | — | — | — | — |
| | | | 5, PHE-8, LEU-9, GLU-11 | | | | |
| 34 | 11DR37 | −53.372 | SER-1, VAL-3, TRP- | — | — | — | — |
| | | | 5, PHE-8, LEU-9 | | | | |
| 35 | 11DR38 | −68.041 | THR-4, TRP-5, TYR- | H58- | ASP7 | 2.149 | 1 |
| | | | 6, ASP-7, MET-10 | O2819 | | | |
| 36 | 11DR39 | −75.011 | SER-1, ARG-2, VAL- | — | — | — | — |
| | | | 3, THR-4, TRP-5, PHE- | | | | |
| | | | 8, LEU-9 | | | | |
| 37 | 11DR40 | −62.832 | THR-4, TYR-6, ASP-7 | — | — | — | — |
| 38 | 11DR41 | −51.854 | SER-1, VAL-3, THR-4, | — | — | — | — |
| | | | TRP-5, PHE-8, LEU- | | | | |
| | | | 9, GLU-11 | | | | |
| 39 | 11DR42 | −72.925 | SER-1, VAL-3, TRP- | — | — | — | — |
| | | | 5, PHE-8, LEU-9, GLU-11 | | | | |
| 40 | 11DR43 | −65.248 | SER-1, ARG-2, VAL-3, | — | — | — | — |
| | | | THR-4, TRP-5, PHE- | | | | |
| | | | 8, LEU-9 | | | | |
| 41 | 11DR44 | −76.496 | THR-4, TRP-5, TYR- | — | — | — | — |
| | | | 6, ASP-7 | | | | |
| 42 | 11DR45 | −67.26 | SER-1, VAL-3, THR-4, | — | — | — | — |
| | | | TRP-5, PHE-8, LEU- | | | | |
| | | | 9, GLU-11 | | | | |
| 43 | 11DR46 | −58.619 | VAL-3, THR-4, TRP- | — | — | — | — |
| | | | 5, PHE-8, LEU-9 | | | | |
| 44 | 11DR47 | −85.046 | SER-1, VAL-3, THR- | — | — | — | — |
| | | | 4, TRP-5, PHE-8, LEU- | | | | |
| | | | 9, GLU-11 | | | | |
| 45 | 11DR48 | −55.769 | SER-1, VAL-3, THR- | — | — | — | — |
| | | | 4, TRP-5, PHE-8, LEU-9 | | | | |
| 46 | 11DR49 | −81.656 | SER-1, ARG-2, VAL- | — | — | — | — |
| | | | 3, TRP-5, PHE-8, LEU- | | | | |
| | | | 9, GLU-11 | | | | |
| 47 | 11DR50 | −75.126 | SER-1, VAL-3, THR- | — | — | — | — |
| | | | 4, TRP-5, ASP-7, PHE- | | | | |
| | | | 8, LEU-9, GLU-11 | | | | |
| 48 | 11DR51 | −79.976 | THR-4, TRP-5, TYR- | — | — | — | — |
| | | | 6, ASP-7 | | | | |
| 49 | 11DR52 | −96.417 | SER-1, VAL-3, TRP-5, | — | — | — | — |
| | | | PHE-8, LEU-9, GLU-11 | | | | |
| 50 | 11DR53 | −93.452 | SER-1, VAL-3, THR-4, | — | — | — | — |
| | | | TRP-5, PHE-8, LEU- | | | | |
| | | | 9, GLU-11 | | | | |
| 51 | 11DR54 | −80.383 | SER-1, VAL-3, THR- | — | — | — | — |
| | | | 4, TRP-5, PHE-8, GLU-11 | | | | |
| 52 | 11DR55 | −75.878 | SER-1, VAL-3, THR- | — | — | — | — |
| | | | 4, TRP-5, PHE-8, LEU-9 | | | | |
| 53 | 11DR56 | −70.113 | SER-1, VAL-3, THR- | — | — | — | — |
| | | | 4, TRP-5, ASP-7, PHE- | | | | |
| | | | 8, LEU-9, GLU-11 | | | | |
| 54 | 11DR57 | −82.35 | SER-1, ARG-2, VAL- | — | — | — | — |
| | | | 3, THR-4, TRP-5, PHE- | | | | |
| | | | 8, LEU-9, GLU-11 | | | | |
| 55 | 11DR58 | −65.203 | SER-1, VAL-3, THR- | — | — | — | — |
| | | | 4, TRP-5, PHE-8, LEU- | | | | |
| | | | 9, GLU-11 | | | | |
| 56 | 11DR59 | −97.025 | SER-1, VAL-3, TRP- | — | — | — | — |
| | | | 5, PHE-8, LEU-9, GLU- | | | | |
| | | | 11, ASP-12 | | | | |
| 57 | 11DR60 | −81.147 | THR-4, TRP-5, TYR- | — | — | — | — |
| | | | 6, ASP-7, LEU-9, MET-10 | | | | |
| 58 | 11DR61 | −71.392 | SER-1, VAL-3, TRP- | — | — | — | — |
| | | | 5, PHE-8, LEU-9, GLU-11 | | | | |
| 59 | 11DR62 | −80.729 | SER-1, VAL-3, THR- | — | — | — | — |
| | | | 4, TRP-5, PHE-8, LEU- | | | | |
| | | | 9, GLU-11 | | | | |

TABLE 18
Details of binding affinity of K001A derivatives and its binding pocked residue
docked on Serotonin receptor (5HT_{2A}) (developed homology based 3D model)

| | | | | Atoms of | A. A residue | | |
|---|---|---|---|---|---|---|---|
| | | Docking | Binding pocket residues(4 Å) | Ligand | involved in | Length of | No. of |
| S. | | energy | (hydrogen bonded residues are | involved in | Docking | hydrogen | Hydrogen |
| No | Ligand | (Kcal/mol) | highlighted in bold) | Docking | interaction | bond (Å) | Bond (H)* |
| 1 | 11DR1 | −6.079 | PHE-167, LEU-170, THR- | — | — | — | — |
| | | | 171, VAL-174, VAL- | | | | |
| | | | 256, VAL-257, CYS- | | | | |
| | | | 260, PRO-261, ILE-264 | | | | |
| 2 | 11DR2 | −17.064 | PHE-218, ILE-250, LEU- | — | — | — | — |
| | | | 254, VAL-298, LEU- | | | | |
| | | | 301, VAL-302, TYR- | | | | |
| | | | 303, THR-304, ARG-311 | | | | |
| 3 | 11DR3 | −16.508 | ILE-250, LEU-254, MET- | — | — | — | — |
| | | | 258, LEU-294, VAL- | | | | |
| | | | 302, TYR-303 | | | | |
| 4 | 11DR7 | −20.691 | ILE-250, LEU-254, MET- | — | — | — | — |
| | | | 258, LEU-294, VAL- | | | | |
| | | | 298, LEU-301, VAL- | | | | |
| | | | 302, TYR-303 | | | | |
| 5 | 11DR9 | −2.499 | ILE-250, LEU-254, MET- | — | — | — | — |
| | | | 258, LEU-294, VAL- | | | | |
| | | | 298, LEU-301, VAL- | | | | |
| | | | 302, TYR-303, THR- | | | | |
| | | | 303, THR-304, ARG-311 | | | | |
| 6 | 11DR10 | −21.213 | PHE-218, VAL-247, ILE- | H5124- | VAL-302 | 2.166 | 1 |
| | | | 250, LEU-254, LEU- | O332 | | | |
| | | | 294, VAL-298, LEU- | | | | |
| | | | 301, VAL-302, TYR- | | | | |
| | | | 303, THR-304, ARG-311 | | | | |
| 7 | 11DR11 | −8.217 | ILE-250, LEU-254, LEU- | — | — | — | — |
| | | | 294, VAL-298, LEU- | | | | |
| | | | 301, VAL-302, TYR- | | | | |
| | | | 303, THR-304, ARG-311 | | | | |
| 8 | 11DR12 | −10.814 | LEU-10, LEU-254, MET- | — | — | — | — |
| | | | 258, LEU-294, ALA- | | | | |
| | | | 297, VAL-298, LEU- | | | | |
| | | | 301, VAL-302, TYR- | | | | |
| | | | 303, THR-304, ARG-311 | | | | |
| 9 | 11DR13 | −6.947 | ILE-250, LEU-254, LEU- | — | — | — | — |
| | | | 298, LEU-301, VAL- | | | | |
| | | | 302, TYR-303 | | | | |
| 10 | 11DR14 | −1.591 | ILE-250, LEU-254, LEU- | — | — | — | — |
| | | | 294, VAL-298, LEU- | | | | |
| | | | 301, VAL-302, TYR- | | | | |
| | | | 303, THR-304, ARG-311 | | | | |
| 11 | 11DR16 | −5.436 | LEU-170, VAL-174, ILE- | — | — | — | — |
| | | | 250, PHE-253, LEU- | | | | |
| | | | 254, VAL-256, VAL- | | | | |
| | | | 257, CYS-260, PRO- | | | | |
| | | | 261, ILE-264 | | | | |
| 12 | 11DR18 | −11.896 | PHE-218, LYS-246, VAL- | — | — | — | — |
| | | | 247, ILE-250, LEU- | | | | |
| | | | 254, VAL-298, LEU- | | | | |
| | | | 301, VAL-302, TYR- | | | | |
| | | | 303, THR-304, ARG-311 | | | | |
| 13 | 11DR20 | −0.43 | PHE-218, LYS-246, VAL- | — | — | — | — |
| | | | 247, ILE-250, LEU- | | | | |
| | | | 294, VAL-298, LEU- | | | | |
| | | | 301, VAL-302, TYR- | | | | |
| | | | 303, THR-304, ARG-311 | | | | |
| 14 | 11DR21 | −6.473 | ILE-250, PHE-253, LEU- | — | — | — | — |
| | | | 254, LEU-294, VAL- | | | | |
| | | | 298, LEU-301, VAL- | | | | |
| | | | 302, TYR-303 | | | | |
| 15 | 11DR22 | −6.754 | PHE-218, ALA-244, LYS- | — | — | — | — |
| | | | 246, VAL-247, LEU- | | | | |
| | | | 248, GLY-249, ILE- | | | | |
| | | | 250, VAL-251, PHE- | | | | |
| | | | 252, PHE-253, LEU- | | | | |
| | | | 254, PHE-255, VAL- | | | | |
| | | | 256, VAL-257, MET- | | | | |
| | | | 258, LEU-294, SER- | | | | |
| | | | 295, ALA-297, VAL- | | | | |
| | | | 298, ASN-299, PRO- | | | | |
| | | | 300, LEU-301, VAL- | | | | |
| | | | 302, TYR-303, THR- | | | | |
| | | | 304, LEU-305, LYS- | | | | |
| | | | 308, ARG-311 | | | | |
| 16 | 11DR23 | −2.36 | VAL-247, ILE-250, PHE- | H5130- | VAL-302 | 2.197 | 1 |
| | | | 253, LEU-254, VAL- | O2332 | | | |
| | | | 257, VAL-298, LEU- | | | | |
| | | | 301, VAL-302, TYR- | | | | |
| | | | 303, THR-304, ARG-311 | | | | |
| 17 | 11DR25 | −26.013 | PHE-218, LYS-246, VAL- | — | — | — | — |
| | | | 247, ILE-250, LEU- | | | | |
| | | | 294, VAL-298, LEU- | | | | |
| | | | 301, VAL-302, TYR- | | | | |
| | | | 303, THR-304, ARG-311 | | | | |
| 18 | 11DR27 | −14.701 | PHE-218, LYS-246, VAL- | H5129- | VAL-302 | 2.028 | 1 |
| | | | 247, ILE-250, PHE- | O2332 | | | |
| | | | 253, LEU-254, VAL- | | | | |
| | | | 257, VAL-298, LEU- | | | | |
| | | | 301, VAL-302, TYR- | | | | |
| | | | 303, THR-304 | | | | |
| 19 | 11DR29 | −17.329 | PHE-218, LYS-246, VAL- | | | | |
| | | | 247, ILE-250, LEU- | | | | |
| | | | 294, VAL-298, LEU- | | | | |
| | | | 301, VAL-302, TYR- | | | | |
| | | | 303, THR-304, ARG-311 | | | | |
| 20 | 11DR32 | −20.914 | PHE-218, LYS-246, VAL- | H5127- | VAL-302 | 1.911 | 1 |
| | | | 247, ILE-250, LEU- | O2332 | | | |
| | | | 294, VAL-298, LEU- | | | | |
| | | | 301, VAL-302, TYR- | | | | |
| | | | 303, THR-304, ARG-311 | | | | |
| 21 | 11DR37 | −2.174 | PHE-218, LYS-246, VAL- | — | — | — | — |
| | | | 247, ILE-250, LEU- | | | | |
| | | | 254, LEU-294, VAL- | | | | |
| | | | 298, LEU-301, VAL- | | | | |
| | | | 302, TYR-303, THR-304 | | | | |
| 22 | 11DR40 | −16.613 | PHE-218, LYS-246, VAL- | — | — | — | — |
| | | | 247, ILE-250, LEU- | | | | |
| | | | 254, LEU-294, VAL- | | | | |
| | | | 298, LEU-301, VAL- | | | | |
| | | | 302, TYR-303, THR- | | | | |
| | | | 304, ARG-311 | | | | |
| 23 | 11DR41 | −1.019 | PHE-218, LYS-246, VAL- | — | — | — | — |
| | | | 247, ILE-250, LEU- | | | | |
| | | | 254, LEU-294, VAL- | | | | |
| | | | 298, LEU-301, VAL- | | | | |
| | | | 302, TYR-303, THR- | | | | |
| | | | 304, ARG-311 | | | | |
| 24 | 11DR44 | −15.899 | VAL-7, LEU-10, ILE- | — | — | — | — |
| | | | 250, LEU-254, LEU- | | | | |
| | | | 294, VAL-298, LEU- | | | | |
| | | | 301, VAL-302, TYR-303 | | | | |
| 25 | 11DR45 | −15.568 | ILE-250, LEU-254, LEU- | — | — | — | — |
| | | | 294, VAL-298, LEU- | | | | |
| | | | 301, VAL-302, TYR- | | | | |
| | | | 303, THR-304, ARG-311 | | | | |
| 26 | 11DR51 | −12.337 | PHE-218, ILE-250, LEU- | — | — | — | — |
| | | | 254, MET-258, LEU- | | | | |
| | | | 294, VAL-298, LEU- | | | | |
| | | | 301, VAL-302, TYR- | | | | |
| | | | 303, ARG-311 | | | | |
| 27 | 11DR52 | −11.411 | ILE-250, PHE-253, LEU- | — | — | — | — |
| | | | 254, VAL-256, VAL- | | | | |
| | | | 257, VAL-298, LEU- | | | | |
| | | | 301, VAL-302 | | | | |
| 28 | 11DR53 | −18.745 | PHE-218, LYS-246, VAL- | — | — | — | — |
| | | | 247, ILE-250, PHE- | | | | |
| | | | 243, LEU-254, VAL- | | | | |
| | | | 298, LEU-301, VAL- | | | | |
| | | | 302, TYR-303, THR- | | | | |
| | | | 304, ARG-311 | | | | |
| 29 | 11DR58 | −4.16 | PHE-218, LYS-246, VAL- | — | — | — | — |
| | | | 247, ILE-250, LEU- | | | | |
| | | | 294, VAL-298, LEU- | | | | |
| | | | 301, VAL-302, TYR- | | | | |
| | | | 303, THR-304 | | | | |
| 30 | 11DR60 | −11.966 | PHE-218, ILE-250, LEU- | — | — | — | — |
| | | | 254, MET-258, LEU- | | | | |
| | | | 294, VAL-298, LEU- | | | | |
| | | | 301, VAL-302, TYR- | | | | |
| | | | 303, ARG-311 | | | | |

TABLE 19
Predicted antipsychotic activity of K004B derivatives

| | Compound | Pred. log | Pred. |
|---|---|---|---|
| S. No. | Name | IC50 (nM) | IC50 (nM) |
| 1 | 10DR1 | 3.6 | 3981.07 |
| 2 | 10DR2 | 4.037 | 10889.30 |
| 3 | 10DR3 | 4.491 | 30974.19 |
| 4 | 10DR4 | 2.618 | 414.95 |
| 5 | 10DR5 | 2.724 | 529.66 |
| 6 | 10DR6 | 2.582 | 381.94 |
| 7 | 10DR7 | 2.195 | 156.68 |
| 8 | 10DR8 | 2.149 | 140.93 |
| 9 | 10DR9 | 1.148 | 14.06 |
| 10 | 10DR10 | 3.12 | 1318.26 |
| 11 | 10DR11 | 2.484 | 304.79 |
| 12 | 10DR12 | 3.525 | 3349.65 |
| 13 | 10DR13 | 3.374 | 2365.92 |
| 14 | 10DR14 | 3.122 | 1324.34 |
| 15 | 10DR15 | 2.753 | 566.24 |
| 16 | 10DR16 | 3.509 | 3228.49 |
| 17 | 10DR17 | 1.972 | 93.76 |
| 18 | 10DR18 | 3.183 | 1524.05 |
| 19 | 10DR19 | 1.826 | 66.99 |
| 20 | 10DR20 | 2.264 | 183.65 |
| 21 | 10DR21 | 2.456 | 285.76 |
| 22 | 10DR22 | Failed | #VALUE! |
| 23 | 10DR23 | 1.903 | 79.98 |
| 24 | 10DR24 | 2.072 | 118.03 |
| 25 | 10DR25 | 3.585 | 3845.92 |
| 26 | 10DR26 | 2.966 | 924.70 |
| 27 | 10DR27 | 2.335 | 216.27 |
| 28 | 10DR28 | 2.104 | 127.06 |
| 29 | 10DR29 | 2.168 | 147.23 |
| 30 | 10DR30 | 1.788 | 61.38 |
| 31 | 10DR31 | 1.364 | 23.12 |
| 32 | 10DR32 | 3.274 | 1879.32 |
| 33 | 10DR33 | 3.626 | 4226.69 |
| 34 | 10DR34 | 1.147 | 14.03 |
| 35 | 10DR35 | 1.091 | 12.33 |
| 36 | 10DR36 | 3.174 | 1492.79 |
| 37 | 10DR37 | 3.207 | 1610.65 |
| 38 | 10DR38 | 2.388 | 244.34 |
| 39 | 10DR39 | 1.618 | 41.50 |
| 40 | 10DR40 | 4.009 | 10209.39 |
| 41 | 10DR41 | 3.993 | 9840.11 |
| 42 | 10DR42 | 1.935 | 86.10 |
| 43 | 10DR43 | 3.161 | 1448.77 |
| 44 | 10DR44 | 1.053 | 11.30 |
| 45 | 10DR45 | 3.863 | 7294.58 |
| 46 | 10DR46 | 2.715 | 518.80 |
| 47 | 10DR47 | 1.513 | 32.58 |
| 48 | 10DR48 | 2.341 | 219.28 |
| 49 | 10DR49 | 0.982 | 9.59 |
| 50 | 10DR50 | 9.397 | 2494594726.94 |
| 51 | 10DR52 | 2.083 | 121.06 |
| 52 | 10DR53 | 2.175 | 149.62 |
| 53 | 10DR54 | 1.451 | 28.25 |
| 54 | 10DR55 | 0.571 | 3.72 |
| 55 | 10DR56 | −0.757 | 0.17 |
| 56 | 10DR57 | −2.565 | 0.00 |
| 57 | 10DR58 | 2.024 | 105.68 |
| 58 | 10DR59 | 2.96 | 912.01 |
| 59 | 10DR60 | 1.246 | 17.62 |
| 60 | 10DR61 | 5.725 | 530884.44 |
| 61 | 10DR62 | 5.718 | 522396.19 |

TABLE 20
Predicted antipsychotic activity of active K004B derivatives

| COMPD | ACTIVITY | STATUS |
|---|---|---|
| 10DR52 | 2.083 | Moderate activity and druglikeness |
| 10DR4 | [symbol] | then Clozapine |
| 10DR5 | 2.724 | |
| 10DR6 | 2.582 | |
| 10DR7 | 2.195 | |
| 10DR8 | [symbol] | |
| 10DR15 | 2.753 | |
| 10DR20 | 2.264 | |
| 10DR21 | [symbol] | |
| 10DR24 | 2.072 | |
| 10DR26 | 2.966 | |
| 10DR27 | 2.335 | |
| 10DR28 | 2.104 | |
| 10DR29 | 2.168 | |
| 10DR48 | 2.341 | |
| 10DR53 | 2.175 | |
| 10DR58 | 2.024 | |
| 10DR59 | 2.96 | |
| 10DR38 | 2.388 | |
| 10DR11 | 2.484 | |
| 10DR15 | 2.753 | |
| 10DR46 | 2.715 | |
| 10DR1 | 3.6 | Close activity and drug likeness |
| 10DR10 | 3.12 | similar to Clozapine |
| 10DR12 | [symbol] | |
| 10DR13 | 3.374 | |
| 10DR14 | [symbol] | |
| 10DR16 | [symbol] | |
| 10DR18 | 3.183 | |
| 10DR2 [symbol] | [symbol] | |
| 10DR32 | 3.274 | |
| 10DR33 | 3.626 | |
| 10DR3 [symbol] | 3.174 | |
| 10DR37 | 3.207 | |
| 10DR4 [symbol] | [symbol] | |
| 10DR4 [symbol] | [symbol] | |
| 10DR4 [symbol] | [symbol] | |
| 10DR30 | 1.788 | High activity but low druglikeness |
| 10DR31 | 1.364 | dur to high extrapyramidal symptoms |
| 10DR34 | 1.147 | similar to Haloperidol |
| 10DR35 | 1.091 | |
| 10DR39 | 1.618 | |
| 10DR42 | 1.935 | |
| 10DR44 | 1.053 | |
| 10DR47 | 1.513 | |
| 10DR49 | 0.982 | |

[symbol]

indicates data missing or illegible when filed

TABLE 21
Details of binding affinity of K001B derivative and its binding
pocked residue docked on dopamine D2 receptor (PDB ID: 2HLB)

| | | | | Atoms of | A. A residue | | |
|---|---|---|---|---|---|---|---|
| | | Docking | Binding pocket residues(4 Å) | Ligand | involved in | Length of | No. of |
| S. | | energy | (hydrogen bonded residues are | involved in | Docking | hydrogen | Hydrogen |
| No | Ligand | (Kcal/mol) | highlighted in bold) | Docking | interaction | bond (Å) | Bond (H)* |
| 1 | 10DR1 | −54.256 | SER-1, VAL-3, THR-4, TRP-5, | — | — | — | — |
| | | | PHE-8, GLU-11 | | | | |
| 2 | 10DR2 | −59.485 | SER-1, ARG-2, VAL-3, THR-4, | — | — | — | — |
| | | | TRP-5, PHE-8, LEU-9, GLU-11 | | | | |
| 3 | 10DR3 | −60.806 | SER-1, VAL-3, THR-4, TRP-5, | — | — | — | — |
| | | | PHE-8, LEU-9, GLU-11 | | | | |
| 4 | 10DR4 | −61.648 | SER-1, VAL-3, THR-4, TRP-5, | — | — | — | — |
| | | | PHE-8, LEU-9, GLU-11 | | | | |
| 5 | 10DR5 | −54.421 | SER-1, VAL-3, THR-4, TRP-5, | — | — | — | — |
| | | | PHE-8, LEU-9, GLU-11 | | | | |
| 6 | 10DR6 | −66.344 | ARG-2, VAL-3, TRP-5, PHE-8, | — | — | — | — |
| | | | LEU-9, | | | | |
| 7 | 10DR7 | −55.317 | ARG-2, VAL-3, THR-4, TRP-5, | — | — | — | — |
| | | | PHE-8, LEU-9, | | | | |
| 8 | 10DR8 | −69.016 | VAL-3, TRP-5, PHE-8, LEU-9, | — | — | — | — |
| | | | GLU-11 | | | | |
| 9 | 10DR9 | −67.036 | SER-1, VAL-3, TRP-5, PHE-8, | — | — | — | — |
| | | | LEU-9, GLU-11 | | | | |
| 10 | 10DR10 | −52.208 | TRP-5, PHE-8, LEU-9, | — | — | — | — |
| 11 | 10DR11 | −63.164 | SER-1, VAL-3, TRP-5, PHE-8, | — | — | — | — |
| | | | LEU-9, GLU-11 | | | | |
| 12 | 10DR12 | −57.867 | THR-4, TRP-5, TYR-6, ASP-7. | — | — | — | — |
| 13 | 10DR13 | −49.082 | SER-1, VAL-3, TRP-5, PHE-8, | — | — | — | — |
| | | | LEU-9, GLU-11 | | | | |
| 14 | 10DR14 | −58.552 | SER-1, VAL-3, TRP-5, PHE-8, | — | — | — | — |
| | | | LEU-9, GLU-11 | | | | |
| 15 | 10DR15 | −60.199 | SER-1, VAL-3, TRP-5, PHE-8, | — | — | — | — |
| | | | LEU-9, GLU-11 | | | | |
| 16 | 10DR16 | −57.114 | SER-1, VAL-3, TRP-5, PHE-8, | — | — | — | — |
| | | | LEU-9, GLU-11 | | | | |
| 17 | 10DR17 | −53.508 | TRP-5, PHE-8, LEU-9, | — | — | — | — |
| 18 | 10DR18 | −59.959 | SER-1, VAL-3, TRP-5, PHE-8, | — | — | — | — |
| | | | LEU-9, GLU-11 | | | | |
| 19 | 10DR19 | −62.664 | VAL-3, TRP-5, PHE-8, LEU-9, | — | — | — | — |
| 20 | 10DR20 | −58.49 | TRP-5, PHE-8, LEU-9, | — | — | — | — |
| 21 | 10DR21 | −57.242 | TRP-5, PHE-8, LEU-9, | — | — | — | — |
| 22 | 10DR22 | −60.864 | TRP-5, PHE-8, LEU-9, | — | — | — | — |
| 23 | 10DR23 | −61.553 | SER-1, VAL-3, THR-4, TRP-5, | — | — | — | — |
| | | | PHE-8, LEU-9, GLU-11 | | | | |
| 24 | 10DR24 | −71.77 | ARG-2, VAL-3, TRP-5, PHE-8, | — | — | — | — |
| | | | LEU-9, | | | | |
| 25 | 10DR25 | −56.196 | , TRP-5, PHE-8, LEU-9, | — | — | — | — |
| 26 | 10DR26 | −71.503 | VAL-3, THR-4, TRP-5, PHE-8, | — | — | — | — |
| | | | LEU-9, | | | | |
| 27 | 10DR27 | −60.27 | VAL-3, TRP-5, PHE-8, LEU-9, | — | — | — | — |
| | | | GLU-11 | | | | |
| 28 | 10DR28 | −52.616 | VAL-3, THR-4, TYR-6, ASP-7 | — | — | — | — |
| 29 | 10DR29 | −63.877 | SER-1, VAL-3, TRP-5, PHE-8, | — | — | — | — |
| | | | LEU-9, GLU-11 | | | | |
| 30 | 10DR30 | −59.435 | SER-1, VAL-3, THR-4, TRP-5, | — | — | — | — |
| | | | PHE-8, LEU-9, GLU-11 | | | | |
| 31 | 10DR31 | −51.715 | VAL-3, THR-4, TRP-5, PHE-8, | — | — | — | — |
| | | | LEU-9, GLU-11 | | | | |
| 32 | 10DR32 | −57.668 | ARG-2, VAL-3, TRP-5, PHE-8, | — | — | — | — |
| | | | LEU-9, | | | | |
| 33 | 10DR33 | −62.921 | SER-1, ARG-2, VAL-3, TRP-5, | — | — | — | — |
| | | | PHE-8, LEU-9, | | | | |
| 34 | 10DR34 | −74.696 | VAL-3, THR-4, TRP-5, PHE-8, | — | — | — | — |
| | | | LEU-9, | | | | |
| 35 | 10DR35 | −69.426 | SER-1, VAL-3, TRP-5, PHE-8, | — | — | — | — |
| | | | LEU-9, | | | | |
| 36 | 10DR36 | −66.647 | SER-1, ARG-2, VAL-3, TRP-5, | — | — | — | — |
| | | | PHE-8, LEU-9, | | | | |
| 37 | 10DR37 | −52.032 | SER-1, VAL-3, TRP-5, PHE-8, | — | — | — | — |
| | | | LEU-9, GLU-11 | | | | |
| 38 | 10DR38 | −63.825 | VAL-3, TRP-5, PHE-8, LEU-9, | — | — | — | — |
| | | | GLU-11 | | | | |
| 39 | 10DR39 | −62.321 | ARG-2, VAL-3, THR-4, TRP-5, | — | — | — | — |
| | | | PHE-8, LEU-9. | | | | |
| 40 | 10DR40 | −59.813 | VAL-3, THR-4, TYR-6, ASP-7. | H51- | ASP-7 | 1.803 | 1 |
| | | | | O2818 | | | |
| 41 | 10DR41 | −48.192 | SER-1, VAL-3, THR-4, TRP-5, | — | — | — | — |
| | | | PHE-8, LEU-9, GLU-11 | | | | |
| 42 | 10DR42 | −60.415 | TRP-5, PHE-8, LEU-9, | — | — | — | — |
| 43 | 10DR43 | −63.265 | TRP-5, PHE-8, LEU-9, | — | — | — | — |
| 44 | 10DR44 | −62.356 | SER-1, VAL-3, THR-4, TRP-5, | — | — | — | — |
| | | | PHE-8, LEU-9, GLU-11 | | | | |
| 45 | 10DR45 | −57.073 | VAL-3, THR-4, TRP-5, PHE-8, | — | — | — | — |
| | | | LEU-9, | | | | |
| 46 | 10DR46 | −55.968 | SER-1, VAL-3, THR-4, TRP-5, | — | — | — | — |
| | | | PHE-8, LEU-9, GLU-11 | | | | |
| 47 | 10DR47 | −72.195 | TRP-5, PHE-8, LEU-9, | — | — | — | — |
| 48 | 10DR48 | −61.966 | VAL-3, TRP-5, PHE-8, LEU-9, | — | — | — | — |
| 49 | 10DR49 | −73.055 | TRP-5, PHE-8, LEU-9, | — | — | — | — |
| 50 | 10DR50 | −92.213 | SER-1, VAL-3, TRP-5, PHE-8, | — | — | — | — |
| | | | LEU-9, GLU-11 | | | | |
| 51 | 10DR52 | −72.794 | SER-1, VAL-3, THR-4, TRP-5, | — | — | — | — |
| | | | PHE-8, LEU-9, GLU-11 | | | | |
| 52 | 10DR53 | −74.686 | SER-1, VAL-3, TRP-5, ASP-7, | — | — | — | — |
| | | | PHE-8, LEU-9, GLU-11 | | | | |
| 53 | 10DR54 | −70.084 | SER-1, VAL-3, TRP-5, PHE-8, | — | — | — | — |
| | | | LEU-9, GLU-11 | | | | |
| 54 | 10DR55 | −71.383 | TRP-5, TYR-6, ASP-7. | — | — | — | — |
| 55 | 10DR56 | −77.099 | SER-1, VAL-3, TRP-5, PHE-8, | — | — | — | — |
| | | | LEU-9, GLU-11 | | | | |
| 56 | 10DR57 | −71.858 | SER-1, VAL-3, THR-4, TRP-5, | — | — | — | — |
| | | | ASP-7, PHE-8, LEU-9, GLU-11 | | | | |
| 57 | 10DR58 | −92.598 | THR-4, TRP-5, TYR-6, ASP-7,, | — | — | — | — |
| | | | LEU-9, MET-10, | | | | |
| 58 | 10DR59 | −71.793 | SER-1, ARG-2, VAL-3, THR-4, | — | — | — | — |
| | | | TRP-5, PHE-8, LEU-9, GLU-11 | | | | |
| 59 | 10DR60 | −70.685 | VAL-3, THR-4, TRP-5, PHE-8, | — | — | — | — |
| | | | LEU-9, | | | | |
| 60 | 10DR61 | −78.893 | VAL-3, THR-4, TRP-5, PHE-8, | — | — | — | — |
| | | | LEU-9, GLU-11 | | | | |
| 61 | 10DR62 | −59.384 | SER-1, VAL-3, THR-4, TRP-5, | — | — | — | — |
| | | | ASP-7, PHE-8, GLU-11 | | | | |

TABLE 22
Details of binding affinity of K001B derivatives and its binding pocked residue
docked on Serotonin receptor (5HT_{2A}) (developed homology based 3D model)

| | | Docking energy | Binding pocket residues(4 Å) (hydrogen |
|---|---|---|---|
| S. No | Ligand | (Kcal/mol) | bonded residues are highlighted in bold) |
| 1 | 10DR1 | −18.993 | PHE-218, ILE-250, LEU-254, VAL-298, LEU-301, VAL-302, |
| | | | TYR-303, THR-304, ARG-311 |
| 2 | 10DR2 | −34.042 | LEU-170, VAL-174, PHE-178, PHE-253, VAL-256, VAL-257, |
| | | | CYS-260, ILE-264, |
| 3 | 10DR3 | −17.39 | PHE-218, ILE-250, LEU-254, VAL-298, LEU-301, VAL-302, |
| | | | TYR-303, THR-304, ARG-311. |
| 4 | 10DR5 | −18.799 | PHE-218, ILE-250, LEU-254, MET-258, LEU-294, VAL-298, |
| | | | LEU-301, VAL-302, TYR-303, ARG-311 |
| 5 | 10DR6 | −17.605 | PHE-218, LYS-246, VAL-247, ILE-250, PHE-253, LEU-254, |
| | | | VAL-257, VAL-298, LEU-301, VAL-302, |
| 6 | 10DR10 | −12.088 | PHE-218, LYS-246, VAL-247, ILE-250, VAL-298, LEU-301, |
| | | | VAL-302, TYR-303, THR-304, |
| 7 | 10DR11 | −12.499 | ILE-250, LEU-254, MET-258, LEU-294, VAL-298, LEU-301, |
| | | | VAL-302, TYR-303, ARG-311 |
| 8 | 10DR12 | −14.863 | PHE-218, VAL-247, ILE-250, LEU-254, VAL-298, LEU-301, |
| | | | VAL-302, TYR-303, THR-304, ARG-311 |
| 9 | 10DR15 | −15.743 | PHE-218, VAL-247, ILE-250, LEU-254, MET-258, LEU-294, |
| | | | VAL-298, LEU-301, VAL-302, TYR-303, THR-304, ARG-311 |
| 10 | 10DR18 | −27.8 | LEU-170, VAL-174, PHE-178, ILE-181, LYS-182, LYS-246, |
| | | | ILE-250, PHE-253, LEU-254, VAL-256, VAL-257, |
| 11 | 10DR21 | −9.594 | PHE-218, ILE-250, LEU-254, LEU-294, VAL-298, LEU-301, |
| | | | VAL-302, TYR-303, ARG-311 |
| 12 | 10DR22 | −15.776 | PHE-218, ILE-250, PHE-253, LEU-254, VAL-298, LEU-301, |
| | | | VAL-302, |
| 13 | 10DR25 | −14.016 | PHE-218, LYS-246, VAL-247, ILE-250, VAL-298, LEU-301, |
| | | | VAL-302, TYR-303, THR-304, |
| 14 | 10DR32 | −18.85 | PHE-218, LYS-246, VAL-247, ILE-250, PHE-253, LEU-254, |
| | | | VAL-257, VAL-298, LEU-301, VAL-302, THR-304, |
| 15 | 10DR37 | −9.008 | PHE-218, LYS-246, VAL-247, ILE-250, VAL-298, LEU-301, |
| | | | VAL-302, TYR-303, THR-304, |
| 16 | 10DR39 | −13.033 | VAL-7, ILE-250, PHE-253, LEU-254, MET-258, LEU-294, |
| | | | VAL-298, LEU-301, VAL-302. |
| 17 | 10DR41 | −12.992 | PHE-218, LYS-246, VAL-247, ILE-250, PHE-253, LEU-254 |
| | | | VAL-298, LEU-301, VAL-302, THR-304, |
| 18 | 10DR42 | −21.486 | PHE-218, ILE-250, LEU-254, VAL-298, LEU-301, VAL-302, |
| | | | TYR-303, THR-304, ARG-311, |
| 19 | 10DR44 | −12.497 | PHE-218, VAL-247, ILE-250, PHE-253, LEU-254, VAL-298, |
| | | | LEU-301, VAL-302, TYR-303, THR-304, ARG-311, |
| 20 | 10DR45 | −17.724 | PHE-218, VAL-247, ILE-250, LEU-254, VAL-298, LEU-301, |
| | | | VAL-302, TYR-303, THR-304, ARG-311, |
| 21 | 10DR48 | −45.775 | VAL-174, PHE-178, PHE-253, LEU-254, VAL-256, VAL-257, |
| | | | CYS-260, PRO-261, ILE-264, |
| 22 | 10DR49 | −13.453 | ILE-250, LEU-254, MET-258, ILE-291, LEU-294, VAL-298, |
| | | | LEU-301, VAL-302, TYR-303, THR-304, |
| 23 | 10DR52 | −12.663 | ILE-250, LEU-254, MET-258, TRP-290, ILE-291, LEU-294, |
| | | | VAL-298, LEU-301, VAL-302, TYR-303, |
| 24 | 10DR58 | −16.669 | VAL-7, LEU-10, PHE-218, LYS-246, VAL-247, ILE-250, LEU- |
| | | | 294, VAL-298, LEU-301, VAL-302. TYR-303, THR-304. |
| 25 | 10DR60 | −10.881 | LEU-10, PHE-218, LYS-246, VAL-247, ILE-250, LEU-294, LEU- |
| | | | 301, VAL-302. TYR-303, THR-304, ARG-311. |
| 26 | 10DR62 | −4.427 | VAL-7, LEU-254, MET-258, TRP-290, ILE-291, LEU-294, VAL- |
| | | | 298, LEU-301, VAL-302. |

TABLE 23
Toxicity Risks Assessment, drug likeness and drug score of Yohimbane alkaloids derivatives

| | Toxicity risks | | | | | | | | |
|---|---|---|---|---|---|---|---|---|---|
| | MUT | TUMO | IRRI | REP | Parameters | | Drug Likeness | | |
| Compound | (Mutagencity) | Tumorogencity | (Irritation) | (Reproduction) | MW | CLP | S | D-L | D-S |
| Yohimbine | No Risk | No Risk | No Risk | No Risk | 354 | 2.44 | −3.06 | 1.0 | 0.72 |
| Halopreidol | No Risk | No Risk | No Risk | No Risk | 373 | 5.41 | −4.55 | 7.59 | 0.51 |
| Clozapine | No Risk | No Risk | No Risk | No Risk | 326 | 3.0 | −3.74 | 8.7 | 0.79 |
| Risperidone | No Risk | No Risk | No Risk | No Risk | 410 | 3.37 | −4.32 | 4.43 | 0.66 |
| Ziprasidone | High Risk | No Risk | No Risk | No Risk | 412 | 2.46 | −3.89 | 8.71 | 0.44 |
| KOO1 | No Risk | No Risk | No Risk | No Risk | 354 | 2.44 | −3.06 | 1.0 | 0.72 |
| KOO1A | No Risk | No Risk | No Risk | No Risk | 396 | 2.93 | −3.47 | 0.99 | 0.66 |
| KOO1B | No Risk | No Risk | No Risk | No Risk | 574 | 4.22 | −5.07 | 1.63 | 0.37 |
| KOO1C | High Risk | No Risk | No Risk | No Risk | 503 | 4.28 | −5.1 | −5.62 | 0.14 |
| KOO1D | No Risk | No Risk | No Risk | No Risk | 458 | 4.41 | −4.64 | 0.94 | 0.46 |
| KOO1E | High Risk | No Risk | No Risk | No Risk | 503 | 4.28 | −5.1 | −13.69 | 0.14 |
| KOO1F | No Risk | No Risk | No Risk | No Risk | 484 | 4.53 | −5.01 | −2.56 | 0.2 |
| KOO1G | No Risk | No Risk | No Risk | No Risk | 522 | 7.97 | −6.19 | −19.0 | 0.12 |
| KOO6 | No Risk | No Risk | No Risk | No Risk | 352 | 2.2 | −3.14 | 2.28 | 0.8 |
| KOO3 | No Risk | No Risk | No Risk | No Risk | 382 | 2.09 | −3.16 | 2.51 | 0.79 |
| KOO5 | No Risk | No Risk | No Risk | No Risk | 412 | 1.98 | −3.18 | 2.9 | 0.77 |
| KOO2 | No Risk | No Risk | No Risk | No Risk | 412 | 1.98 | −3.18 | 2.9 | 0.77 |
| KOO4A | No Risk | No Risk | No Risk | No Risk | 382 | 2.09 | −3.16 | 2.51 | 0.79 |
| KOO4B | No Risk | No Risk | No Risk | No Risk | 382 | 2.09 | −3.16 | 2.51 | 0.79 |
| Y1 | No Risk | No Risk | No Risk | No Risk | 354 | 2.45 | −3.21 | 3.04 | 0.81 |
| Y2 | No Risk | No Risk | No Risk | No Risk | 396 | 2.94 | −3.61 | 3.09 | 0.74 |
| Y3 | No Risk | No Risk | No Risk | No Risk | 410 | 3.4 | −3.89 | 3.86 | 0.69 |
| Y4 | No Risk | No Risk | No Risk | No Risk | 467 | 3.32 | −4.26 | 2.69 | 0.6 |
| Y5 | No Risk | No Risk | No Risk | No Risk | 501 | 4.4 | −5.13 | 4.31 | 0.45 |
| Y6 | No Risk | No Risk | Medium Risk | No Risk | 505 | 5.12 | −5.85 | 4.39 | 0.28 |
| Y7 | No Risk | No Risk | No Risk | No Risk | 549 | 5.2 | −5.95 | 2.26 | 0.3 |
| Y8 | No Risk | No Risk | No Risk | No Risk | 485 | 4.29 | −4.93 | 4.05 | 0.49 |
| Y9 | No Risk | No Risk | No Risk | No Risk | 507 | 6.14 | −5.53 | −14.1 | 0.16 |
| Y10 | No Risk | No Risk | No Risk | No Risk | 437 | 3.82 | −4.18 | 4.22 | 0.62 |
| Y11 | No Risk | No Risk | High Risk | No Risk | 480 | 5.69 | −5.12 | −10.9 | 0.11 |
| Y12 | No Risk | No Risk | No Risk | No Risk | 438 | 4.23 | −4.42 | −0.84 | 0.38 |
| Y13 | No Risk | No Risk | High Risk | No Risk | 452 | 4.63 | −4.47 | 1.54 | 0.39 |
| Y14 | No Risk | No Risk | High Risk | No Risk | 452 | 4.76 | −4.58 | −3.29 | 0.16 |
| Y15 | No Risk | No Risk | High Risk | No Risk | 466 | 5.22 | −4.85 | −6.48 | 0.13 |
| Y16 | No Risk | No Risk | No Risk | No Risk | 452 | 4.38 | −4.53 | −22.5 | 0.27 |
| Y17 | No Risk | No Risk | No Risk | No Risk | 483 | 1.5 | −3.47 | 5.14 | 0.69 |
| Y18 | No Risk | No Risk | No Risk | No Risk | 467 | 2.41 | −3.76 | 0.68 | 0.57 |
| Y19 | No Risk | No Risk | No Risk | No Risk | 468 | 0.5 | −3.27 | −1.95 | 0.41 |
| Y20 | No Risk | No Risk | No Risk | No Risk | 496 | 0.52 | −3.31 | −1.59 | 0.41 |
| Y21 | No Risk | No Risk | No Risk | No Risk | 497 | 1.08 | −3.24 | −4.24 | 0.35 |
| Y22 | Medium Risk | No Risk | No Risk | High Risk | 485 | 2.28 | −4.18 | 2.52 | 0.16 |
| Y23 | No Risk | No Risk | No Risk | No Risk | 517 | −0.84 | −3.15 | 1.38 | 0.61 |
| Y25 | No Risk | No Risk | No Risk | No Risk | 453 | 2.01 | −3.38 | −0.91 | 0.47 |
| Y26 | No Risk | No Risk | No Risk | No Risk | 519 | 1.54 | −3.32 | −1.43 | 0.39 |
| Y27 | No Risk | No Risk | No Risk | No Risk | 495 | 3.21 | −4.19 | −5.3 | 0.3 |
| Y28 | No Risk | No Risk | No Risk | No Risk | 465 | 4.57 | −4.72 | 3.34 | 0.5 |
| Y30 | No Risk | No Risk | No Risk | No Risk | 499 | 2.33 | −3.9 | 1.47 | 0.58 |
| Y31 | No Risk | No Risk | No Risk | No Risk | 529 | 3.4 | −4.48 | −3.08 | 0.28 |
| Y32 | No Risk | No Risk | No Risk | No Risk | 469 | 1.04 | −3.2 | 1.29 | 0.65 |
| Y33 | No Risk | No Risk | No Risk | No Risk | 497 | 1.86 | −3.63 | −3.72 | 0.34 |
| Y34 | No Risk | No Risk | No Risk | No Risk | 568 | 3.47 | −5.0 | −1.06 | 0.28 |
| Y36 | No Risk | No Risk | No Risk | No Risk | 545 | 3.1 | −4.18 | −0.57 | 0.37 |
| Y37 | No Risk | No Risk | No Risk | No Risk | 481.0 | 2.92 | −3.78 | −1.45 | 0.39 |
| Y38 | No Risk | No Risk | High Risk | No Risk | 479 | 4.5 | −4.55 | 2.28 | 0.29 |
| Y40 | No Risk | No Risk | No Risk | No Risk | 425 | 1.94 | −3.13 | 4.77 | 0.78 |
| Y41 | No Risk | No Risk | No Risk | No Risk | 439 | 2.35 | −3.51 | 4.74 | 0.73 |
| Y43 | No Risk | No Risk | No Risk | No Risk | 497 | 1.85 | −3.49 | 1.93 | 0.63 |
| Y44 | No Risk | No Risk | No Risk | No Risk | 559 | 3.38 | −4.48 | 3.09 | 0.49 |
| Y45 | No Risk | No Risk | No Risk | No Risk | 453 | 2.0 | −3.24 | 1.13 | 0.65 |
| Y46 | No Risk | No Risk | No Risk | No Risk | 509 | 3.67 | −4.32 | 4.07 | 0.54 |
| Y47 | No Risk | No Risk | No Risk | No Risk | 529 | 3.39 | −4.34 | 4.72 | 0.54 |
| Y48 | No Risk | No Risk | No Risk | No Risk | 525 | 527 | −6.32 | 3.78 | 0.31 |
| Y50 | No Risk | No Risk | No Risk | No Risk | 526 | 5.64 | −6.26 | 3.06 | 0.29 |

TABLE 24
Screening of yohimbane alkaloids derivatives through Lipinski rule of five

| | | | | Group | | | | Rule | Molec- | | | |
|---|---|---|---|---|---|---|---|---|---|---|---|---|
| Chemical | Molec- | | Group | Count | Group | Atom | Atom | of 5 | ular | | H-bond | H-bond |
| Sample | ular | | Count | (sec- | Count | Count | Count | viola- | weight > | LogP > | donors > | acceptors > |
| Name | Weight | Log P | (amine) | amine) | (hydroxyl) | (nitrogen) | (oxygen) | tions | 500 | 5 | 5 | 10 |
| 10DR1 | 368.432 | 1.774 | 0 | 1 | 1 | 2 | 4 | 0 | 0 | 0 | 0 | 0 |
| 10DR2 | 354.405 | 1.742 | 0 | 1 | 1 | 2 | 4 | 0 | 0 | 0 | 0 | 0 |
| 10DR3 | 368.432 | 1.774 | 0 | 1 | 0 | 2 | 4 | 0 | 0 | 0 | 0 | 0 |
| 10DR4 | 439.553 | 2.058 | 0 | 2 | 1 | 3 | 4 | 0 | 0 | 0 | 0 | 0 |
| 10DR5 | 473.571 | 2.584 | 0 | 2 | 0 | 3 | 4 | 0 | 0 | 0 | 0 | 0 |
| 10DR6 | 477.99 | 3.355 | 0 | 2 | 0 | 3 | 3 | 0 | 0 | 0 | 0 | 0 |
| 10DR7 | 522.44 | 3.629 | 0 | 2 | 0 | 3 | 3 | 1 | 0.045 | 0 | 0 | 0 |
| 10DR8 | 457.571 | 2.932 | 0 | 2 | 0 | 3 | 3 | 0 | 0 | 0 | 0 | 0 |
| 10DR9 | 479.661 | 3.948 | 0 | 2 | 0 | 3 | 3 | 0 | 0 | 0 | 0 | 0 |
| 10DR10 | 409.527 | 1.966 | 0 | 2 | 0 | 3 | 3 | 0 | 0 | 0 | 0 | 0 |
| 10DR11 | 452.592 | 3.805 | 0 | 1 | 0 | 2 | 4 | 0 | 0 | 0 | 0 | 0 |
| 10DR12 | 410.512 | 2.561 | 0 | 1 | 0 | 2 | 4 | 0 | 0 | 0 | 0 | 0 |
| 10DR13 | 424.539 | 3.019 | 0 | 1 | 0 | 2 | 4 | 0 | 0 | 0 | 0 | 0 |
| 10DR14 | 424.539 | 3.013 | 0 | 1 | 0 | 2 | 4 | 0 | 0 | 0 | 0 | 0 |
| 10DR15 | 438.566 | 3.409 | 0 | 1 | 0 | 2 | 4 | 0 | 0 | 0 | 0 | 0 |
| 10DR16 | 424.539 | 2.639 | 0 | 1 | 0 | 2 | 4 | 0 | 0 | 0 | 0 | 0 |
| 10DR17 | 455.51 | 0.773 | 0 | 2 | 1 | 3 | 6 | 0 | 0 | 0 | 0 | 0 |
| 10DR18 | 439.51 | 1.235 | 0 | 2 | 0 | 3 | 5 | 0 | 0 | 0 | 0 | 0 |
| 10DR19 | 482.578 | 0.605 | 1 | 2 | 0 | 4 | 5 | 0 | 0 | 0 | 0 | 0 |
| 10DR20 | 482.535 | −0.25 | 0 | 2 | 0 | 4 | 6 | 0 | 0 | 0 | 0 | 0 |
| 10DR21 | 483.52 | 0.615 | 0 | 2 | 0 | 3 | 7 | 0 | 0 | 0 | 0 | 0 |
| 10DR22 | 470.562 | 1.018 | 0 | 2 | 0 | 3 | 5 | 0 | 0 | 0 | 0 | 0 |
| 10DR23 | 497.547 | 0.867 | 0 | 2 | 0 | 3 | 7 | 0 | 0 | 0 | 0 | 0 |
| 10DR24 | 496.562 | 0.002 | 0 | 2 | 0 | 4 | 6 | 0 | 0 | 0 | 0 | 0 |
| 10DR25 | 425.483 | 0.697 | 0 | 2 | 0 | 3 | 5 | 0 | 0 | 0 | 0 | 0 |
| 10DR26 | 505.572 | 0.361 | 0 | 3 | 0 | 5 | 5 | 1 | 0.011 | 0 | 0 | 0 |
| 10DR27 | 481.591 | 2.502 | 0 | 2 | 0 | 3 | 5 | 0 | 0 | 0 | 0 | 0 |
| 10DR28 | 481.591 | 2.43 | 0 | 2 | 0 | 3 | 5 | 0 | 0 | 0 | 0 | 0 |
| 10DR29 | 496.605 | 1.001 | 1 | 2 | 0 | 4 | 5 | 0 | 0 | 0 | 0 | 0 |
| 10DR30 | 499.624 | 1.222 | 0 | 2 | 0 | 3 | 5 | 0 | 0 | 0 | 0 | 0 |
| 10DR31 | 515.608 | 2.92 | 0 | 2 | 0 | 3 | 5 | 1 | 0.031 | 0 | 0 | 0 |
| 10DR32 | 455.51 | 0.449 | 0 | 2 | 1 | 3 | 6 | 0 | 0 | 0 | 0 | 0 |
| 10DR33 | 469.536 | 0.862 | 0 | 2 | 1 | 3 | 6 | 0 | 0 | 0 | 0 | 0 |
| 10DR34 | 554.644 | 2.229 | 0 | 3 | 0 | 4 | 5 | 1 | 0.109 | 0 | 0 | 0 |
| 10DR35 | 531.607 | 2.636 | 0 | 2 | 1 | 3 | 6 | 1 | 0.063 | 0 | 0 | 0 |
| 10DR36 | 467.564 | 2.106 | 0 | 2 | 0 | 3 | 5 | 0 | 0 | 0 | 0 | 0 |
| 10DR37 | 453.537 | 0.841 | 0 | 2 | 0 | 3 | 5 | 0 | 0 | 0 | 0 | 0 |
| 10DR38 | 467.564 | 1.254 | 0 | 2 | 0 | 3 | 5 | 0 | 0 | 0 | 0 | 0 |
| 10DR39 | 515.608 | 2.431 | 0 | 2 | 0 | 3 | 5 | 1 | 0.031 | 0 | 0 | 0 |
| 10DR40 | 411.5 | 0.712 | 0 | 2 | 1 | 3 | 4 | 0 | 0 | 0 | 0 | 0 |
| 10DR41 | 425.527 | 1.125 | 0 | 2 | 1 | 3 | 4 | 0 | 0 | 0 | 0 | 0 |
| 10DR42 | 473.571 | 2.302 | 0 | 2 | 1 | 3 | 4 | 0 | 0 | 0 | 0 | 0 |
| 10DR43 | 483.563 | 0.894 | 0 | 2 | 1 | 3 | 6 | 0 | 0 | 0 | 0 | 0 |
| 10DR44 | 501.624 | 3.312 | 0 | 2 | 1 | 3 | 4 | 1 | 0.003 | 0 | 0 | 0 |
| 10DR45 | 395.5 | 1.498 | 0 | 2 | 0 | 3 | 3 | 0 | 0 | 0 | 0 | 0 |
| 10DR46 | 495.617 | 2.534 | 0 | 2 | 0 | 3 | 5 | 0 | 0 | 0 | 0 | 0 |
| 10DR47 | 529.635 | 2.952 | 0 | 2 | 0 | 3 | 5 | 1 | 0.059 | 0 | 0 | 0 |
| 10DR48 | 512.435 | 3.873 | 0 | 2 | 0 | 3 | 3 | 1 | 0.025 | 0 | 0 | 0 |
| 10DR49 | 541.43 | 4.506 | 0 | 1 | 0 | 2 | 5 | 1 | 0.083 | 0 | 0 | 0 |
| 10DR50 | 562.618 | 2.712 | 0 | 1 | 0 | 2 | 8 | 1 | 0.125 | 0 | 0 | 0 |
| 10DR52 | 438.522 | 2.581 | 0 | 1 | 0 | 2 | 5 | 0 | 0 | 0 | 0 | 0 |
| 10DR53 | 517.537 | 3.423 | 0 | 1 | 0 | 3 | 7 | 1 | 0.035 | 0 | 0 | 0 |
| 10DR54 | 531.564 | 3.356 | 0 | 1 | 0 | 3 | 7 | 1 | 0.063 | 0 | 0 | 0 |
| 10DR55 | 498.577 | 3.878 | 0 | 1 | 0 | 2 | 5 | 0 | 0 | 0 | 0 | 0 |
| 10DR56 | 550.737 | 5.752 | 0 | 1 | 0 | 2 | 5 | 2 | 0.101 | 1 | 0 | 0 |
| 10DR57 | 606.844 | 7.337 | 0 | 1 | 0 | 2 | 5 | 2 | 0.214 | 1 | 0 | 0 |
| 10DR58 | 502.566 | 3.217 | 0 | 1 | 0 | 2 | 6 | 1 | 0.005 | 0 | 0 | 0 |
| 10DR59 | 452.549 | 3.413 | 0 | 1 | 0 | 2 | 5 | 0 | 0 | 0 | 0 | 0 |
| 10DR60 | 497.549 | 3.506 | 0 | 1 | 0 | 3 | 5 | 0 | 0 | 0 | 0 | 0 |
| 10DR61 | 530.574 | 0.31 | 0 | 1 | 4 | 2 | 9 | 2 | 0.061 | 0 | 0 | 1 |
| 10DR62 | 530.574 | 0.31 | 0 | 1 | 4 | 2 | 9 | 2 | 0.061 | 0 | 0 | 1 |
| 11DR1 | 368.432 | 1.774 | 0 | 1 | 1 | 2 | 4 | 0 | 0 | 0 | 0 | 0 |
| 11DR2 | 354.405 | 1.742 | 0 | 1 | 1 | 2 | 4 | 0 | 0 | 0 | 0 | 0 |
| 11DR3 | 368.432 | 1.774 | 0 | 1 | 0 | 2 | 4 | 0 | 0 | 0 | 0 | 0 |
| 11DR4 | 439.553 | 2.058 | 0 | 2 | 1 | 3 | 4 | 0 | 0 | 0 | 0 | 0 |
| 11DR5 | 473.571 | 2.584 | 0 | 2 | 0 | 3 | 4 | 0 | 0 | 0 | 0 | 0 |
| 11DR6 | 477.99 | 3.355 | 0 | 2 | 0 | 3 | 3 | 0 | 0 | 0 | 0 | 0 |
| 11DR7 | 522.44 | 3.629 | 0 | 2 | 0 | 3 | 3 | 1 | 0.045 | 0 | 0 | 0 |
| 11DR8 | 457.571 | 2.932 | 0 | 2 | 0 | 3 | 3 | 0 | 0 | 0 | 0 | 0 |
| 11DR9 | 479.661 | 3.948 | 0 | 2 | 0 | 3 | 3 | 0 | 0 | 0 | 0 | 0 |
| 11DR10 | 409.527 | 1.966 | 0 | 2 | 0 | 3 | 3 | 0 | 0 | 0 | 0 | 0 |
| 11DR11 | 452.592 | 3.805 | 0 | 1 | 0 | 2 | 4 | 0 | 0 | 0 | 0 | 0 |
| 11DR12 | 410.512 | 2.561 | 0 | 1 | 0 | 2 | 4 | 0 | 0 | 0 | 0 | 0 |
| 11DR13 | 424.539 | 3.019 | 0 | 1 | 0 | 2 | 4 | 0 | 0 | 0 | 0 | 0 |
| 11DR14 | 424.539 | 3.013 | 0 | 1 | 0 | 2 | 4 | 0 | 0 | 0 | 0 | 0 |
| 11DR15 | 438.566 | 3.409 | 0 | 1 | 0 | 2 | 4 | 0 | 0 | 0 | 0 | 0 |
| 11DR16 | 424.539 | 2.639 | 0 | 1 | 0 | 2 | 4 | 0 | 0 | 0 | 0 | 0 |
| 11DR17 | 455.51 | 0.773 | 0 | 2 | 1 | 3 | 6 | 0 | 0 | 0 | 0 | 0 |
| 11DR18 | 439.51 | 1.235 | 0 | 2 | 0 | 3 | 5 | 0 | 0 | 0 | 0 | 0 |
| 11DR19 | 482.578 | 0.605 | 1 | 2 | 0 | 4 | 5 | 0 | 0 | 0 | 0 | 0 |
| 11DR20 | 482.535 | −0.25 | 0 | 2 | 0 | 4 | 6 | 0 | 0 | 0 | 0 | 0 |
| 11DR21 | 483.52 | 0.615 | 0 | 2 | 0 | 3 | 7 | 0 | 0 | 0 | 0 | 0 |
| 11DR22 | 470.562 | 1.018 | 0 | 2 | 0 | 3 | 5 | 0 | 0 | 0 | 0 | 0 |
| 11DR23 | 497.547 | 0.867 | 0 | 2 | 0 | 3 | 7 | 0 | 0 | 0 | 0 | 0 |
| 11DR24 | 496.562 | 0.002 | 0 | 2 | 0 | 4 | 6 | 0 | 0 | 0 | 0 | 0 |
| 11DR25 | 425.483 | 0.697 | 0 | 2 | 0 | 3 | 5 | 0 | 0 | 0 | 0 | 0 |
| 11DR26 | 505.572 | 0.361 | 0 | 3 | 0 | 5 | 5 | 1 | 0.011 | 0 | 0 | 0 |
| 11DR27 | 481.591 | 2.502 | 0 | 2 | 0 | 3 | 5 | 0 | 0 | 0 | 0 | 0 |
| 11DR28 | 481.591 | 2.43 | 0 | 2 | 0 | 3 | 5 | 0 | 0 | 0 | 0 | 0 |
| 11DR29 | 496.605 | 1.001 | 1 | 2 | 0 | 4 | 5 | 0 | 0 | 0 | 0 | 0 |
| 11DR32 | 455.51 | 0.449 | 0 | 2 | 1 | 3 | 6 | 0 | 0 | 0 | 0 | 0 |
| 11DR34 | 554.644 | 2.229 | 0 | 3 | 0 | 4 | 5 | 1 | 0.109 | 0 | 0 | 0 |
| 11DR35 | 531.607 | 2.636 | 0 | 2 | 1 | 3 | 6 | 1 | 0.063 | 0 | 0 | 0 |
| 11DR36 | 467.564 | 2.106 | 0 | 2 | 0 | 3 | 5 | 0 | 0 | 0 | 0 | 0 |
| 11DR37 | 453.537 | 0.841 | 0 | 2 | 0 | 3 | 5 | 0 | 0 | 0 | 0 | 0 |
| 11DR38 | 467.564 | 1.254 | 0 | 2 | 0 | 3 | 5 | 0 | 0 | 0 | 0 | 0 |
| 11DR39 | 515.608 | 2.431 | 0 | 2 | 0 | 3 | 5 | 1 | 0.031 | 0 | 0 | 0 |
| 11DR40 | 411.5 | 0.712 | 0 | 2 | 1 | 3 | 4 | 0 | 0 | 0 | 0 | 0 |
| 11DR41 | 425.527 | 1.125 | 0 | 2 | 1 | 3 | 4 | 0 | 0 | 0 | 0 | 0 |
| 11DR42 | 473.571 | 2.302 | 0 | 2 | 1 | 3 | 4 | 0 | 0 | 0 | 0 | 0 |
| 11DR43 | 483.563 | 0.894 | 0 | 2 | 1 | 3 | 6 | 0 | 0 | 0 | 0 | 0 |
| 11DR44 | 545.634 | 2.668 | 0 | 2 | 1 | 3 | 6 | 1 | 0.091 | 0 | 0 | 0 |
| 11DR45 | 439.51 | 0.729 | 0 | 2 | 0 | 3 | 5 | 0 | 0 | 0 | 0 | 0 |
| 11DR46 | 495.617 | 2.534 | 0 | 2 | 0 | 3 | 5 | 0 | 0 | 0 | 0 | 0 |
| 11DR47 | 529.635 | 2.952 | 0 | 2 | 0 | 3 | 5 | 1 | 0.059 | 0 | 0 | 0 |
| 11DR48 | 512.435 | 3.873 | 0 | 2 | 0 | 3 | 3 | 1 | 0.025 | 0 | 0 | 0 |
| 11DR49 | 541.43 | 4.506 | 0 | 1 | 0 | 2 | 5 | 1 | 0.083 | 0 | 0 | 0 |
| 11DR50 | 562.618 | 2.712 | 0 | 1 | 0 | 2 | 8 | 1 | 0.125 | 0 | 0 | 0 |
| 11DR51 | 438.522 | 2.581 | 0 | 1 | 0 | 2 | 5 | 0 | 0 | 0 | 0 | 0 |
| 11DR52 | 517.537 | 3.423 | 0 | 1 | 0 | 3 | 7 | 1 | 0.035 | 0 | 0 | 0 |
| 11DR53 | 531.564 | 3.356 | 0 | 1 | 0 | 3 | 7 | 1 | 0.063 | 0 | 0 | 0 |
| 11DR54 | 498.577 | 3.878 | 0 | 1 | 0 | 2 | 5 | 0 | 0 | 0 | 0 | 0 |
| 11DR55 | 550.737 | 5.752 | 0 | 1 | 0 | 2 | 5 | 2 | 0.101 | 1 | 0 | 0 |
| 11DR56 | 606.844 | 7.337 | 0 | 1 | 0 | 2 | 5 | 2 | 0.214 | 1 | 0 | 0 |
| 11DR57 | 502.566 | 3.217 | 0 | 1 | 0 | 2 | 6 | 1 | 0.005 | 0 | 0 | 0 |
| 11DR58 | 452.549 | 3.413 | 0 | 1 | 0 | 2 | 5 | 0 | 0 | 0 | 0 | 0 |
| 11DR59 | 497.549 | 3.506 | 0 | 1 | 0 | 3 | 5 | 0 | 0 | 0 | 0 | 0 |
| 11DR60 | 502.566 | 3.217 | 0 | 1 | 0 | 2 | 6 | 1 | 0.005 | 0 | 0 | 0 |
| 11DR61 | 530.574 | 0.31 | 0 | 1 | 4 | 2 | 9 | 2 | 0.061 | 0 | 0 | 1 |
| 11DR62 | 530.574 | 0.31 | 0 | 1 | 4 | 2 | 9 | 2 | 0.061 | 0 | 0 | 1 |
| R1 | 384.431 | 1.489 | 0 | 1 | 2 | 2 | 5 | 0 | 0 | 0 | 0 | 0 |
| R2 | 398.458 | 1.521 | 0 | 1 | 0 | 2 | 5 | 0 | 0 | 0 | 0 | 0 |
| R4 | 469.58 | 1.805 | 0 | 2 | 1 | 3 | 5 | 0 | 0 | 0 | 0 | 0 |
| R5 | 503.597 | 2.332 | 0 | 2 | 0 | 3 | 5 | 1 | 0.007 | 0 | 0 | 0 |
| R6 | 508.016 | 3.102 | 0 | 2 | 0 | 3 | 4 | 1 | 0.016 | 0 | 0 | 0 |
| R7 | 552.467 | 3.376 | 0 | 2 | 0 | 3 | 4 | 1 | 0.105 | 0 | 0 | 0 |
| R8 | 487.597 | 2.679 | 0 | 2 | 0 | 3 | 4 | 0 | 0 | 0 | 0 | 0 |
| R9 | 509.687 | 3.695 | 0 | 2 | 0 | 3 | 4 | 1 | 0.019 | 0 | 0 | 0 |
| R10 | 439.553 | 1.714 | 0 | 2 | 0 | 3 | 4 | 0 | 0 | 0 | 0 | 0 |
| R11- | 482.619 | 3.553 | 0 | 1 | 0 | 2 | 5 | 0 | 0 | 0 | 0 | 0 |
| R12 | 440.538 | 2.308 | 0 | 1 | 0 | 2 | 5 | 0 | 0 | 0 | 0 | 0 |
| R13 | 454.565 | 2.766 | 0 | 1 | 0 | 2 | 5 | 0 | 0 | 0 | 0 | 0 |
| R14 | 454.565 | 2.76 | 0 | 1 | 0 | 2 | 5 | 0 | 0 | 0 | 0 | 0 |
| R15 | 468.592 | 3.156 | 0 | 1 | 0 | 2 | 5 | 0 | 0 | 0 | 0 | 0 |
| R16 | 454.565 | 2.386 | 0 | 1 | 0 | 2 | 5 | 0 | 0 | 0 | 0 | 0 |
| R18 | 469.536 | 0.982 | 0 | 2 | 0 | 3 | 6 | 0 | 0 | 0 | 0 | 0 |
| R19 | 512.605 | 0.352 | 1 | 2 | 0 | 4 | 6 | 1 | 0.025 | 0 | 0 | 0 |
| R20 | 512.561 | −0.502 | 0 | 2 | 0 | 4 | 7 | 2 | 0.025 | 0 | 0 | 1 |
| R21 | 513.546 | 0.362 | 0 | 2 | 0 | 3 | 8 | 2 | 0.027 | 0 | 0 | 1 |
| R22 | 500.589 | 0.765 | 0 | 2 | 0 | 3 | 6 | 1 | 0.001 | 0 | 0 | 0 |
| R23 | 527.573 | 0.614 | 0 | 2 | 0 | 3 | 8 | 2 | 0.055 | 0 | 0 | 1 |
| R24 | 526.588 | −0.251 | 0 | 2 | 0 | 4 | 7 | 2 | 0.053 | 0 | 0 | 1 |
| R25 | 455.51 | 0.444 | 0 | 2 | 0 | 3 | 6 | 0 | 0 | 0 | 0 | 0 |
| R26- | 535.599 | 0.108 | 0 | 3 | 0 | 5 | 6 | 2 | 0.071 | 0 | 0 | 1 |
| R27 | 511.617 | 2.25 | 0 | 2 | 0 | 3 | 6 | 1 | 0.023 | 0 | 0 | 0 |
| R28 | 511.617 | 2.177 | 0 | 2 | 0 | 3 | 6 | 1 | 0.023 | 0 | 0 | 0 |
| R29 | 526.631 | 0.748 | 1 | 2 | 0 | 4 | 6 | 1 | 0.053 | 0 | 0 | 0 |
| R30 | 529.65 | 0.969 | 0 | 2 | 0 | 3 | 6 | 1 | 0.059 | 0 | 0 | 0 |
| R31 | 545.634 | 2.668 | 0 | 2 | 0 | 3 | 6 | 1 | 0.091 | 0 | 0 | 0 |
| R32 | 485.536 | 0.196 | 0 | 2 | 1 | 3 | 7 | 0 | 0 | 0 | 0 | 0 |
| R33 | 499.563 | 0.609 | 0 | 2 | 1 | 3 | 7 | 0 | 0 | 0 | 0 | 0 |
| R35 | 561.633 | 2.383 | 0 | 2 | 1 | 3 | 7 | 1 | 0.123 | 0 | 0 | 0 |
| R36 | 497.59 | 1.853 | 0 | 2 | 0 | 3 | 6 | 0 | 0 | 0 | 0 | 0 |
| R37 | 483.563 | 0.589 | 0 | 2 | 0 | 3 | 6 | 0 | 0 | 0 | 0 | 0 |
| R38 | 497.59 | 1.002 | 0 | 2 | 0 | 3 | 6 | 0 | 0 | 0 | 0 | 0 |
| R39- | 545.634 | 2.178 | 0 | 2 | 0 | 3 | 6 | 1 | 0.091 | 0 | 0 | 0 |
| R40 | 441.526 | 0.46 | 0 | 2 | 1 | 3 | 5 | 0 | 0 | 0 | 0 | 0 |
| R41 | 455.553 | 0.873 | 0 | 2 | 1 | 3 | 5 | 0 | 0 | 0 | 0 | 0 |
| R42 | 503.597 | 2.049 | 0 | 2 | 1 | 3 | 5 | 1 | 0.007 | 0 | 0 | 0 |
| R43 | 513.589 | 0.641 | 0 | 2 | 1 | 3 | 7 | 1 | 0.027 | 0 | 0 | 0 |
| R44 | 531.65 | 3.06 | 0 | 2 | 1 | 3 | 5 | 1 | 0.063 | 0 | 0 | 0 |
| R45 | 469.536 | 0.476 | 0 | 2 | 0 | 3 | 6 | 0 | 0 | 0 | 0 | 0 |
| R47 | 559.661 | 2.699 | 0 | 2 | 0 | 3 | 6 | 1 | 0.119 | 0 | 0 | 0 |
| R48 | 542.461 | 3.62 | 0 | 2 | 0 | 3 | 4 | 1 | 0.085 | 0 | 0 | 0 |
| R49 | 571.456 | 4.253 | 0 | 1 | 0 | 2 | 6 | 1 | 0.143 | 0 | 0 | 0 |
| R50 | 592.644 | 2.459 | 0 | 1 | 0 | 2 | 9 | 2 | 0.185 | 0 | 0 | 1 |
| R51 | 468.549 | 2.329 | 0 | 1 | 0 | 2 | 6 | 0 | 0 | 0 | 0 | 0 |
| R52 | 547.563 | 3.171 | 0 | 1 | 0 | 3 | 8 | 2 | 0.095 | 0 | 0 | 1 |
| R53 | 561.59 | 3.103 | 0 | 1 | 0 | 3 | 8 | 2 | 0.123 | 0 | 0 | 1 |
| R54 | 528.604 | 3.625 | 0 | 1 | 0 | 2 | 6 | 1 | 0.057 | 0 | 0 | 0 |
| R55 | 580.763 | 5.499 | 0 | 1 | 0 | 2 | 6 | 2 | 0.162 | 1 | 0 | 0 |
| R56 | 622.843 | 6.688 | 0 | 1 | 0 | 2 | 6 | 2 | 0.246 | 1 | 0 | 0 |
| R57 | 532.592 | 2.964 | 0 | 1 | 0 | 2 | 7 | 1 | 0.065 | 0 | 0 | 0 |
| R58 | 482.575 | 3.16 | 0 | 1 | 0 | 2 | 6 | 0 | 0 | 0 | 0 | 0 |
| R59 | 571.456 | 4.253 | 0 | 1 | 0 | 2 | 6 | 1 | 0.143 | 0 | 0 | 0 |
| R60 | 592.644 | 2.459 | 0 | 1 | 0 | 2 | 9 | 2 | 0.185 | 0 | 0 | 1 |
| R61 | 468.549 | 2.329 | 0 | 1 | 0 | 2 | 6 | 0 | 0 | 0 | 0 | 0 |
| R62 | 547.563 | 3.171 | 0 | 1 | 0 | 3 | 8 | 2 | 0.095 | 0 | 0 | 1 |
| R63 | 561.59 | 3.103 | 0 | 1 | 0 | 3 | 8 | 2 | 0.123 | 0 | 0 | 1 |
| R64 | 528.604 | 3.625 | 0 | 1 | 0 | 2 | 6 | 1 | 0.057 | 0 | 0 | 0 |
| R65 | 580.763 | 5.499 | 0 | 1 | 0 | 2 | 6 | 2 | 0.162 | 1 | 0 | 0 |
| R66 | 636.87 | 7.084 | 0 | 1 | 0 | 2 | 6 | 2 | 0.274 | 1 | 0 | 0 |
| R67 | 532.592 | 2.964 | 0 | 1 | 0 | 2 | 7 | 1 | 0.065 | 0 | 0 | 0 |
| R68 | 482.575 | 3.16 | 0 | 1 | 0 | 2 | 6 | 0 | 0 | 0 | 0 | 0 |
| Y1 | 340.421 | 2.011 | 0 | 1 | 1 | 2 | 3 | 0 | 0 | 0 | 0 | 0 |
| Y2 | 382.458 | 2.14 | 0 | 1 | 0 | 2 | 4 | 0 | 0 | 0 | 0 | 0 |
| Y3 | 396.485 | 2.769 | 0 | 1 | 0 | 2 | 4 | 0 | 0 | 0 | 0 | 0 |
| Y4 | 453.58 | 2.424 | 0 | 2 | 1 | 3 | 4 | 0 | 0 | 0 | 0 | 0 |
| Y5 | 487.597 | 2.951 | 0 | 2 | 0 | 3 | 4 | 0 | 0 | 0 | 0 | 0 |
| Y6 | 492.016 | 3.722 | 0 | 2 | 0 | 3 | 3 | 0 | 0 | 0 | 0 | 0 |
| Y7 | 536.467 | 3.996 | 0 | 2 | 0 | 3 | 3 | 1 | 0.073 | 0 | 0 | 0 |
| Y8 | 471.598 | 3.299 | 0 | 2 | 0 | 3 | 3 | 0 | 0 | 0 | 0 | 0 |
| Y9 | 493.688 | 4.315 | 0 | 2 | 0 | 3 | 3 | 0 | 0 | 0 | 0 | 0 |
| Y10 | 423.554 | 2.333 | 0 | 2 | 0 | 3 | 3 | 0 | 0 | 0 | 0 | 0 |
| Y11 | 466.619 | 4.172 | 0 | 1 | 0 | 2 | 4 | 0 | 0 | 0 | 0 | 0 |
| Y12 | 424.539 | 2.928 | 0 | 1 | 0 | 2 | 4 | 0 | 0 | 0 | 0 | 0 |
| Y13 | 438.566 | 3.386 | 0 | 1 | 0 | 2 | 4 | 0 | 0 | 0 | 0 | 0 |
| Y14 | 438.566 | 3.38 | 0 | 1 | 0 | 2 | 4 | 0 | 0 | 0 | 0 | 0 |
| Y15 | 452.592 | 3.776 | 0 | 1 | 0 | 2 | 4 | 0 | 0 | 0 | 0 | 0 |
| Y16 | 438.566 | 3.006 | 0 | 1 | 0 | 2 | 4 | 0 | 0 | 0 | 0 | 0 |
| Y17 | 469.536 | 1.14 | 0 | 2 | 1 | 3 | 6 | 0 | 0 | 0 | 0 | 0 |
| Y18 | 453.537 | 1.601 | 0 | 2 | 0 | 3 | 5 | 0 | 0 | 0 | 0 | 0 |
| Y19 | 496.605 | 0.972 | 1 | 2 | 0 | 4 | 5 | 0 | 0 | 0 | 0 | 0 |
| Y20 | 496.562 | 0.117 | 0 | 2 | 0 | 4 | 6 | 0 | 0 | 0 | 0 | 0 |
| Y21 | 497.547 | 0.982 | 0 | 2 | 0 | 3 | 7 | 0 | 0 | 0 | 0 | 0 |
| Y22 | 485.597 | 1.402 | 0 | 2 | 0 | 3 | 5 | 0 | 0 | 0 | 0 | 0 |
| Y23 | 511.574 | 1.234 | 0 | 2 | 0 | 3 | 7 | 1 | 0.023 | 0 | 0 | 0 |
| Y24 | 510.589 | 0.369 | 0 | 2 | 0 | 4 | 6 | 1 | 0.021 | 0 | 0 | 0 |
| Y25 | 439.51 | 1.064 | 0 | 2 | 0 | 3 | 5 | 0 | 0 | 0 | 0 | 0 |
| Y26 | 519.599 | 0.728 | 0 | 3 | 0 | 5 | 5 | 1 | 0.039 | 0 | 0 | 0 |
| Y27 | 495.617 | 2.869 | 0 | 2 | 0 | 3 | 5 | 0 | 0 | 0 | 0 | 0 |
| Y28 | 495.617 | 2.797 | 0 | 2 | 0 | 3 | 5 | 0 | 0 | 0 | 0 | 0 |
| Y29 | 510.632 | 1.368 | 1 | 2 | 0 | 4 | 5 | 1 | 0.021 | 0 | 0 | 0 |
| Y30 | 513.651 | 1.589 | 0 | 2 | 0 | 3 | 5 | 1 | 0.027 | 0 | 0 | 0 |
| Y31 | 529.635 | 3.287 | 0 | 2 | 0 | 3 | 5 | 1 | 0.059 | 0 | 0 | 0 |
| Y32 | 469.536 | 0.816 | 0 | 2 | 1 | 3 | 6 | 0 | 0 | 0 | 0 | 0 |
| Y33 | 483.563 | 1.229 | 0 | 2 | 1 | 3 | 6 | 0 | 0 | 0 | 0 | 0 |
| Y34 | 568.671 | 2.596 | 0 | 3 | 0 | 4 | 5 | 1 | 0.137 | 0 | 0 | 0 |
| Y35 | 545.634 | 3.003 | 0 | 2 | 1 | 3 | 6 | 1 | 0.091 | 0 | 0 | 0 |
| Y36 | 481.591 | 2.473 | 0 | 2 | 0 | 3 | 5 | 0 | 0 | 0 | 0 | 0 |
| Y37 | 467.564 | 1.208 | 0 | 2 | 0 | 3 | 5 | 0 | 0 | 0 | 0 | 0 |
| Y38 | 481.591 | 1.621 | 0 | 2 | 0 | 3 | 5 | 0 | 0 | 0 | 0 | 0 |
| Y39 | 529.635 | 2.798 | 0 | 2 | 0 | 3 | 5 | 1 | 0.059 | 0 | 0 | 0 |
| Y40 | 425.527 | 1.079 | 0 | 2 | 1 | 3 | 4 | 0 | 0 | 0 | 0 | 0 |
| Y41 | 439.553 | 1.492 | 0 | 2 | 1 | 3 | 4 | 0 | 0 | 0 | 0 | 0 |
| Y42 | 487.597 | 2.669 | 0 | 2 | 1 | 3 | 4 | 0 | 0 | 0 | 0 | 0 |
| Y43 | 497.59 | 1.261 | 0 | 2 | 1 | 3 | 6 | 0 | 0 | 0 | 0 | 0 |
| Y44 | 515.651 | 3.679 | 0 | 2 | 1 | 3 | 4 | 1 | 0.031 | 0 | 0 | 0 |
| Y45 | 453.537 | 1.096 | 0 | 2 | 0 | 3 | 5 | 0 | 0 | 0 | 0 | 0 |
| Y46 | 509.644 | 2.901 | 0 | 2 | 0 | 3 | 5 | 1 | 0.019 | 0 | 0 | 0 |
| Y47 | 543.661 | 3.319 | 0 | 2 | 0 | 3 | 5 | 1 | 0.087 | 0 | 0 | 0 |
| Y48 | 526.461 | 4.24 | 0 | 2 | 0 | 3 | 3 | 1 | 0.053 | 0 | 0 | 0 |
| Y49 | 526.461 | 4.24 | 0 | 2 | 0 | 3 | 3 | 1 | 0.053 | 0 | 0 | 0 |
| Y50 | 513.419 | 5.089 | 0 | 1 | 0 | 2 | 4 | 2 | 0.027 | 1 | 0 | 0 |
| Y51 | 534.608 | 3.295 | 0 | 1 | 0 | 2 | 7 | 1 | 0.069 | 0 | 0 | 0 |
| Y52 | 386.921 | 3.013 | 0 | 1 | 0 | 2 | 2 | 0 | 0 | 0 | 0 | 0 |
| Y53 | 489.527 | 4.007 | 0 | 1 | 0 | 3 | 6 | 0 | 0 | 0 | 0 | 0 |
| Y54 | 489.527 | 4.007 | 0 | 1 | 0 | 3 | 6 | 0 | 0 | 0 | 0 | 0 |
| Y55 | 470.567 | 4.461 | 0 | 1 | 0 | 2 | 4 | 0 | 0 | 0 | 0 | 0 |
| Y56 | 522.726 | 6.335 | 0 | 1 | 0 | 2 | 4 | 2 | 0.045 | 1 | 0 | 0 |
| Y57 | 534.824 | 8.446 | 0 | 1 | 0 | 2 | 2 | 2 | 0.07 | 1 | 0 | 0 |
| Y58 | 474.555 | 3.801 | 0 | 1 | 0 | 2 | 5 | 0 | 0 | 0 | 0 | 0 |
| Y60 | 559.661 | 3.035 | 0 | 2 | 1 | 3 | 6 | 1 | 0.119 | 0 | 0 | 0 |
| Y61 | 280.412 | 3.595 | 0 | 1 | 0 | 2 | 0 | 0 | 0 | 0 | 0 | 0 |
| Y62 | 543.661 | 3.319 | 0 | 2 | 0 | 3 | 5 | 1 | 0.087 | 0 | 0 | 0 |
| Y63 | 469.536 | 0.816 | 0 | 2 | 1 | 3 | 6 | 0 | 0 | 0 | 0 | 0 |
| Y64 | 280.412 | 3.595 | 0 | 1 | 0 | 2 | 0 | 0 | 0 | 0 | 0 | 0 |
| Y65 | 483.563 | 0.873 | 0 | 2 | 1 | 3 | 6 | 0 | 0 | 0 | 0 | 0 |
| Y66 | 545.634 | 3.003 | 0 | 2 | 1 | 3 | 6 | 1 | 0.091 | 0 | 0 | 0 |
| Y67 | 529.635 | 3.287 | 0 | 2 | 0 | 3 | 5 | 1 | 0.059 | 0 | 0 | 0 |
| Y68 | 280.412 | 3.595 | 0 | 1 | 0 | 2 | 0 | 0 | 0 | 0 | 0 | 0 |
| Y69 | 280.412 | 3.595 | 0 | 1 | 0 | 2 | 0 | 0 | 0 | 0 | 0 | 0 |
| Y70 | 545.634 | 3.038 | 0 | 2 | 1 | 3 | 6 | 1 | 0.091 | 0 | 0 | 0 |
| Y71 | 280.412 | 3.595 | 0 | 1 | 0 | 2 | 0 | 0 | 0 | 0 | 0 | 0 |
| Y72 | 503.597 | 2.909 | 0 | 2 | 2 | 3 | 5 | 1 | 0.007 | 0 | 0 | 0 |
| Y73 | 280.412 | 3.595 | 0 | 1 | 0 | 2 | 0 | 0 | 0 | 0 | 0 | 0 |
| Y74 | 396.485 | 2.967 | 0 | 1 | 0 | 2 | 4 | 0 | 0 | 0 | 0 | 0 |
| Y75 | 368.432 | 2.593 | 0 | 1 | 0 | 2 | 4 | 0 | 0 | 0 | 0 | 0 |
| Y76 | 424.539 | 3.363 | 0 | 1 | 0 | 2 | 4 | 0 | 0 | 0 | 0 | 0 |
| Y77 | 438.566 | 3.527 | 0 | 1 | 0 | 2 | 4 | 0 | 0 | 0 | 0 | 0 |
| Y78 | 438.566 | 3.593 | 0 | 1 | 0 | 2 | 4 | 0 | 0 | 0 | 0 | 0 |
| Y79 | 452.592 | 3.989 | 0 | 1 | 0 | 2 | 4 | 0 | 0 | 0 | 0 | 0 |
| Y80 | 438.566 | 4.028 | 0 | 1 | 0 | 2 | 4 | 0 | 0 | 0 | 0 | 0 |
| Y81 | 468.549 | 2.36 | 0 | 1 | 0 | 2 | 6 | 0 | 0 | 0 | 0 | 0 |
| Y82 | 441.564 | 2.366 | 0 | 1 | 0 | 2 | 4 | 0 | 0 | 0 | 0 | 0 |
| Y83 | 454.522 | 1.964 | 0 | 1 | 0 | 2 | 6 | 0 | 0 | 0 | 0 | 0 |
| Y84 | 453.537 | 1.099 | 0 | 1 | 0 | 3 | 5 | 0 | 0 | 0 | 0 | 0 |
| Y85 | 453.58 | 2.098 | 1 | 1 | 0 | 3 | 4 | 0 | 0 | 0 | 0 | 0 |
| Y86 | 432.564 | 2.806 | 0 | 2 | 0 | 4 | 2 | 0 | 0 | 0 | 0 | 0 |
| Y87 | 452.592 | 3.924 | 0 | 1 | 0 | 2 | 4 | 0 | 0 | 0 | 0 | 0 |
| Y88 | 452.592 | 3.924 | 0 | 1 | 0 | 2 | 4 | 0 | 0 | 0 | 0 | 0 |
| Y89 | 467.607 | 2.495 | 1 | 1 | 0 | 3 | 4 | 0 | 0 | 0 | 0 | 0 |
| Y90 | 470.626 | 2.77 | 0 | 1 | 0 | 2 | 4 | 0 | 0 | 0 | 0 | 0 |
| Y93 | 502.609 | 4.129 | 0 | 1 | 1 | 2 | 5 | 1 | 0.005 | 0 | 0 | 0 |
| Y95 | 482.575 | 2.489 | 0 | 1 | 0 | 2 | 6 | 0 | 0 | 0 | 0 | 0 |
| Y96 | 426.511 | 1.798 | 0 | 1 | 1 | 2 | 5 | 0 | 0 | 0 | 0 | 0 |
| Y97 | 440.538 | 2.36 | 0 | 1 | 1 | 2 | 5 | 0 | 0 | 0 | 0 | 0 |
| Y98 | 502.609 | 3.482 | 0 | 1 | 1 | 2 | 5 | 1 | 0.005 | 0 | 0 | 0 |
| Y99 | 560.689 | 3.917 | 0 | 1 | 0 | 2 | 6 | 1 | 0.121 | 0 | 0 | 0 |
| Y100 | 454.522 | 2.063 | 0 | 1 | 0 | 2 | 6 | 0 | 0 | 0 | 0 | 0 |
| K005 | 412.485 | 1.553 | 0 | 1 | 0 | 2 | 5 | 0 | 0 | 0 | 0 | 0 |
| K002 | 412.485 | 1.553 | 0 | 1 | 0 | 2 | 5 | 0 | 0 | 0 | 0 | 0 |
| K004 A | 382.458 | 1.805 | 0 | 1 | 0 | 2 | 4 | 0 | 0 | 0 | 0 | 0 |
| K004 B | 382.458 | 1.805 | 0 | 1 | 0 | 2 | 4 | 0 | 0 | 0 | 0 | 0 |
| K006 | 352.432 | 2.058 | 0 | 1 | 0 | 2 | 3 | 0 | 0 | 0 | 0 | 0 |
| K003 | 382.458 | 1.805 | 0 | 1 | 0 | 2 | 4 | 0 | 0 | 0 | 0 | 0 |
| K001 | 354.448 | 2.043 | 0 | 1 | 1 | 2 | 3 | 0 | 0 | 0 | 0 | 0 |
| K001 A | 396.485 | 2.172 | 0 | 1 | 0 | 2 | 4 | 0 | 0 | 0 | 0 | 0 |
| K001 B | 574.672 | 3.735 | 0 | 1 | 0 | 2 | 7 | 1 | 0.149 | 0 | 0 | 0 |
| K001 C | 504.562 | 2.618 | 0 | 1 | 1 | 3 | 6 | 1 | 0.009 | 0 | 0 | 0 |
| K001 D | 458.556 | 4.085 | 0 | 1 | 0 | 2 | 4 | 0 | 0 | 0 | 0 | 0 |
| K001 E | 504.562 | 2.618 | 0 | 1 | 1 | 3 | 6 | 1 | 0.009 | 0 | 0 | 0 |
| K001 F | 484.594 | 4.493 | 0 | 1 | 0 | 2 | 4 | 0 | 0 | 0 | 0 | 0 |
| K001 G | 522.77 | 6.699 | 0 | 1 | 0 | 2 | 3 | 2 | 0.046 | 1 | 0 | 0 |

TABLE 25
Details of radioligands, competitors and brain regions
involved in the assay of neurotransmitter receptors

| Sl. no. | Receptor | Brain Region | Radioligand | Competitor |
|---|---|---|---|---|
| 1. | Dopamine | Corpus striatum | ³H-Spiperone | Haloperidol |
| | (DA) - D2 | | (1 × 10⁻⁹ M) | (1 × 10⁻⁶ M) |
| 2. | Serotonin | Frontal cortex | ³H-Ketanserin | Cinanserin |
| | (5HT) -2A | | (1.5 × 10⁻⁹ M) | (1 × 10⁻⁵ M) |

TABLE 26
Details of buffer, competitors and MAP-1597 extracts/alkaloids
added in the multiwell plates

| | Tris | | | | | |
|---|---|---|---|---|---|---|
| | Buffer | | | | | |
| Receptor | (40 mM) | Radio- | Mem- | Compet- | Sam- | Total |
| Binding | pH 7.4 | ligand | brane | itor | ples | volume |
| Total | 160 μl | 40 μl | 50 μl | — | — | 250 μl |
| Binding | | | | | | |
| Compet- | 140 μl | 40 μl | 50 μl | 20 μl | — | 250 μl |
| itors | | | | | | |
| Binding | 140 μl | 40 μl | 50 μl | — | 20 μl | 250 μl |
| with test | | | | | (20 μg) | |
| sample | | | | | | |

Incubation was carried out in a final volume of 250 μl.

TABLE 27
representative compounds of formula 2

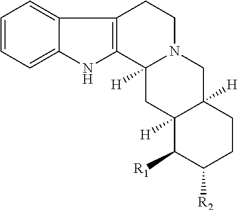

| | R1 | R2 |
|---|---|---|
| Y1 | —COOH | —OH |
| Y2 | —COOH | —OCOCH₃ |
| Y3 | —COOH | —OCOCH₂CH₃ |
| Y4 | 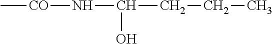 | —OCOCH₃ |
| Y5 | 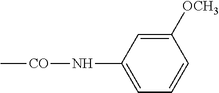 | —OCOCH₃ |
| Y6 | 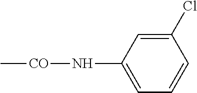 | —OCOCH₃ |
| Y7 | 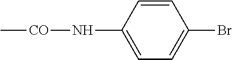 | —OCOCH₃ |
| Y8 | 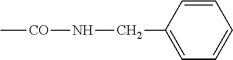 | —OCOCH₃ |
| Y9 | —CO—NH—CH₂—(CH₂)₆—CH₃ | —OCOCH₃ |
| Y10 | —CO—NH—CH₂—CH₂—CH₃ | —OCOCH₃ |
| Y11 | —COO—CH₂—(CH₂)₄—CH₃ | —OCOCH₃ |
| Y12 | 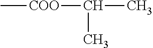 | —OCOCH₃ |
| Y13 | 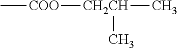 | —OCOCH₃ |
| Y14 | —COO—CH₂—CH₂—CH₂—CH₃ | —OCOCH₃ |
| Y15 | —COO—CH₂—CH₂—CH₂—CH₂—CH₃ | —OCOCH₃ |
| Y16 | —COO—CH—(CH₃)₃ | —OCOCH₃ |
| Y17 | 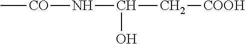 | —OCOCH₃ |
| Y18 | 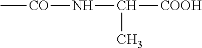 | —OCOCH₃ |
| Y19 | 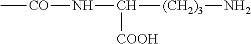 | —OCOCH₃ |
| Y20 | 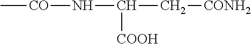 | —OCOCH₃ |
| Y21 | 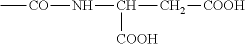 | —OCOCH₃ |
| Y22 | 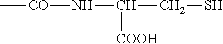 | —OCOCH₃ |
| Y23 | 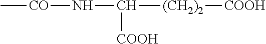 | —OCOCH₃ |
| Y24 | 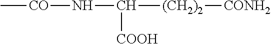 | —OCOCH₃ |
| Y25 | —CO—NH—CH₂—COOH | —OCOCH₃ |
| Y26 | 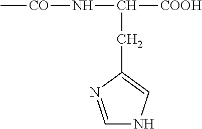 | —OCOCH₃ |
| Y27 | 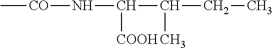 | —OCOCH₃ |
| Y28 | 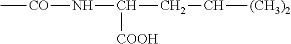 | —OCOCH₃ |
| Y29 | 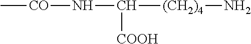 | —OCOCH₃ |
| Y30 | 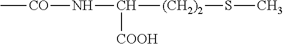 | —OCOCH₃ |
| Y31 | 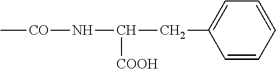 | —OCOCH₃ |
| Y32 | 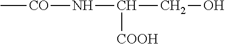 | —OCOCH₃ |
| Y33 | 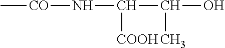 | —OCOCH₃ |
| Y34 | 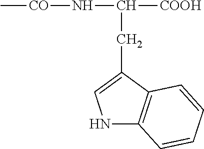 | —OCOCH₃ |
| Y35 | 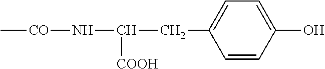 | —OCOCH₃ |
| Y36 | 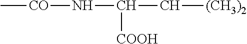 | —OCOCH₃ |
| Y37 | —CO—NH—CH₂—CH₂—OCOCH₃ | —OCOCH₃ |
| Y38 | 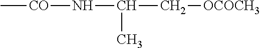 | —OCOCH₃ |
| Y39 | 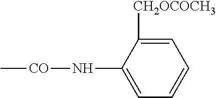 | —OCOCH₃ |
| Y40 | —CO—NH—CH₂—CH₂—OH | —OCOCH₃ |
| Y41 | 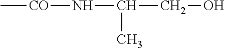 | —OCOCH₃ |
| Y42 | 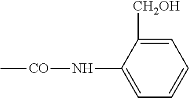 | —OCOCH₃ |
| Y43 | 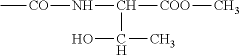 | —OCOCH₃ |
| Y44 | 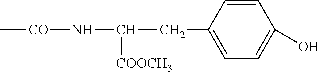 | —OCOCH₃ |
| Y45 | —CO—NH—CH₂—COO—CH₃ | —OCOCH₃ |
| Y46 | 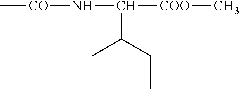 | —OCOCH₃ |
| Y47 | 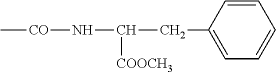 | —OCOCH₃ |
| Y48 | 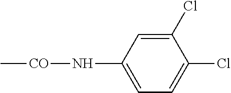 | —OCOCH₃ |
| Y49 | 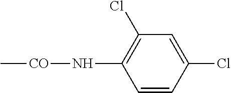 | —OCOCH₃ |
| Y50 | —COOH | 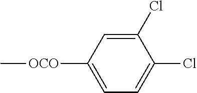 |
| Y51 | —COOH | 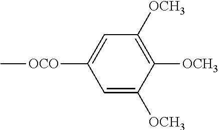 |
| Y52 | —COOH | —O—CH₂—CH₂—CO—Cl |
| Y53 | —COOH | 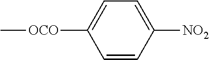 |
| Y54 | —COOH | 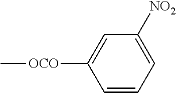 |
| Y55 | —COOH | 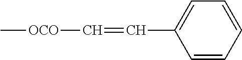 |
| Y56 | —COOH | —OCO—CH₂—(CH₂)₉—CH₃ |
| Y57 | —COOH | —OCO—CH₂—(CH₂)₁₃—CH₃ |
| Y58 | —COOH | 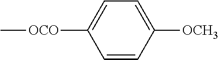 |
| Y59 | —COOH | —OCO—CH—(CH₃)₃ |
| Y60 | 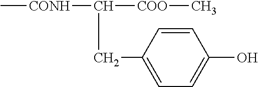 | —OCOCH₃ |
| Y61 | —CONH—CH₂—COO—CH₃ | —OCOCH₃ |
| Y62 | 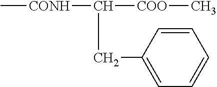 | —OCOCH₃ |
| Y63 | 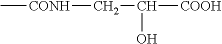 | —OCOCH₃ |
| Y64 | —CONH—CH₂—COOH | —OCOCH₃ |
| Y65 | 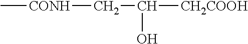 | —OCOCH₃ |
| Y66 | 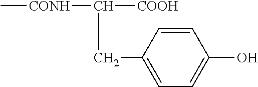 | —OCOCH₃ |
| Y67 | 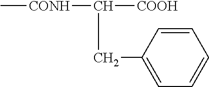 | —OCOCH₃ |
| Y68 | —CONH—CH₂—CH₂—OCOCH₃ | —OCOCH₃ |
| Y69 | 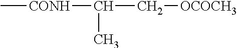 | —OCOCH₃ |
| Y70 | 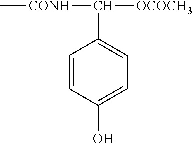 | —OCOCH₃ |
| Y71 | 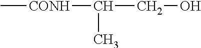 | —OCOCH₃ |
| Y72 | 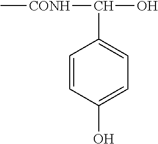 | —OCOCH₃ |
| Y73 | —CONH—CH₂—CH₂—OH | —OCOCH₃ |
| Y74 | —COOH | —OCO—COO—CH₂—CH₃ |
| Y75 | —COOH | —OCO—CO—OH |
| Y76 | —COO—CH₃ | 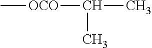 |
| Y77 | —COO—CH₃ | 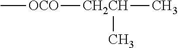 |
| Y78 | —COO—CH₃ | —OCO—CH₂—CH₂—CH₂—CH₃ |
| Y79 | —COO—CH₃ | —OCO—CH₂—CH₂—CH₂—CH₂—CH₃ |
| Y80 | —COO—CH₃ | —OCO—CH—(CH₃)₃ |
| Y81 | —COO—CH₃ | —OCO—CH₂—CH₂—CH₂—COOH |
| Y82 | —COO—CH₃ | —OCO—CH₂—CH₂—SH |
| Y83 | —COO—CH₃ | —OCO—CH₂—CH₂—COOH |
| Y84 | —COO—CH₃ | —OCO—CH₂—CH₂—CONH₂ |
| Y85 | —COO—CH₃ | —OCO—CH₂—CH₂—CH₂—CH₂—NH₂ |
| Y86 | —COOCH₃ | 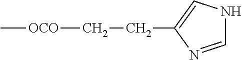 |
| Y87 | —COOCH₃ | 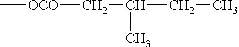 |
| Y88 | —COOCH₃ | 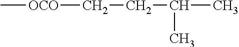 |
| Y89 | —COOCH₃ | —OCO—CH₂—(CH₂)₄—NH₂ |
| Y90 | —COOCH₃ | —OCO—CH₂—CH₂—CH₂—S—CH₃ |
| Y91 | —COOCH₃ | 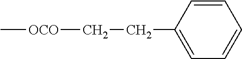 |
| Y92 | —COOCH₃ | 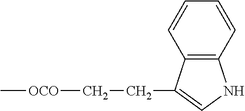 |
| Y93 | —COOCH₃ | 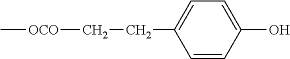 |
| Y94 | —COOCH₃ | —OCO—CH₂—CH₂—OCO—CH₃ |
| Y95 | —COOCH₃ | 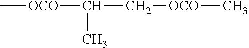 |
| Y96 | —COOCH₃ | —OCO—CH₂—CH₂—OH |
| Y97 | —COOCH₃ | 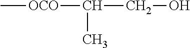 |
| Y98 | —COOCH₃ | 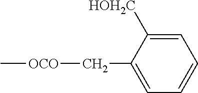 |
| Y99 | —COOCH₃ | 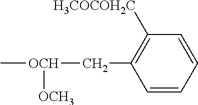 |
| Y100 | —COOCH₃ | —OCO—CH₂—COO—CH₃ |

TABLE 28
representative compounds of formula 3

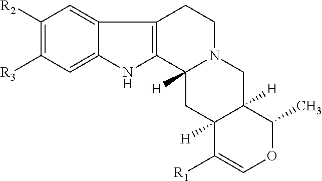

| | R1 | R2 | R3 |
|---|---|---|---|
| R1 | —COOCH₃ | —OH | —OH |
| R2 | —COOH | —OCH₃ | —OCH₃ |
| R3 | —COOH | —OH | —OH |
| R4 | 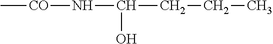 | —OCH₃ | —OCH₃ |
| R5 | 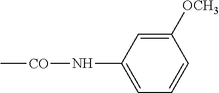 | —OCH₃ | —OCH₃ |
| R6 | 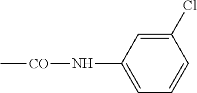 | —OCH₃ | —OCH₃ |
| R7 | 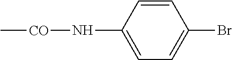 | —OCH₃ | —OCH₃ |
| R8 | 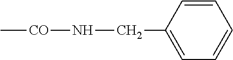 | —OCH₃ | —OCH₃ |
| R9 | —CO—NH—CH₂—(CH₂)₆—CH₃ | —OCH₃ | —OCH₃ |
| R10 | —CO—NH—CH₂—CH₂—CH₃ | —OCH₃ | —OCH₃ |
| R11 | —COO—CH₂—(CH₂)₄—CH₃ | —OCH₃ | —OCH₃ |
| R12 | 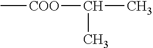 | —OCH₃ | —OCH₃ |
| R13 | 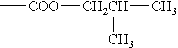 | —OCH₃ | —OCH₃ |
| R14 | —COO—CH₂—CH₂—CH₂—CH₃ | —OCH₃ | —OCH₃ |
| R15 | —COO—CH₂—CH₂—CH₂—CH₂—CH₃ | —OCH₃ | —OCH₃ |
| R16 | —COO—CH—(CH₃)₃ | —OCH₃ | —OCH₃ |
| R17 | 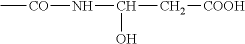 | —OCH₃ | —OCH₃ |
| R18 | 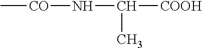 | —OCH₃ | —OCH₃ |
| R19 | 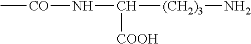 | —OCH₃ | —OCH₃ |
| R20 | 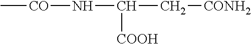 | —OCH₃ | —OCH₃ |
| R21 | 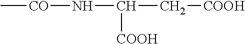 | —OCH₃ | —OCH₃ |
| R22 | 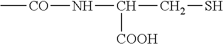 | —OCH₃ | —OCH₃ |
| R23 | 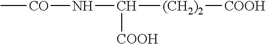 | —OCH₃ | —OCH₃ |
| R24 | 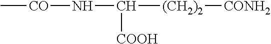 | —OCH₃ | —OCH₃ |
| R25 | —CO—NH—CH₂—COOH | —OCH₃ | —OCH₃ |
| R26 | 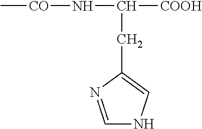 | —OCH₃ | —OCH₃ |
| R27 | 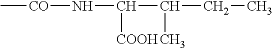 | —OCH₃ | —OCH₃ |
| R28 | 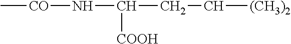 | —OCH₃ | —OCH₃ |
| R29 | 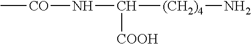 | —OCH₃ | —OCH₃ |
| R30 | 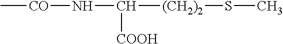 | —OCH₃ | —OCH₃ |
| R31 | 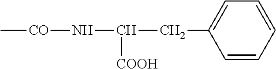 | —OCH₃ | —OCH₃ |
| R32 | 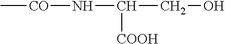 | —OCH₃ | —OCH₃ |
| R33 | 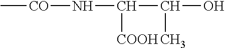 | —OCH₃ | —OCH₃ |
| R34 | 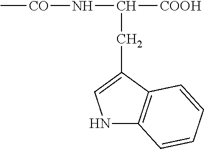 | —OCH₃ | —OCH₃ |
| R35 | 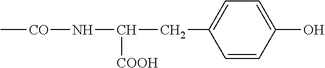 | —OCH₃ | —OCH₃ |
| R36 | 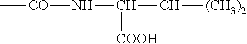 | —OCH₃ | —OCH₃ |
| R37 | —CO—NH—CH₂—CH₂—OCOCH₃ | —OCH₃ | —OCH₃ |
| R38 | 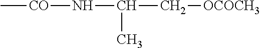 | —OCH₃ | —OCH₃ |
| R39 | 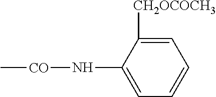 | —OCH₃ | —OCH₃ |
| R40 | —CO—NH—CH₂—CH₂—OH | —OCH₃ | —OCH₃ |
| R41 | 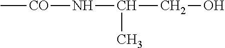 | —OCH₃ | —OCH₃ |
| R42 | 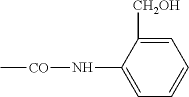 | —OCH₃ | —OCH₃ |
| R43 | 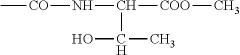 | —OCH₃ | —OCH₃ |
| R44 | 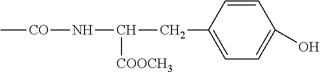 | —OCH₃ | —OCH₃ |
| R45 | —CO—NH—CH₂—COO—CH₃ | —OCH₃ | —OCH₃ |
| R46 | 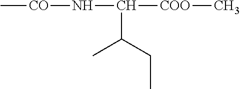 | —OCH₃ | —OCH₃ |
| R47 | 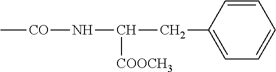 | —OCH₃ | —OCH₃ |
| R48 | 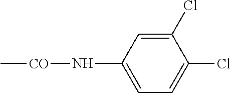 | —OCH₃ | —OCH₃ |
| R49 | —COOCH₃ | 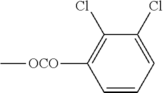 | —OCH₃ |
| R50 | —COOCH₃ | 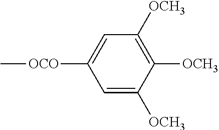 | —OCH₃ |
| R51 | —COOCH₃ | —OCO—CH₂—CH₂—CH₃ | —OCH₃ |
| R52 | —COOCH₃ | 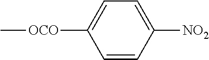 | —OCH₃ |
| R53 | —COOCH₃ | 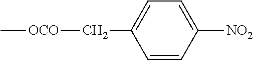 | —OCH₃ |
| R54 | —COOCH₃ | 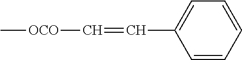 | —OCH₃ |
| R55 | —COOCH₃ | —OCO—CH₂—(CH₂)₉—CH₃ | —OCH₃ |
| R56 | —COOCH₃ | —OCO—CH₂—(CH₂)₁₂—CH₃ | —OCH₃ |
| R57 | —COOCH₃ | 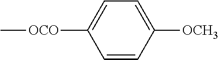 | —OCH₃ |
| R58 | —COOCH₃ | —OCO—CH—(CH₃)₃ | —OCH₃ |
| R59 | —COOCH₃ | 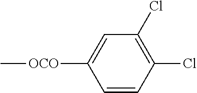 | —OCH₃ |
| R60 | —COOCH₃ | —OCH₃ | 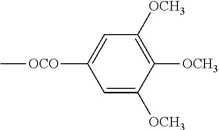 |
| R61 | —COOCH₃ | —OCH₃ | —OCO—CH₂—CH₂—CH₃ |
| R62 | —COOCH₃ | —OCH₃ | 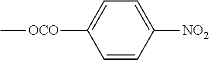 |
| R63 | —COOCH₃ | —OCH₃ | 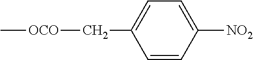 |
| R64 | —COOCH₃ | —OCH₃ | 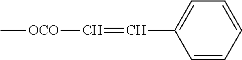 |
| R65 | —COOCH₃ | —OCH₃ | —OCO—CH₂—(CH₂)₉—CH₃ |
| R66 | —COOCH₃ | —OCH₃ | —OCO—CH₂—(CH₂)₁₃—CH₃ |
| R67 | —COOCH₃ | —OCH₃ | 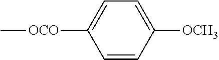 |
| R68 | —COOCH₃ | —OCH₃ | —OCO—CH—(CH₃)₃ |

TABLE 29
representative compounds of formula 4

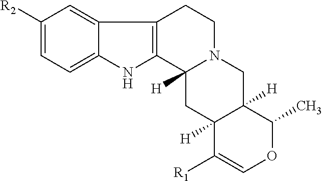

| | R1 | R2 |
|---|---|---|
| 11DR1 | —COOCH₃ | —OH |
| 11DR2 | —COOH | —OH |
| 11DR3 | —COOH | —OCH₃ |
| 11DR4 | 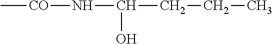 | —OCH₃ |
| 11DR5 | 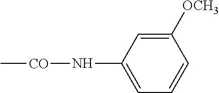 | —OCH₃ |
| 11DR6 | 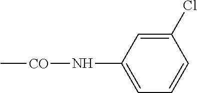 | —OCH₃ |
| 11DR7 | 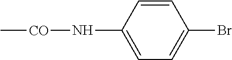 | —OCH₃ |
| 11DR8 | 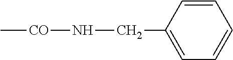 | —OCH₃ |
| 11DR9 | —CO—NH—CH₂—(CH₂)₆—CH₃ | —OCH₃ |
| 11DR10 | —CO—NH—CH₂—CH₂—CH₃ | —OCH₃ |
| 11DR11 | —COO—CH₂—(CH₂)₄—CH₃ | —OCH₃ |
| 11DR12 | 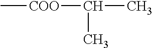 | —OCH₃ |
| 11DR13 | 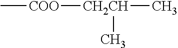 | —OCH₃ |
| 11DR14 | —COO—CH₂—CH₂—CH₂—CH₃ | —OCH₃ |
| 11DR15 | —COO—CH₂—CH₂—CH₂—CH₂—CH₃ | —OCH₃ |
| 11DR16 | —COO—CH—(CH₃)₃ | —OCH₃ |
| 11DR17 | 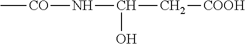 | —OCH₃ |
| 11DR18 | 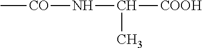 | —OCH₃ |
| 11DR19 | 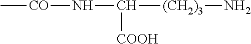 | —OCH₃ |
| 11DR20 | 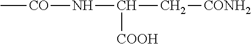 | —OCH₃ |
| 11DR21 | 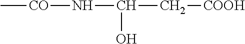 | —OCH₃ |
| 11DR22 | 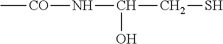 | —OCH₃ |
| 11DR23 | 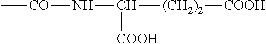 | —OCH₃ |
| 11DR24 | 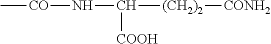 | —OCH₃ |
| 11DR25 | —CO—NH—CH₂—COOH | —OCH₃ |
| 11DR26 | 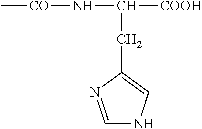 | —OCH₃ |
| 11DR27 | 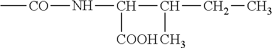 | —OCH₃ |
| 11DR28 | 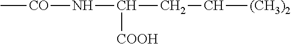 | —OCH₃ |
| 11DR29 | 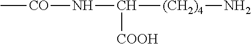 | —OCH₃ |
| 11DR30 | 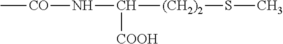 | —OCH₃ |
| 11DR31 | 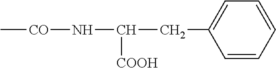 | —OCH₃ |
| 11DR32 | 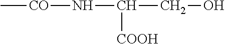 | —OCH₃ |
| 11DR33 | 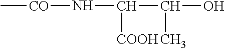 | —OCH₃ |
| 11DR34 | 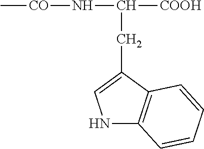 | —OCH₃ |
| 11DR36 | 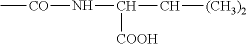 | —OCH₃ |
| 11DR37 | —CO—NH—CH₂—CH₂—OCOCH₃ | —OCH₃ |
| 11DR38 | 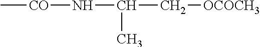 | —OCH₃ |
| 11DR39 | 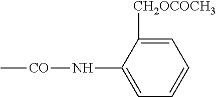 | —OCH₃ |
| 11DR40 | —CO—NH—CH₂—CH₂—OH | —OCH₃ |
| 11DR41 | 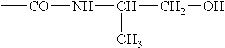 | —OCH₃ |
| 11DR42 | 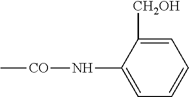 | —OCH₃ |
| 11DR43 | 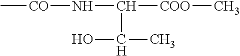 | —OCH₃ |
| 11DR44 | 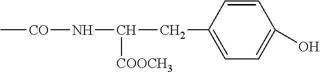 | —OCH₃ |
| 11DR45 | —CO—NH—CH₂—COO—CH₃ | —OCH₃ |
| 11DR46 | 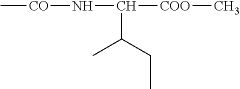 | —OCH₃ |
| 11DR47 | 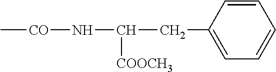 | —OCH₃ |
| 11DR48 | 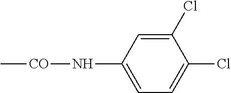 | —OCH₃ |
| 11DR49 | —COOCH₃ | 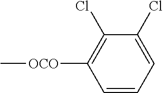 |
| 11DR50 | —COOCH₃ | 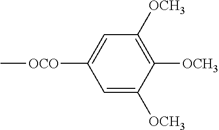 |
| 11DR51 | —COOCH₃ | —OCO—CH₂—CH₂—CH₃ |
| 11DR52 | —COOCH₃ | 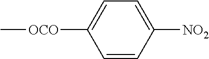 |
| 11DR53 | —COOCH₃ | 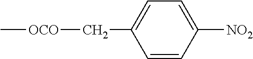 |
| 11DR54 | —COOCH₃ | 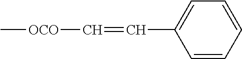 |
| 11DR55 | —COOCH₃ | —OCO—CH₂—(CH₂)₉—CH₃ |
| 11DR56 | —COOCH₃ | —OCO—CH₂—(CH₂)₁₃—CH₃ |
| 11DR57 | —COOCH₃ | 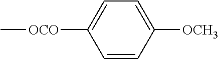 |
| 11DR58 | —COOCH₃ | —OCO—CH—(CH₃)₃ |
| 11DR59 | —COOCH₃ | 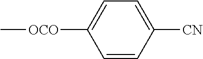 |
| 11DR60 | —COOCH₃ | 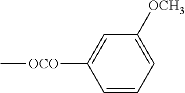 |
| 11DR61 | —COOCH₃ | 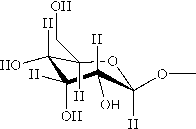 |
| 11DR62 | —COOCH₃ | 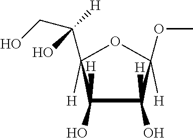 |

TABLE 30
representative compounds of formula 5

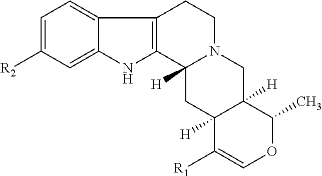

| | R1 | R2 |
|---|---|---|
| 10DR1 | —COOCH₃ | —OH |
| 10DR2 | —COOH | —OH |
| 10DR3 | —COOH | —OCH₃ |
| 10DR4 | 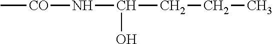 | —OCH₃ |
| 10DR5 | 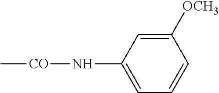 | —OCH₃ |
| 10DR6 | 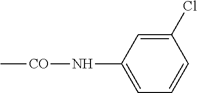 | —OCH₃ |
| 10DR7 | 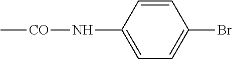 | —OCH₃ |
| 10DR8 | 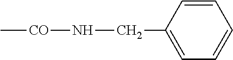 | —OCH₃ |
| 10DR9 | —CO—NH—CH₂—(CH₂)₆—CH₃ | —OCH₃ |
| 10DR10 | —CO—NH—CH₂—CH₂—CH₃ | —OCH₃ |
| 10DR11 | —COO—CH₂—(CH₂)₄—CH₃ | —OCH₃ |
| 10DR12 | 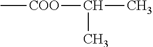 | —OCH₃ |
| 10DR13 | 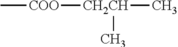 | —OCH₃ |
| 10DR14 | —COO—CH₂—CH₂—CH₂—CH₃ | —OCH₃ |
| 10DR15 | —COO—CH₂—CH₂—CH₂—CH₂—CH₃ | —OCH₃ |
| 10DR16 | —COO—CH—(CH₃)₃ | —OCH₃ |
| 10DR17 | 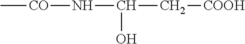 | —OCH₃ |
| 10DR18 | 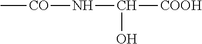 | —OCH₃ |
| 10DR19 | 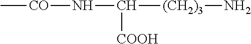 | —OCH₃ |
| 10DR20 | 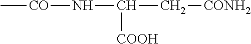 | —OCH₃ |
| 10DR21 | 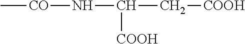 | —OCH₃ |
| 10DR22 | 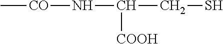 | —OCH₃ |
| 10DR23 | 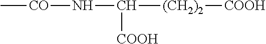 | —OCH₃ |
| 10DR24 | 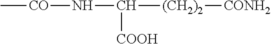 | —OCH₃ |
| 10DR25 | —CO—NH—CH₂—COOH | —OCH₃ |
| 10DR26 | 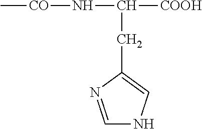 | —OCH₃ |
| 10DR27 | 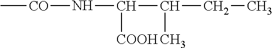 | —OCH₃ |
| 10DR28 | 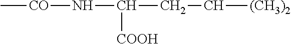 | —OCH₃ |
| 10DR29 | 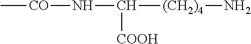 | —OCH₃ |
| 10DR30 | 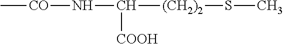 | —OCH₃ |
| 10DR31 | 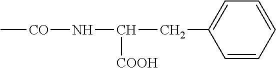 | —OCH₃ |
| 10DR32 | 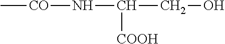 | —OCH₃ |
| 10DR33 | 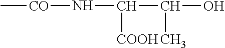 | —OCH₃ |
| 10DR34 | 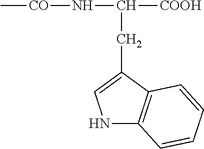 | —OCH₃ |
| 10DR36 | 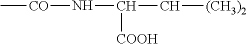 | —OCH₃ |
| 10DR37 | —CO—NH—CH₂—CH₂—OCOCH₃ | —OCH₃ |
| 10DR38 | 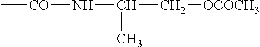 | —OCH₃ |
| 10DR39 | 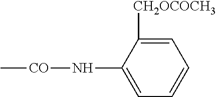 | —OCH₃ |
| 10DR40 | —CO—NH—CH₂—CH₂—OH | —OCH₃ |
| 10DR41 | 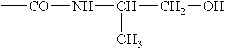 | —OCH₃ |
| 10DR42 | 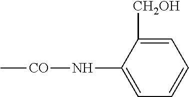 | —OCH₃ |
| 10DR43 | 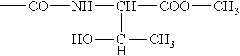 | —OCH₃ |
| 10DR44 | 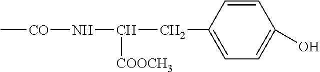 | —OCH₃ |
| 10DR45 | —CO—NH—CH₂—COO—CH₃ | —OCH₃ |
| 10DR46 | 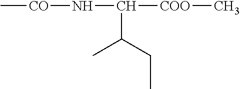 | —OCH₃ |
| 10DR47 | 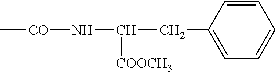 | —OCH₃ |
| 10DR48 | 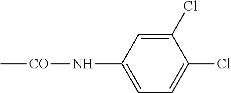 | —OCH₃ |
| 10DR49 | —COOCH₃ | 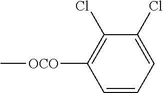 |
| 10DR50 | —COOCH₃ | 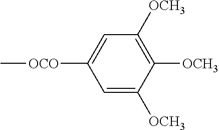 |
| 10DR52 | —COOCH₃ | —OCO—CH₂—CH₂—CH₃ |
| 10DR53 | —COOCH₃ | 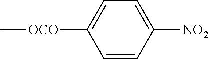 |
| 10DR54 | —COOCH₃ | 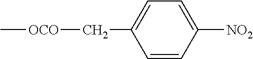 |
| 10DR55 | —COOCH₃ | 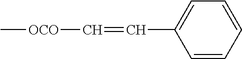 |
| 10DR56 | —COOCH₃ | —OCO—CH₂—(CH₂)₉—CH₃ |
| 10DR57 | —COOCH₃ | —OCO—CH₂—(CH₂)₁₃—CH₃ |
| 10DR58 | —COOCH₃ | 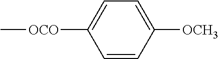 |
| 10DR59 | —COOCH₃ | —OCO—CH—(CH₃)₃ |
| 10DR60 | —COOCH₃ | 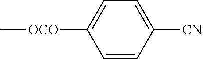 |
| 10DR61 | —COOCH₃ | 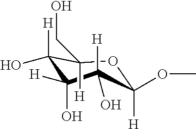 |
| 10DR62 | —COOCH₃ | 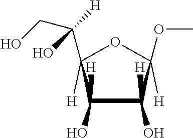 |

TABLE 31
Test data set for antipsychotic compound
Test data set for antipsychotic compound

| | | Pred. log | Exp. |
|---|---|---|---|
| S. No. | Compound Name | IC50 (nM) | IC50 (nM) |
| 1. | Astemizole | −0.897 | −0.05 |
| 2. | Domperidone | 1.124 | 2.21 |
| 3. | Loratadine | 2.188 | 2.24 |
| 4. | Spironolactone | 3.782 | 4.36 |
| 5. | Canrenoic acid | 3.495 | 5.02 |
| 6. | Ketoconazole | 4.043 | 3.28 |

TABLE 32
Predicted logIC50 and IC50 value of isolated
Yohimbane alkaloids and semi-synthetic derivatives
of α-yohimbine by virtual screening model

| Test compounds | Pred log | Pred. |
|---|---|---|
| Name | IC50 (nM) | IC50 (nM) |
| K005 | 5.212 | 162929.60 |
| K002 | 5.263 | 183231.44 |
| K004a | 4.801 | 63241.19 |
| K004b | 4.443 | 27733.20 |
| K006 | 4.096 | 12473.84 |
| K003 | 4.531 | 33962.53 |
| K001 | 3.386 | 2432.20 |
| K001A | 2.773 | 592.93 |
| K001B | 1.901 | 79.62 |
| K001C | 3.834 | 6823.39 |
| K001D | 1.576 | 37.67 |
| K001E | 1.036 | 10.86 |
| K001F | 0.092 | 1.24 |
| K001G | 0.54 | 3.47 |

TABLE 33
Predicted logIC50 and IC50 value of virtual derivatives
of Yohimbane alkaloids by virtual screening model

| Test compounds | Pred log | Pred. |
|---|---|---|
| Name | IC50 (nM) | IC50 (nM) |
| Y1 | 3.748 | 5597.58 |
| Y2 | 2.878 | 755.09 |
| Y3 | 3.062 | 1153.45 |
| Y4 | 0.353 | 2.25 |
| Y5 | 1.876 | 75.16 |
| Y6 | 0.06 | 1.15 |
| Y7 | 0.358 | 2.28 |
| Y8 | 0.553 | 3.57 |
| Y9 | 0.402 | 2.52 |
| Y10 | 2.095 | 124.45 |
| Y11 | 0.208 | 1.61 |
| Y12 | 1.202 | 15.92 |
| Y13 | 1.228 | 16.90 |
| Y14 | 1.635 | 43.15 |
| Y15 | 1.097 | 12.50 |
| Y16 | 0.885 | 7.67 |
| Y17 | −0.012 | 0.97 |
| Y18 | 1.407 | 25.53 |
| Y19 | 0.083 | 1.21 |
| Y20 | −0.043 | 0.91 |
| Y21 | 0.479 | 3.01 |
| Y22 | 1.367 | 23.28 |
| Y23 | 0.094 | 1.24 |
| Y24 | −0.437 | 0.37 |
| Y25 | 1.534 | 34.20 |
| Y26 | −0.41 | 0.39 |
| Y27 | 0.789 | 6.15 |
| Y28 | 0.644 | 4.41 |
| Y29 | −0.208 | 0.62 |
| Y30 | 0.367 | 2.33 |
| Y31 | −0.745 | 0.18 |
| Y32 | 1.818 | 65.77 |
| Y33 | 1.476 | 29.92 |
| Y34 | −1.187 | 0.07 |
| Y35 | −0.696 | 0.20 |
| Y36 | 0.476 | 2.99 |
| Y37 | 0.785 | 6.10 |
| Y38 | 0.708 | 5.11 |
| Y39 | −0.717 | 0.19 |
| Y40 | 1.641 | 43.75 |
| Y41 | 1.612 | 40.93 |
| Y42 | −0.279 | 0.53 |
| Y43 | 1.014 | 10.33 |
| Y44 | −0.751 | 0.18 |
| Y45 | 0.857 | 7.19 |
| Y46 | 0.365 | 2.32 |
| Y47 | 0.057 | 1.14 |
| Y48 | 0.34 | 2.19 |
| Y49 | −0.269 | 0.54 |
| Y50 | 0.998 | 9.95 |
| Y51 | 2.904 | 801.68 |
| Y52 | 3.917 | 8260.38 |
| Y53 | 1.11 | 12.88 |
| Y54 | 0.513 | 3.26 |
| Y55 | −0.376 | 0.42 |
| Y56 | −0.827 | 0.15 |
| Y57 | −1.984 | 0.01 |
| Y58 | 1.985 | 96.61 |
| Y60 | −0.763 | 0.17 |
| Y61 | 4.803 | 63533.09 |
| Y62 | −0.921 | 0.12 |
| Y63 | 1.945 | 88.10 |
| Y64 | 4.539 | 34593.94 |
| Y65 | 0.663 | 4.60 |
| Y66 | −0.4 | 0.40 |
| Y67 | −0.778 | 0.17 |
| Y68 | 4.523 | 33342.64 |
| Y69 | 4.807 | 64120.96 |
| Y70 | −1.002 | 0.10 |
| Y71 | 4.517 | 32885.16 |
| Y72 | −0.861 | 0.14 |
| Y73 | 4.529 | 33806.48 |
| Y74 | 2.814 | 651.63 |
| Y75 | 3.712 | 5152.29 |
| Y76 | 1.878 | 75.51 |
| Y77 | 1.623 | 41.98 |
| Y78 | 1.445 | 27.86 |
| Y79 | 1.161 | 14.49 |
| Y80 | 1.33 | 21.38 |
| Y81 | 0.365 | 2.32 |
| Y82 | 1.923 | 83.75 |
| Y83 | 0.966 | 9.25 |
| Y84 | 0.81 | 6.46 |
| Y85 | 0.797 | 6.27 |
| Y86 | 1.707 | 50.93 |
| Y87 | 1.065 | 11.61 |
| Y88 | 1.191 | 15.52 |
| Y89 | 0.502 | 3.18 |
| Y90 | 0.572 | 3.73 |
| Y93 | 0.502 | 3.18 |
| Y95 | 0.812 | 6.49 |
| Y96 | 2.339 | 218.27 |
| Y97 | 1.78 | 60.26 |
| Y98 | −0.398 | 0.40 |
| Y99 | 1.119 | 13.15 |
| Y100 | 1.492 | 31.05 |
| R1-KOO2 | 3.477 | 2999.16 |
| R2-KOO2 | 5.695 | 495450.19 |
| R4-KOO2 | 2.894 | 783.43 |
| R5-KOO2 | 3.913 | 8184.65 |
| R6-KOO2 | 3.189 | 1545.25 |
| R7-KOO2 | 3.198 | 1577.61 |
| R8-KOO2 | 2.727 | 533.33 |
| R9-KOO2 | 1.658 | 45.50 |
| R10-KOO2 | 3.295 | 1972.42 |
| R11-KOO2 | 2.7 | 501.19 |
| R12-KOO2 | 4.262 | 18281.00 |
| R13-KOO2 | 4.276 | 18879.91 |
| R14-KOO2 | 3.704 | 5058.25 |
| R15-KOO2 | 3.332 | 2147.83 |
| R16-KOO2 | 3.871 | 7430.19 |
| R18-KOO2 | 3.604 | 4017.91 |
| R19-KOO2 | 2.517 | 328.85 |
| R20-KOO2 | 2.733 | 540.75 |
| R21-KOO2 | 2.906 | 805.38 |
| R22-KOO2 | 3.184 | 1527.57 |
| R23-KOO2 | 3.24 | 1737.80 |
| R24-KOO2 | 2.887 | 770.90 |
| R25-KOO2 | 3.854 | 7144.96 |
| R26-KOO2 | 3.713 | 5164.16 |
| R27-KOO2 | 3.087 | 1221.80 |
| R28-KOO2 | 2.905 | 803.53 |
| R29-KOO2 | 2.392 | 246.60 |
| R30-KOO2 | 2.882 | 762.08 |
| R30-KOO2 | 2.882 | 762.08 |
| R31-KOO2 | 1.66 | 45.71 |
| R32-KOO2 | 3.716 | 5199.96 |
| R33-KOO2 | 3.434 | 2716.44 |
| R34-KOO2 | 1.979 | 95.28 |
| R35-KOO2 | 1.844 | 69.82 |
| R36-KOO2 | 3.67 | 4677.35 |
| R37-KOO2 | 3.548 | 3531.83 |
| R38-KOO2 | 2.815 | 653.13 |
| R39-KOO2 | 2.299 | 199.07 |
| R40-KOO2 | 5.259 | 181551.57 |
| R41-KOO2 | 3.948 | 8871.56 |
| R42-KOO2 | 2.582 | 381.94 |
| R43-KOO2 | 4.218 | 16519.62 |
| R44-KOO2 | 7.424 | 26546055.62 |
| R45-KOO2 | 9.458 | 2870780582.02 |
| R47-KOO2 | 5.972 | 937562.01 |
| R48-KOO2 | 3.033 | 1078.95 |
| R49-KOO2 | 3.22 | 1659.59 |
| R50-KOO2 | 25.443 | — |
| R51-KOO2 | 4.441 | 27605.78 |
| R52-KOO2 | 17.384 | — |
| R53-KOO2 | 3.442 | 2766.94 |
| R54-KOO2 | 15.771 | — |
| R55-KOO2 | 1.27 | 18.62 |
| R56-KOO2 | 0.21 | 1.62 |
| R57-KOO2 | 3.968 | 9289.66 |
| R58-KOO2 | 4.543 | 34914.03 |
| R59-KOO2 | 18.704 | — |
| R60-KOO2 | 26.078 | — |
| R61-KOO2 | 4.838 | 68865.23 |
| R62-KOO2 | 4.121 | 13212.96 |
| R63-KOO2 | 3.094 | 1241.65 |
| R64-KOO2 | 15.049 | — |
| R64-KOO2 | 15.049 | — |
| R65-KOO2 | 1.432 | 27.04 |
| R66-KOO2 | 12.075 | — |
| R67-KOO2 | 17.601 | — |
| R68-KOO2 | 4.302 | 20044.72 |
| 11DR1-KOO4a | 3.76 | 5754.40 |
| 11DR2-KOO4a | 4.018 | 10423.17 |
| 11DR3-KOO4a | 4.589 | 38815.04 |
| 11DR4-KOO4a | 2.681 | 479.73 |
| 11DR5-KOO4a | 2.843 | 696.63 |
| 11DR6-KOO4a | 2.575 | 375.84 |
| 11DR7-KOO4a | 2.178 | 150.66 |
| 11DR8-KOO4a | 2.962 | 916.22 |
| 11DR9-KOO4a | 1.515 | 32.73 |
| 11DR10-KOO4a | 3.261 | 1823.90 |
| 11DR11-KOO4a | 2.568 | 369.83 |
| 11DR12-KOO4a | 3.692 | 4920.40 |
| 11DR13-KOO4a | 3.438 | 2741.57 |
| 11DR14-KOO4a | 3.559 | 3622.43 |
| 11DR15-KOO4a | 3.154 | 1425.61 |
| 11DR16-KOO4a | 3.359 | 2285.60 |
| 11DR17-KOO4a | 2.082 | 120.78 |
| 11DR18-KOO4a | 3.465 | 2917.43 |
| 11DR19-KOO4a | 2.125 | 133.35 |
| 11DR20-KOO4a | 2.393 | 247.17 |
| 11DR21-KOO4a | 2.275 | 188.36 |
| 11DR23-KOO4a | 2.219 | 165.58 |
| 11DR24-KOO4a | 2.295 | 197.24 |
| 11DR25-KOO4a | 3.729 | 5357.97 |
| 11DR26-KOO4a | 2.439 | 274.79 |
| 11DR27-KOO4a | 2.469 | 294.44 |
| 11DR28-KOO4a | 2.131 | 135.21 |
| 11DR29-KOO4a | 1.854 | 71.45 |
| 11DR32-KOO4a | 3.377 | 2382.32 |
| 11DR34-KOO4a | 1.58 | 38.02 |
| 11DR35-KOO4a | 1.142 | 13.87 |
| 11DR36-KOO4a | 2.821 | 662.22 |
| 11DR37-KOO4a | 2.715 | 518.80 |
| 11DR38-KOO4a | 3.104 | 1270.57 |
| 11DR39-KOO4a | 1.052 | 11.27 |
| 11DR40-KOO4a | 4.026 | 10616.96 |
| 11DR41cdx-KOO4a | 3.879 | 7568.33 |
| 11DR42-KOO4a | 2.388 | 244.34 |
| 11DR43cdx-KOO4a | 2.895 | 785.24 |
| 11DR44-KOO4a | 0.945 | 8.81 |
| 11DR45-KOO4a | 3.331 | 2142.89 |
| 11DR45-KOO4a | 3.331 | 2142.89 |
| 11DR46-KOO4a | 2.147 | 140.28 |
| 11DR47-KOO4a | 0.838 | 6.89 |
| 11DR48-KOO4a | 1.672 | 46.99 |
| 11DR49-KOO4a | 1.672 | 46.99 |
| 11DR50-KOO4a | 3.297 | 1981.53 |
| 11DR51-KOO4a | 2.482 | 303.39 |
| 11DR52-KOO4a | 1.888 | 77.27 |
| 11DR53-KOO4a | 1.97 | 93.33 |
| 11DR54-KOO4a | 0.633 | 4.30 |
| 11DR55-KOO4a | −0.669 | 0.21 |
| 11DR56-KOO4a | −2.278 | 0.01 |
| 11DR57-KOO4a | 1.898 | 79.07 |
| 11DR58-KOO4a | 2.383 | 241.55 |
| 11DR59-KOO4a | 1.654 | 45.08 |
| 11DR60-KOO4a | 2.208 | 161.44 |
| 11DR61-KOO4a | 5.578 | 378442.58 |
| 11DR62-KOO4a | 5.281 | 190985.33 |
| 10DR3-KOO4b | 4.491 | 30974.19 |
| 10DR4-KOO4b | 2.618 | 414.95 |
| 10DR5-KOO4b | 2.724 | 529.66 |
| 10DR6-KOO4b | 2.582 | 381.94 |
| 10DR7-KOO4b | 2.195 | 156.68 |
| 10DR8-KOO4b | 2.149 | 140.93 |
| 10DR9-KOO4b | 1.148 | 14.06 |
| 10DR10cdx-KOO4b | 3.12 | 1318.26 |
| 10DR11-KOO4b | 2.484 | 304.79 |
| 10DR12-KOO4b | 3.525 | 3349.65 |
| 10DR13-KOO4b | 3.374 | 2365.92 |
| 10DR14-KOO4b | 3.122 | 1324.34 |
| 10DR15-KOO4b | 2.753 | 566.24 |
| 10DR16-KOO4b | 3.509 | 3228.49 |
| 10DR17-KOO4b | 1.972 | 93.76 |
| 10DR18-KOO4b | 3.183 | 1524.05 |
| 10DR19-KOO4b | 1.826 | 66.99 |
| 10DR20-KOO4b | 2.264 | 183.65 |
| 10DR21-KOO4b | 2.456 | 285.76 |
| 10DR22-KOO4b | Failed | — |
| 10DR23-KOO4b | 1.903 | 79.98 |
| 10DR24-KOO4b | 2.072 | 118.03 |
| 10DR25-KOO4b | 3.585 | 3845.92 |
| 10DR26-KOO4b | 2.966 | 924.70 |
| 10DR27-KOO4b | 2.335 | 216.27 |
| 10DR28-KOO4b | 2.104 | 127.06 |
| 10DR29-KOO4b | 2.168 | 147.23 |
| 10DR30-KOO4b | 1.788 | 61.38 |
| 10DR31-KOO4b | 1.364 | 23.12 |
| 10DR32-KOO4b | 3.274 | 1879.32 |
| 10DR33-KOO4b | 3.626 | 4226.69 |
| 10DR34-KOO4b | 1.147 | 14.03 |
| 10DR35-KOO4b | 1.091 | 12.33 |
| 10DR36-KOO4b | 3.174 | 1492.79 |
| 10DR37-KOO4b | 3.207 | 1610.65 |
| 10DR38-KOO4b | 2.388 | 244.34 |
| 10DR39-KOO4b | 1.618 | 41.50 |
| 10DR40-KOO4b | 4.009 | 10209.39 |
| 10DR41cdx-KOO4b | 3.993 | 9840.11 |
| 10DR42-KOO4b | 1.935 | 86.10 |
| 10DR43cdx-KOO4b | 3.161 | 1448.77 |
| 10DR44-KOO4b | 1.053 | 11.30 |
| 10DR45-KOO4b | 3.863 | 7294.58 |
| 10DR46-KOO4b | 2.715 | 518.80 |
| 10DR47-KOO4b | 1.513 | 32.58 |
| 10DR48-KOO4b | 2.341 | 219.28 |
| 10DR49-KOO4b | 0.982 | 9.59 |
| 10DR50-KOO4b | 9.397 | 2494594726.94 |
| 10DR52-KOO4b | 2.083 | 121.06 |
| 10DR53-KOO4b | 2.175 | 149.62 |
| 10DR54-KOO4b | 1.451 | 28.25 |
| 10DR55-KOO4b | 0.571 | 3.72 |
| 10DR56-KOO4b | −0.757 | 0.17 |
| 10DR57-KOO4b | −2.565 | 0.00 |
| 10DR58-KOO4b | 2.024 | 105.68 |
| 10DR59-KOO4b | 2.96 | 912.01 |
| 10DR60-KOO4b | 1.246 | 17.62 |
| 10DR61-KOO4b | 5.725 | 530884.44 |
| 10DR62-KOO4b | 5.718 | 522396.19 |

TABLE 34
Training data set for known anti psychotic drug

| | | | | Atom | Bond | Conformation | Connectiv- | Connectiv- | Connectiv- |
|---|---|---|---|---|---|---|---|---|---|
| | | Exp. | Exp. | Count | Count | Minimum | ity Index | ity Index | ity Index |
| | | IC50 | logIC50 | (all | (all | Energy | (order 0, | (order 1, | (order 2, |
| | Chemical Sample | (nM) | (nM) | atoms) | bonds) | (kcal/mole) | standard) | standard) | standard) |
| | CID 2351 bepridil | 25.7 | 1.41 | 61.00 | 63 | −11.486 | 18.899 | 13.22 | 11.263 |
| | CID 2769_cisapride | 44.67 | 1.65 | 61 | 63 | −157.685 | 23.087 | 15.405 | 13.489 |
| | CID_2771_citalopram | 3981 | 3.6 | 45 | 47 | −2.506 | 17.156 | 11.548 | 10.469 |
| | CID 2995_desipramine | 1380.38 | 3.14 | 42 | 44 | 42.493 | 13.786 | 9.898 | 8.154 |
| | CID 3148 dolasetron | 5884 | 3.77 | 44 | 48 | −77.022 | 16.259 | 11.687 | 11.128 |
| | CID 3168_droperidol | 32.36 | 1.51 | 50 | 53 | −54.58 | 19.51 | 13.614 | 12.208 |
| | CID 3185E 4031 | 18.19 | 1.26 | 55 | 57 | −74.001 | 20.148 | 13.299 | 12.901 |
| | CID 3356 flecainide | 3890.4 | 3.59 | 48 | 49 | −409.699 | 20.786 | 13.034 | 13.36 |
| | CID 3386 Fluoxetine | 5513.5 | 3.741 | 40 | 41 | −149.92 | 16.002 | 10.503 | 9.62 |
| | CID 3510 Granisetron | 3715.3 | 3.57 | 47 | 50 | 13.163 | 15.974 | 11.131 | 10.35 |
| first | CID_3559_Haloperidol | 31.62 | 1.5 | 49 | 51 | −94.323 | 18.571 | 12.46 | 11.482 |
| generation | | | | | | | | | |
| | CID 3696_imipramine | 3388.4 | 3.53 | 45 | 47 | 40.267 | 14.656 | 10.254 | 8.983 |
| | CID 4078 mesoridazine | 316.22 | 2.5 | 52 | 55 | 21.746 | 18.096 | 12.631 | 11.448 |
| | CID_4893_prazosin | 1584.8 | 3.2 | 49 | 52 | −55.482 | 19.673 | 13.601 | 12.019 |
| Second | CID_5002_quetiapine | 5754.3 | 3.76 | 52 | 55 | 2.362 | 18.476 | 13.348 | 11.278 |
| generation | | | | | | | | | |
| Second | CID_5073 risperidone | 147.91 | 2.17 | 57 | 61 | −36.404 | 20.665 | 14.597 | 13.386 |
| generation | | | | | | | | | |
| | CID 5379 gatifloxacin | 128220 | 5.108 | 49 | 52 | 132.373 | 19.292 | 12.918 | 12.139 |
| | CID 5401 terazosin | 17882 | 4.252 | 53 | 56 | −103.21 | 19.673 | 13.601 | 12.019 |
| first | CID 5452_thioridazine | 33.11 | 1.52 | 51 | 54 | 43.813 | 17.225 | 12.258 | 10.718 |
| generation | | | | | | | | | |
| | CID 5663 vesnarinone | 1047.1 | 3.02 | 54 | 57 | −105.129 | 20.38 | 14.084 | 12.455 |
| | CID 40692 Mefloquine | 5623.4 | 3.75 | 42 | 44 | 317.643 | 19.113 | 12.087 | 12.687 |
| | CID 60404 sparfloxacin | 17882.7 | 4.252 | 50 | 53 | −144.414 | 20.326 | 13.201 | 12.991 |
| Second | CID_60854_ziprasidone | 125.89 | 2.1 | 49 | 53 | 17.859 | 19.087 | 13.67 | 12.613 |
| generation | | | | | | | | | |
| | CID 123018 norastemizole | 27.54 | 1.44 | 45 | 48 | 22.075 | 16.355 | 11.793 | 10.469 |
| | CID 129211 tamsulosin | 104710 | 5.02 | 56 | 57 | −138.227 | 20.571 | 13.346 | 12.039 |
| | CID 149096 levofloxacin | 912010 | 5.96 | 46 | 49 | −157.466 | 18.585 | 12.38 | 11.937 |
| | CID 152946 moxifloxacin | 128820 | 5.11 | 53 | 57 | −133.613 | 20.284 | 13.99 | 13.144 |
| | CID 446220 cocaine | 7244.3 | 3.86 | 43 | 45 | −136.937 | 15.69 | 10.613 | 9.43 |
| Second | CID_450907_clozapine | 131820 | 5.12 | 42 | 45 | 88.832 | 15.811 | 11.204 | 10.302 |
| generation | | | | | | | | | |
| | CID_6604102_doxazosin | 588.84 | 2.77 | 58 | 62 | −96.578 | 22.949 | 16.067 | 14.352 |

| | | Dipole | Dipole | Dipole | Dipole | Electron | Dielectric | Steric |
|---|---|---|---|---|---|---|---|---|
| | | Moment | Vector X | Vector Y | Vector Z | Affinity | Energy | Energy |
| | Chemical Sample | (debye) | (debye) | (debye) | (debye) | (eV) | (kcal/mole) | (kcal/mole) |
| | CID 2351 bepridil | 1.144 | 1.106 | −0.203 | 0.032 | −0.166 | 0.234 | 64.463 |
| | CID 2769_cisapride | 3.244 | 2.437 | −1.014 | 1.896 | 0.146 | −0.798 | 39.365 |
| | CID_2771_citalopram | 3.038 | −1.088 | 2.514 | 1.345 | 0.859 | −0.483 | 36.916 |
| | CID 2995_desipramine | 1.05 | 0.269 | −1.005 | 0.143 | −0.288 | −0.253 | 44.619 |
| | CID 3148 dolasetron | 5.333 | −0.84 | 4.863 | −2.032 | 0.333 | −0.798 | 56.126 |
| | CID 3168_droperidol | 1.195 | 0.655 | 1.017 | −0.177 | 0.731 | −0.694 | 30.825 |
| | CID 3185E 4031 | 5.517 | −2.955 | −0.914 | −4.406 | 0.738 | −1.27 | 61.056 |
| | CID 3356 flecainide | 4.224 | −3.212 | −0.308 | −2.666 | 0.778 | −0.721 | 48.491 |
| | CID 3386 Fluoxetine | 3.202 | 0.39 | −1.363 | 2.787 | 0.372 | −0.299 | 22.929 |
| | CID 3510 Granisetron | 4.413 | −1.82 | −2.638 | 3.036 | 0.658 | −0.51 | 59.522 |
| first | CID_3559_Haloperidol | 3.392 | −0.24 | 3.08 | −1.456 | 0.706 | −0.528 | 23.252 |
| generation | | | | | | | | |
| | CID 3696_imipramine | 1.086 | −0.885 | 0.014 | −0.651 | −0.295 | −0.244 | 51.566 |
| | CID 4078 mesoridazine | 1.475 | −0.354 | 0.039 | 1.471 | 0.688 | −0.718 | 63.033 |
| | CID_4893_prazosin | 5.87 | 2.471 | −1.088 | 3.384 | 0.779 | −0.856 | 6.941 |
| Second | CID_5002_quetiapine | 1.466 | −0.19 | 1.235 | 0.674 | 0.708 | −0.49 | 90.114 |
| generation | | | | | | | | |
| Second | CID_5073 risperidone | 5.572 | 0.918 | 1.352 | −5.329 | 0.857 | −0.763 | 36.796 |
| generation | | | | | | | | |
| | CID 5379 gatifloxacin | 5.349 | −0.009 | −2.568 | 4.965 | 1.003 | −0.921 | 92.125 |
| | CID 5401 terazosin | 5.075 | −1.236 | 4.705 | 0.842 | 0.78 | −0.817 | 6.829 |
| first | CID 5452_thioridazine | 3.091 | 1.511 | −1.671 | 1.798 | 0.418 | −0.395 | 63.155 |
| generation | | | | | | | | |
| | CID 5663 vesnarinone | 3.376 | −0.578 | −2.126 | 2.571 | 0.262 | −0.842 | 34.734 |
| | CID 40692 Mefloquine | 7.079 | 7.079 | −0.176 | 0.008 | 1.891 | −0.53 | 70.831 |
| | CID 60404 sparfloxacin | 5.767 | 2.786 | 4.501 | 2.349 | 0.813 | −0.875 | 87.331 |
| Second | CID_60854_ziprasidone | 3.542 | 0.989 | −2.805 | 1.875 | 0.787 | −0.686 | 72.375 |
| generation | | | | | | | | |
| | CID 123018 norastemizole | 1.768 | −1.145 | −1.296 | −0.393 | 0.49 | −0.538 | −7.979 |
| | CID 129211 tamsulosin | 6.579 | 6.326 | −0.074 | −0.553 | 0.602 | −1.235 | 41.895 |
| | CID 149096 levofloxacin | 7.629 | 5.451 | 2.582 | −3.314 | 0.776 | 1.03 | 78.148 |
| | CID 152946 moxifloxacin | 6.024 | −3.166 | 1.283 | −5.836 | 0.858 | −0.822 | 81.531 |
| | CID 446220 cocaine | 1.678 | 0.826 | −1.481 | −0.327 | 0.383 | −0.497 | 37.521 |
| Second | CID_450907_clozapine | 2.432 | −2.249 | 0.54 | −0.669 | 1.181 | −0.381 | 95.173 |
| generation | | | | | | | | |
| | CID_6604102_doxazosin | 4.263 | 1.954 | 2.178 | 1.266 | 0.782 | −0.849 | 17.986 |

| | | | | | Group | | | | |
|---|---|---|---|---|---|---|---|---|---|
| | | Total | Group | Group | Count | Group | Group | Group | Group |
| | | Energy | Count | Count | (sec- | Count | Count | Count | Count |
| | Chemical Sample | (Hartroe) | (amide) | (amine) | amine) | (carbonyl) | (ether) | (hydroxyl) | (methyl) |
| | CID_2351_bepridil | −189.05 | 0 | 0 | 0 | 0 | 1 | 0 | 2 |
| | CID_2769_cisapride | −253.823 | 1 | 1 | 1 | 0 | 3 | 0 | 2 |
| | CID_2771_citalopram | −172.667 | 0 | 0 | 0 | 0 | 1 | 0 | 2 |
| | CID_2995_desipramine | −134.069 | 0 | 0 | 1 | 0 | 0 | 0 | 1 |
| | CID_3148_dolasetron | −174.767 | 0 | 0 | 1 | 1 | 0 | 0 | 0 |
| | CID_3168_droperidol | −205.407 | 1 | 0 | 1 | 1 | 0 | 0 | 0 |
| | CID_3185E-4031 | −208.972 | 0 | 0 | 1 | 1 | 0 | 0 | 2 |
| | CID_3356_flecainide | −263.835 | 1 | 0 | 2 | 0 | 2 | 0 | 0 |
| | CID_3386_Fluoxetine | −178.863 | 0 | 0 | 1 | 0 | 1 | 0 | 1 |
| | CID_3510_Granisetron | −165.181 | 1 | 0 | 1 | 0 | 0 | 0 | 2 |
| first | CID_3559_Haloperidol | −196.262 | 0 | 0 | 0 | 1 | 0 | 1 | 0 |
| generation | | | | | | | | | |
| | CID_3696_imipramine | −141.195 | 0 | 0 | 0 | 0 | 0 | 0 | 2 |
| | CID_4078 mesoridazine | −184.673 | 0 | 0 | 0 | 0 | 0 | 0 | 2 |
| | CID_4893_ prazosin | −212.954 | 0 | 1 | 0 | 0 | 3 | 0 | 2 |
| Second | CID_5002_quetiapine | −195.115 | 0 | 0 | 0 | 0 | 1 | 1 | 0 |
| generation | | | | | | | | | |
| Second | CID_5073 risperidone | −223.915 | 0 | 0 | 0 | 0 | 0 | 0 | 1 |
| generation | | | | | | | | | |
| | CID_5379_gatifloxacin | −213.552 | 0 | 0 | 1 | 1 | 1 | 0 | 2 |
| | CID_5401_ terazosin | −216.509 | 0 | 1 | 0 | 0 | 3 | 0 | 2 |
| first | CID_5452 thioridazine | −172.527 | 0 | 0 | 0 | 0 | 0 | 0 | 2 |
| generation | | | | | | | | | |
| | CID_5663 vesnarinone | −215.742 | 1 | 0 | 1 | 0 | 2 | 0 | 2 |
| | CID_40692_Mefloquine | −236.274 | 0 | 0 | 1 | 0 | 0 | 1 | 0 |
| | CID_60464 sparfloxacin | −226.743 | 0 | 1 | 1 | 1 | 0 | 0 | 2 |
| Second | CID_60854_ziprasidone | −200.906 | 1 | 0 | 1 | 0 | 0 | 0 | 0 |
| generation | | | | | | | | | |
| | CID_123618 norastemizole | −172.629 | 0 | 0 | 2 | 0 | 0 | 0 | 0 |
| | CID_129211 tamsulosin | −220.227 | 0 | 1 | 1 | 0 | 3 | 0 | 3 |
| | CID_149096_levofloxacin | −206.513 | 0 | 0 | 0 | 1 | 1 | 0 | 2 |
| | CID_152946_moxifloxacin | −226.448 | 0 | 0 | 1 | 1 | 1 | 0 | 1 |
| | CID_446220_cocaine | −167.839 | 0 | 0 | 0 | 0 | 0 | 0 | 2 |
| Second | CID_450907_clozapine | −161.2 | 0 | 0 | 1 | 0 | 0 | 0 | 1 |
| generation | | | | | | | | | |
| | CID_6604102_doxazosin | −250.585 | 0 | 1 | 0 | 0 | 4 | 0 | 2 |

| | | | | | | | Lambda | Lambda |
|---|---|---|---|---|---|---|---|---|
| | | Group | Heat of | HOMO | Ionization | Ionization | Max UV- | Max far-UV- |
| | | Count | Formation | Energy | Potential | Potential | Visible | Visible |
| | Chemical Sample | (sulfide) | (kcal/mole) | (eV) | (eV) | (eV) | (nm) | (nm) |
| | CID_2351_bepridil | 0 | −13.706 | −8.325 | 8.32 | 8.319 | 192.181 | 192.187 |
| | CID_2769_cisapride | 0 | −157.8 | −8.732 | 8.734 | 8.733 | 202.855 | 202.921 |
| | CID_2771_citalopram | 0 | −2.471 | −9.191 | 9.192 | 9.193 | 195.756 | 195.747 |
| | CID_2995_desipramine | 0 | 42.572 | −8.422 | 8.423 | 8.424 | 200.026 | 200.071 |
| | CID_3148_dolasetron | 0 | −77.125 | −8.741 | 8.741 | 8.741 | 212.783 | 212.792 |
| | CID_3168_droperidol | 0 | −54.68 | −8.568 | 8.568 | 8.568 | 196.757 | 196.766 |
| | CID_3185E-4031 | 0 | −74.029 | −9.058 | 9.06 | 9.062 | 201.184 | 201.2 |
| | CID_3356_flecainide | 0 | −411.507 | −9.604 | 9.604 | 9.604 | 193.056 | 193.112 |
| | CID_3386_Fluoxetine | 0 | −149.934 | −9.381 | 9.38 | 9.383 | 190.881 | 222.799 |
| | CID_3510_Granisetron | 0 | 12.997 | −8.925 | 8.914 | 8.917 | 217.619 | 217.573 |
| first | CID_3559_Haloperidol | 0 | −94.321 | −9.229 | 9.229 | 9.23 | 196.526 | 196.424 |
| generation | | | | | | | | |
| | CID_3696_imipramine | 0 | 40.25 | −8.402 | 8.417 | 8.418 | 199.954 | 200.048 |
| | CID_4078 mesoridazine | 1 | 18.658 | −7.992 | 7.991 | 7.994 | 235.722 | 235.709 |
| | CID_4893_ prazosin | 0 | −58.424 | −8.512 | 8.495 | 8.51 | 239.511 | 239.584 |
| Second | CID_5002_quetiapine | 1 | 2.072 | −8.633 | 8.63 | 8.633 | 211.893 | 211.871 |
| generation | | | | | | | | |
| Second | CID_5073 risperidone | 0 | −35.875 | −9.065 | 9.064 | 9.064 | 201.447 | 201.449 |
| generation | | | | | | | | |
| | CID_5379_gatifloxacin | 0 | −132.594 | −8.937 | 8.937 | 8.937 | 244.657 | 244.892 |
| | CID_5401_ terazosin | 0 | −103.064 | −8.321 | 8.327 | 8.324 | 240.998 | 240.894 |
| first | CID_5452 thioridazine | 2 | 46.388 | −7.827 | 7.828 | 7.826 | 238.346 | 238.385 |
| generation | | | | | | | | |
| | CID_5663 vesnarinone | 0 | −105.635 | −8.368 | 8.369 | 8.369 | 201.952 | 201.955 |
| | CID_40692_Mefloquine | 0 | −317.644 | −9.573 | 9.573 | 9.573 | 217.075 | 217.093 |
| | CID_60464 sparfloxacin | 0 | −144.461 | −8.572 | 8.572 | 8.572 | 280.525 | 280.662 |
| Second | CID_60854_ziprasidone | 1 | 17.583 | −8.613 | 8.614 | 8.615 | 196.916 | 196.914 |
| generation | | | | | | | | |
| | CID_123618 norastemizole | 0 | 21.256 | −8.595 | 8.594 | 8.595 | 205.653 | 205.675 |
| | CID_129211 tamsulosin | 0 | −136.409 | −8.766 | 8.766 | 8.764 | 194.077 | 194.065 |
| | CID_149096_levofloxacin | 0 | −157.384 | −8.721 | 8.721 | 8.721 | 274.685 | 274.561 |
| | CID_152946_moxifloxacin | 0 | −134.15 | −8.882 | 8.877 | 8.872 | 269.73 | 270.165 |
| | CID_446220_cocaine | 0 | −137.468 | −9.433 | 9.434 | 9.434 | 192.294 | 192.405 |
| Second | CID_450907_clozapine | 0 | 88.836 | −8.08 | 8.08 | 8.076 | 225.962 | 226.004 |
| generation | | | | | | | | |
| | CID_6604102_doxazosin | 0 | −96.755 | −8.561 | 8.561 | 8.561 | 193.3 | 193.308 |

| | | | LUMO | | | Ring | Size of | Size of |
|---|---|---|---|---|---|---|---|---|
| | | | Energy | Molar | Molecular | Count | Smallest | Largest |
| | Chemical Sample | Log P | (eV) | Refractivity | Weight | (all rings) | Ring | Ring |
| | CID_2351_bepridil | 5.512 | 0.229 | 115.116 | 366.545 | 3 | 5 | 6 |
| | CID_2769_cisapride | 2.246 | −0.136 | 122.437 | 465.951 | 3 | 6 | 6 |
| | CID_2771_citalopram | 3.76 | −0.855 | 93.835 | 324.397 | 3 | 5 | 6 |
| | CID_2995_desipramine | 3.645 | 0.284 | 85.311 | 266.385 | 3 | 6 | 7 |
| | CID_3148_dolasetron | 1.511 | −0.335 | 88.868 | 324.379 | 6 | 5 | 6 |
| | CID_3168_droperidol | 1.498 | −0.738 | 107.586 | 379.433 | 4 | 5 | 6 |
| | CID_3185E-4031 | 2.063 | −0.735 | 111.09 | 401.523 | 3 | 6 | 6 |
| | CID_3356_flecainide | 2.981 | −0.775 | 87.898 | 414.347 | 2 | 6 | 6 |
| | CID_3386_Fluoxetine | 4.194 | −0.371 | 80.368 | 309.331 | 2 | 6 | 6 |
| | CID_3510_Granisetron | 1.705 | −0.665 | 91.008 | 312.414 | 4 | 5 | 6 |
| first | CID_3559_Haloperidol | 3.378 | −0.708 | 102.592 | 375.87 | 3 | 6 | 6 |
| generation | | | | | | | | |
| | CID_3696_imipramine | 4.006 | 0.296 | 90.606 | 280.412 | 3 | 6 | 7 |
| | CID_4078_mesopridazine | 3.048 | −0.688 | 115.041 | 386.569 | 4 | 6 | 6 |
| | CID_4893_ prazosin | 1.498 | −0.761 | 102.974 | 383.406 | 4 | 5 | 6 |
| Second | CID_5002_quetiapine | 3.056 | −0.709 | 113.801 | 383.507 | 4 | 6 | 7 |
| generation | | | | | | | | |
| Second | CID_5073 risperidone | 1.65 | −0.849 | 116.156 | 410.49 | 5 | 5 | 6 |
| generation | | | | | | | | |
| | CID_5379_gatifloxacin | 1.299 | −1.001 | 97.997 | 375.399 | 4 | 3 | 6 |
| | CID_5401_ terazosin | 1.017 | −0.669 | 105.176 | 387.438 | 4 | 5 | 6 |
| first | CID_5452 thioridazine | 4.185 | −0.42 | 113.669 | 370.57 | 4 | 6 | 6 |
| generation | | | | | | | | |
| | CID_5663 vesnarinone | 1.867 | −0.334 | 110.254 | 395.457 | 4 | 6 | 6 |
| | CID_40692_Mefloquine | 4.246 | −1.891 | 82.577 | 378.317 | 3 | 6 | 6 |
| | CID_60464 sparfloxacin | 1.321 | −0.812 | 100.868 | 392.405 | 4 | 3 | 6 |
| Second | CID_60854_ziprasidone | 3.444 | −0.788 | 116.906 | 412.936 | 5 | 5 | 6 |
| generation | | | | | | | | |
| | CID_123618 norastemizole | 3.179 | −0.486 | 94.518 | 324.4 | 4 | 5 | 6 |
| | CID_129211 tamsulosin | 2.21 | −0.604 | 108.863 | 408.512 | 2 | 6 | 6 |
| | CID_149096_levofloxacin | 1.087 | −0.778 | 94.112 | 361.372 | 4 | 6 | 6 |
| | CID_152946_moxifloxacin | 1.422 | −0.858 | 105.4 | 401.437 | 5 | 3 | 6 |
| | CID_446220_cocaine | 1.925 | −0.314 | 80.662 | 303.357 | 3 | 5 | 6 |
| Second | CID_450907_clozapine | 3.582 | −1.182 | 96.773 | 326.828 | 4 | 6 | 7 |
| generation | | | | | | | | |
| | CID_6604102_doxazosin | 2.042 | −0.784 | 121.638 | 451.481 | 5 | 6 | 6 |

| | | | | | | Predicted Log |
|---|---|---|---|---|---|---|
| | | | | | | IC50 (nm) (C) = |
| | | | | | | −0.124236*M + |
| | | | | | | 0.0305374*P + |
| | | | | | | 1.0651*V − |
| | | Shape | Shape | Shape | Solvent | 0.0639271*AH − |
| | | Index | Index | Index | Accessibility | 0.380434*AO + |
| | | (basic | (basic | (basic | Surface Area | 9.12642 rCV\hat{ }2 = |
| | | kappa, | kappa, | kappa, | (angstrom- | 0.807357 r\hat{ }2 = |
| | Chemical Sample | order 1) | order 2) | order 3) | square) | 0.874903 |
| | CID_2351_bepridil | 21.703 | 11.87 | 7.396 | 392.105 | 1.983 |
| | CID_2769_cisapride | 26.602 | 13.185 | 7.759 | 484.148 | 2.51 |
| | CID_2771_citalopram | 18.781 | 8.131 | 4.066 | 357.47 | 3.607 |
| | CID_2995_desipramine | 14.917 | 7.32 | 3.442 | 308.272 | 3.708 |
| | CID_3148_dolasetron | 16.194 | 6.311 | 2.823 | 330.621 | 4.338 |
| | CID_3168_droperidol | 21.24 | 9.871 | 5.202 | 398.056 | 1.233 |
| | CID_3185E-4031 | 22.68 | 10.347 | 7.335 | 420.652 | 1.646 |
| | CID_3356_flecainide | 24.271 | 10.858 | 9.58 | 376.177 | 3.805 |
| | CID_3386_Fluoxetine | 18.34 | 8.741 | 5.864 | 333.528 | 3.177 |
| | CID_3510_Granisetron | 16.467 | 6.719 | 3.133 | 340.013 | 3.557 |
| first | CID_3559_Haloperidol | 20.727 | 9.467 | 5.75 | 393.948 | 1.271 |
| generation | | | | | | |
| | CID_3696_imipramine | 15.879 | 7.513 | 3.855 | 325.247 | 3.523 |
| | CID_4078_mesopridazine | 19.322 | 8.566 | 4.224 | 382.602 | 1.907 |
| | CID_4893_ prazosin | 21.24 | 9.428 | 4.542 | 391.721 | 3.803 |
| Second | CID_5002_quetiapine | 20.28 | 10.156 | 5.136 | 400.796 | 3.631 |
| generation | | | | | | |
| Second | CID_5073 risperidone | 21.825 | 9.469 | 4.578 | 425.463 | 1.745 |
| generation | | | | | | |
| | CID_5379_gatifloxacin | 20.28 | 8.025 | 3.545 | 366.156 | 4.775 |
| | CID_5401_ terazosin | 21.24 | 9.428 | 4.542 | 402.588 | 3.974 |
| first | CID_5452 thioridazine | 18.367 | 8.347 | 3.984 | 360.78 | 2.05 |
| generation | | | | | | |
| | CID_5663 vesnarinone | 22.203 | 10.08 | 5.087 | 410.79 | 3.014 |
| | CID_40692_Mefloquine | 20.727 | 7.788 | 4.543 | 332.742 | 4.281 |
| | CID_60464 sparfloxacin | 21.24 | 7.922 | 3.55 | 369.708 | 4.286 |
| Second | CID_60854_ziprasidone | 19.934 | 8.626 | 4.258 | 404.49 | 2.01 |
| generation | | | | | | |
| | CID_123618 norastemizole | 17.416 | 8.131 | 4.233 | 341.837 | 1.279 |
| | CID_129211 tamsulosin | 24.271 | 12 | 7.987 | 444.184 | 3.672 |
| | CID_149096_levofloxacin | 19.322 | 7.438 | 3.338 | 345.307 | 5.703 |
| | CID_152946_moxifloxacin | 20.878 | 8.165 | 3.457 | 377.353 | 5.353 |
| | CID_446220_cocaine | 16.844 | 7.266 | 3.44 | 317.583 | 3.847 |
| Second | CID_450907_clozapine | 16.467 | 7.087 | 3.52 | 327.498 | 4.59 |
| generation | | | | | | |
| | CID_6604102_doxazosin | 24.684 | 10.948 | 5.259 | 452.689 | 2.903 |

### ADVANTAGES OF THE INVENTION

1. The main advantage of our virtual screening model is that compounds are screened very fast thus readily providing hits for in-vitro screening.

2. The other major advantage of our model is that it avoids unnecessary animal scarifies in animal testing for drug discovery hence; it is the need of hour to switch to virtual screening.

2. The other major advantage of our model is that it will reduce many fold cost and duration of antipsychotic drug discovery.

3. The other advantage of our model is that virtual molecules can be easily, economically synthesized in less time.

4. It may provide structural novelty.

5. Apart from saving animal life, cost, and time this is very fast, reliable, statistically validated and has become one of the essential component of antipsychotic drug discovery.

6. This virtual screening model for prediction of antipsychotic activity may be of immense advantage in understanding action mechanism and directing the molecular design of lead compound with improved anti-psychotic activity.

7. The other advantage will be that we can update the present virtual screening model for better predicting accuracy of antipsychotic agents.

We claim:

1. A computer aided method for predicting and modeling anti-psychotic activity of a test compound wherein the said method comprising:
i. validating training set descriptors comprising chemical and structural information of the known antipsychotic drugs/compounds through quantitative structure activity relationship (QSAR) model using the equation: Predicted log IC50 (nM)=−0.124236×M+0.0305374×P+1.0651×V−0.0639271×AH−0.380434×AO+9.12642 wherein, M=Dipole Vector Z (debye), P=Steric Energy (kcal/mole), V=Group Count (ether) (V), AH=Molar Refractivity and AO=Shape Index (basic kappa, order 3) in a computational modeling system;
ii. providing training set descriptors comprising chemical and structural information of the training set compounds and experimental antipsychotic activity against selective antipsychotic targets to the computational modeling system of step (i) and obtaining virtual antipsychotic activity value (Log IC₅₀) of the test compounds;
iii. performing molecular docking studies of the test compound exhibiting anti psychotic activity as evaluated in step (ii) against antipsychotic targets using the computational modeling system of step (i);
iv. evaluating toxicity risk and physicochemical properties of the test compounds as evaluated in step (ii) using the computational modeling system of step (i).
v. evaluating oral bioavailability, absorption, distribution, metabolism and excretion (ADME) values of the untested (unknown) compounds evaluated in step (ii) using the computational modeling system of step (i) for drug likeness;
vi. outputting the values obtained in step (ii) to (v) to a computer recordable medium to predict anti-psychotically active test compound.

2. The method as claimed in claim 1, wherein the test compounds are selected from the group consisting of formula 1, formula 2, formula 3, formula 4 or formula 5 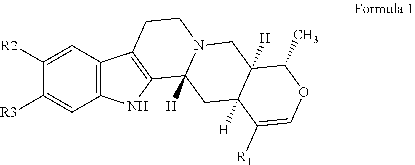
wherein R1 in formula 1=COOCH3(methyl ester);
R2 in formula 1 is selected from the group consisting of H, OH, OCH3, OCH2CH2CH3, 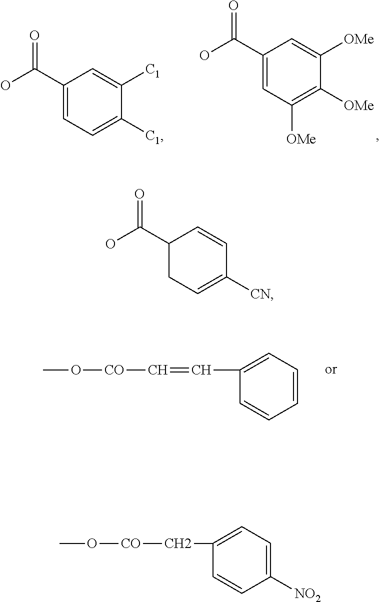
R3 in formula 1 is selected from the group consisting of H, OCO(CH2)10CH3, OCO(CH2)14CH3, OCO(CH)(CH3)3, 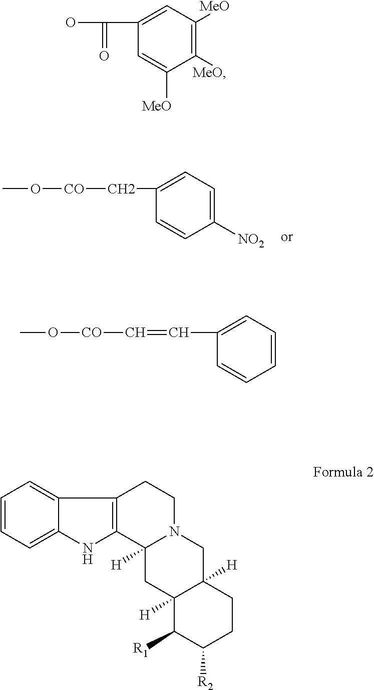
Wherein R₁ in formula 2 is selected from the group consisting of
—COOH, —COO—CH₃, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH —CO—NH—CH₂—CH₂—OCOCH₃, —CO—NH—CH₂—CH₂—OH, —CO—NH—CH₂—COO—CH₃, —CONH—CH₂—COO—CH₃, —CONH—CH₂—COOH, —CONH—CH₂—CH₂—OCOCH₃, —CONH—CH₂—CH₂—OH, 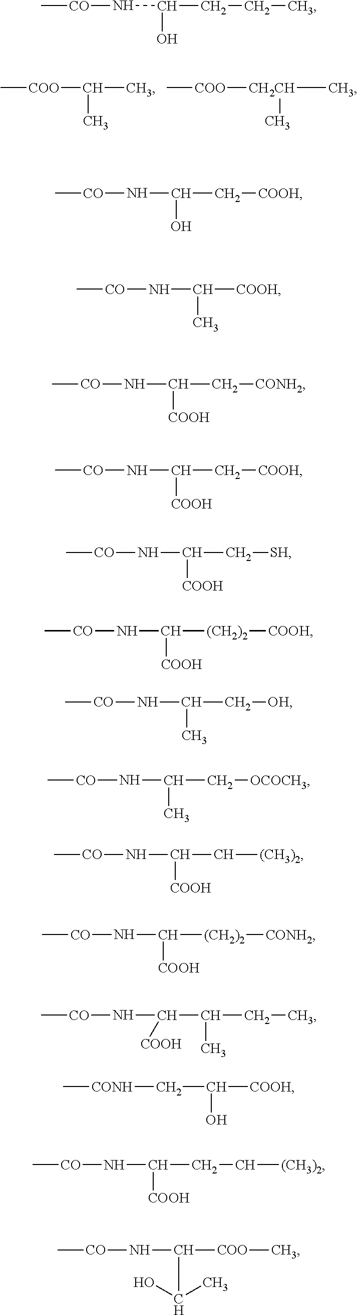 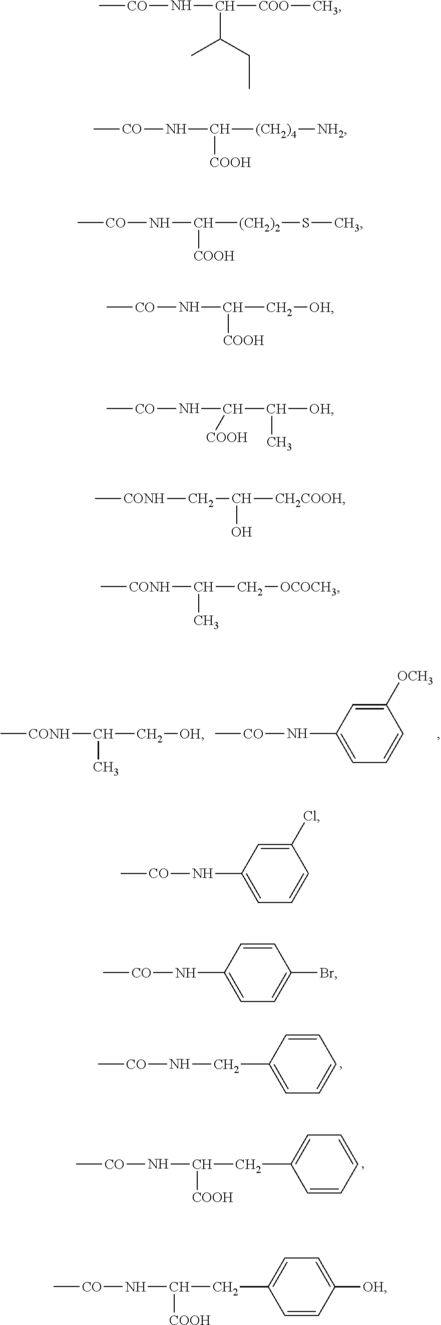 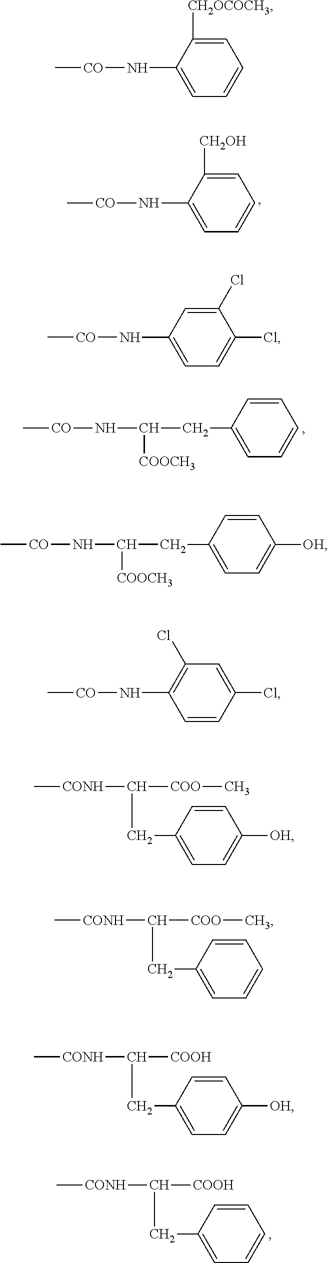 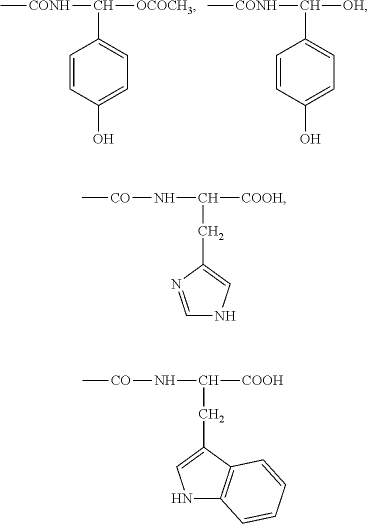
R₂ in formula 2 is selected from the group consisting of
—OH, —OCOCH₃—OCOCH₂CH₃, —O—CH₂—CH₂—CO—Cl, —OCO—CH₂—(CH₂)₉—CH₃, —OCO—CH₂—(CH₂)₁₃—CH₃, —OCO—CH—(CH₃)₃, —OCO—COO—CH₂—CH₃, —OCO—CO—OH, —OCO—CH₂—CH₂—CH₂—CH₃, —OCO—CH₂—CH₂—CH₂—CH₂—CH₃, —OCO—CH₂—CH₂—CH₂—COOH, —OCO—CH₂—CH₂—CH₂—CH₂—NH₂, —OCO—CH₂—CH₂—SH, —OCO—CH₂—CH₂—COOH, —OCO—CH₂—CH₂—CONH₂, —OCO—CH₂—(CH₂)₄—NH₂, —OCO—CH₂—CH₂—CH₂—S—CH₃, 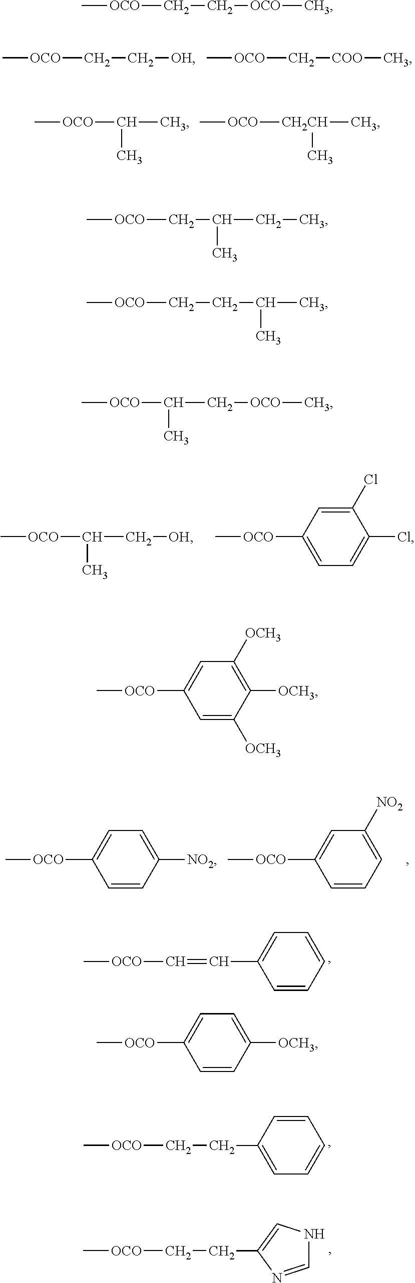 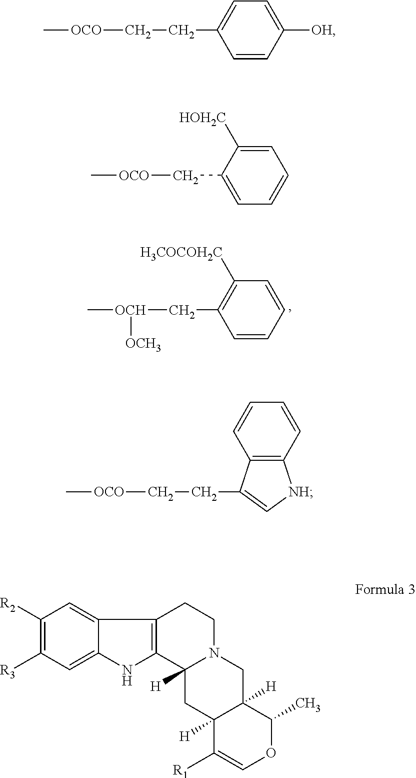
Wherein R₁ in formula 3 is selected from the group consisting of
—COOCH₃, —COOH, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH, —CO—NH—CH₂—CH₂—OCOCH₃—CO—NH—CH₂—CH₂—OH, —CO—NH—CH₂—COO—CH₃, 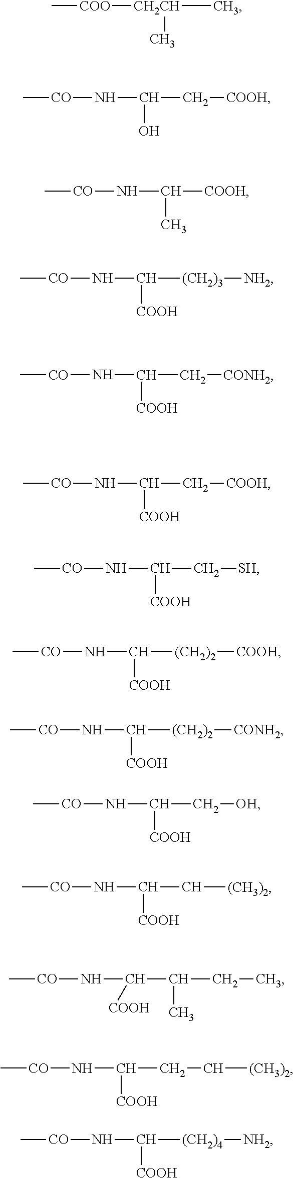 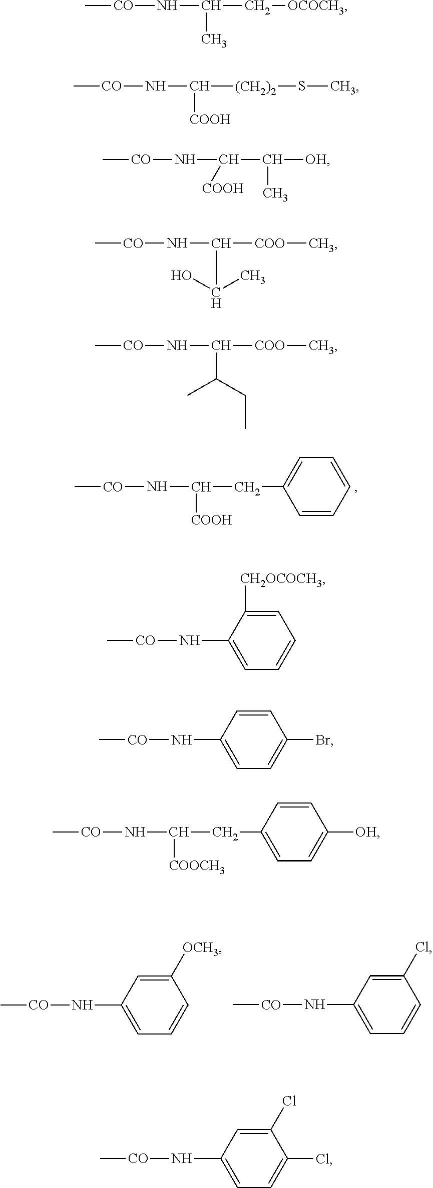 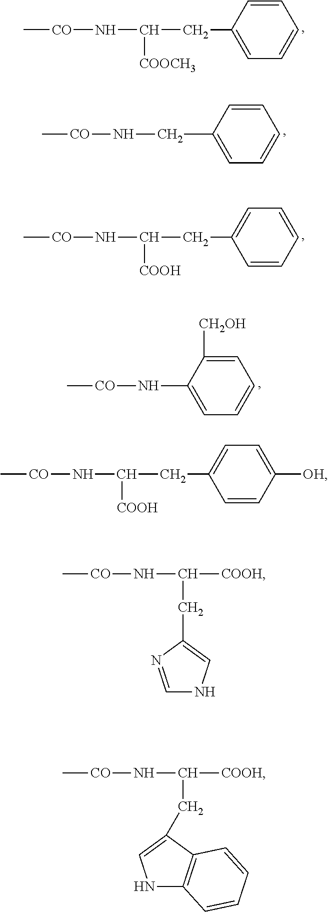
wherein R₂ in formula 3 is selected from the group consisting of
—OH, —OCH₃, —OCO—CH₂—(CH₂)₉—CH₃, —OCO—CH₂—(CH₂)₁₂—CH₃, —OCO—CH—(CH₃)₃, —OCO—CH₂—CH₂—CH₃, 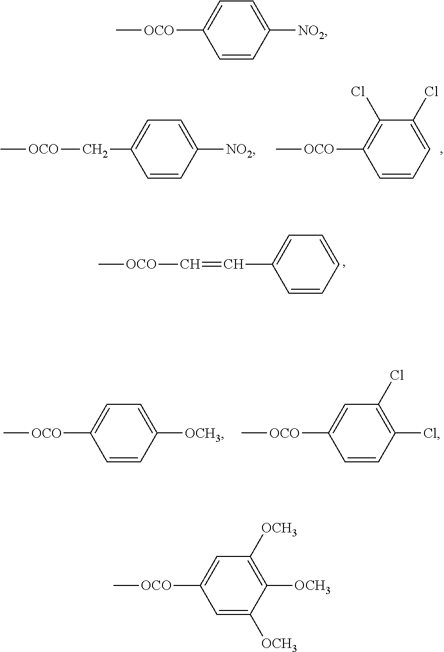
wherein R3 in formula 3 is selected from the group consisting of
—OH, —OCH₃, —OCO—CH₂—(CH₂)₉—CH₃, —OCO—CH₂—(CH₂)₁₃—CH₃, —OCO—CH—(CH₃)₃—OCO—CH₂—CH₂—CH₃, 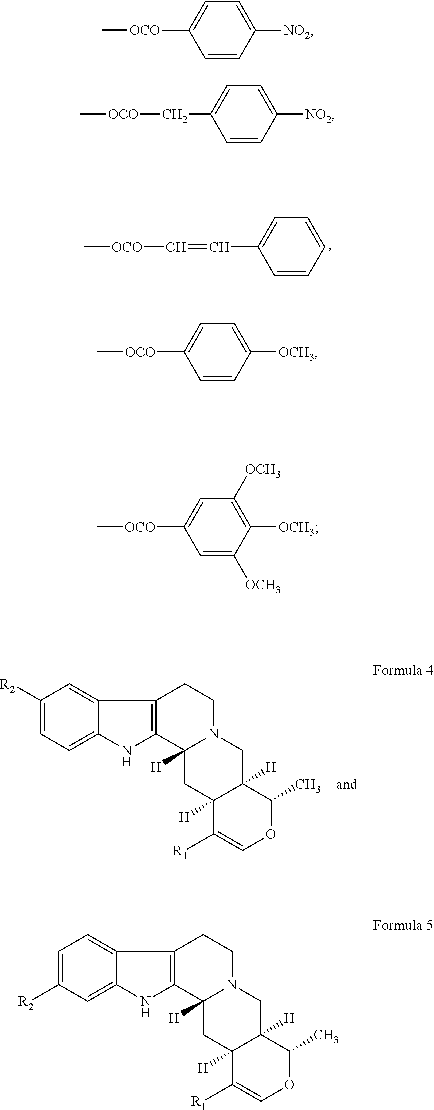
wherein R1 in formulae 4 and 5 is selected from the group consisting of
—COOCH₃, —COOH, —CO—NH—CH₂—(CH₂)₆—CH₃, —CO—NH—CH₂—CH₂—CH₃, —COO—CH₂—(CH₂)₄—CH₃, —COO—CH₂—CH₂—CH₂—CH₃, —COO—CH₂—CH₂—CH₂—CH₂—CH₃, —COO—CH—(CH₃)₃, —CO—NH—CH₂—COOH, —CO—NH—CH₂—CH₂—OCOCH₃, —CO—NH—CH₂—CH₂—OH, —CO—NH—CH₂—COO—CH₃, 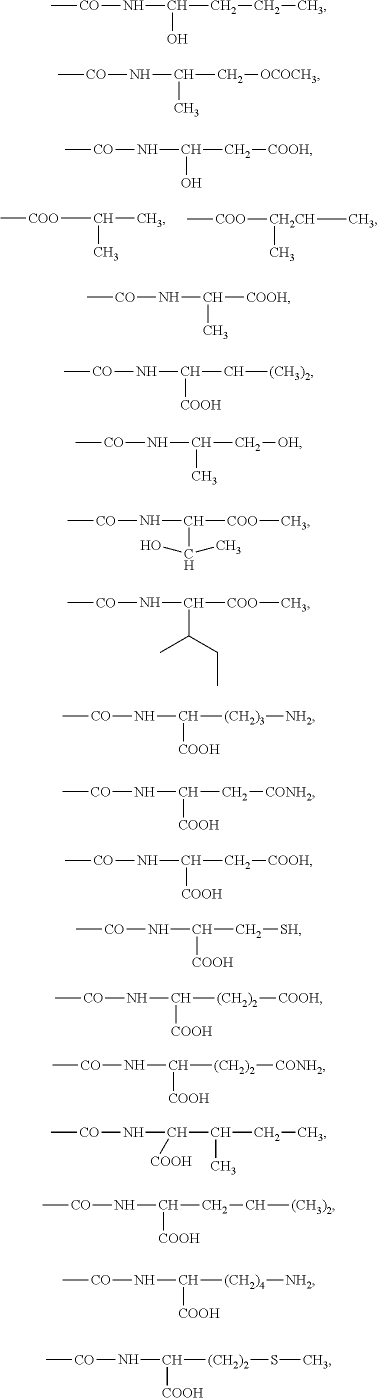 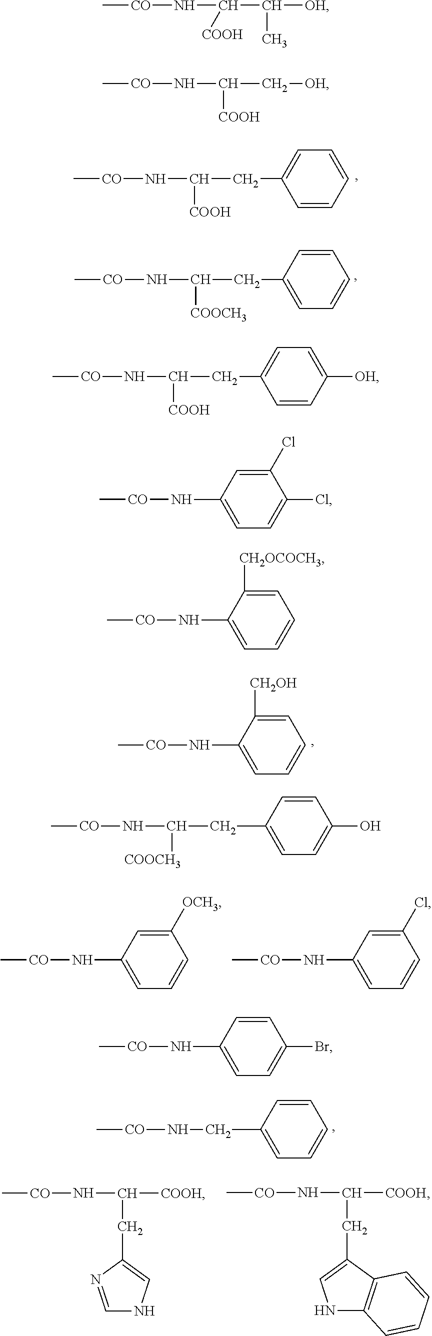
wherein R2 in formulae 4 and 5 is selected from the group consisting of
—OH, —OCH₃, —OCO—CH₂—CH₂—CH₃, —OCO—CH₂—(CH₂)₉—CH₃, —OCO—CH₂—(CH₂)₁₃—CH₃, —OCO—CH—(CH₃)₃,

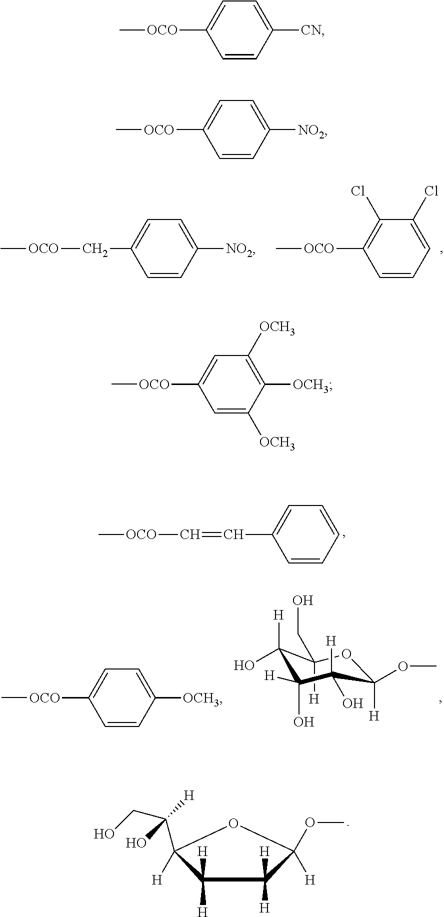

3. A compound of general formula 1 predicted and tested for antipsychotic activity by the method as claimed in claim 1 is representated by: 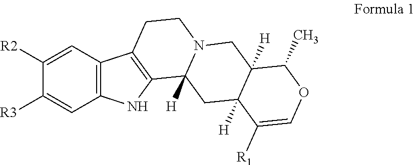
wherein R1=COOCH3(methyl ester);
R2=H, OH, OCH3, OCH2CH2CH3, 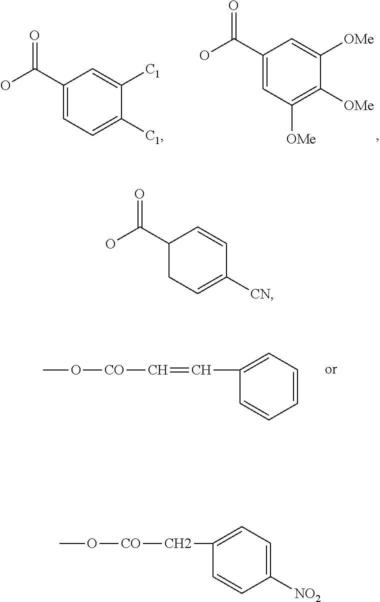
R3=H, OCO(CH2)10CH3, OCO(CH2)14CH3, OCO(CH)(CH3)3,

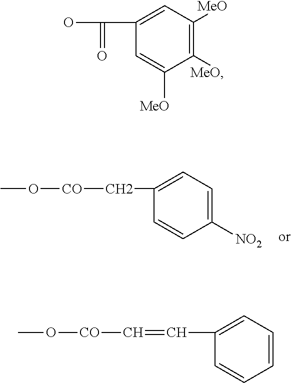

4. The method as claimed in claim 3, wherein the predicted log(nM) IC50 value of the compounds of general formula 1 is in the range of 3.154 to 4.589 showing antipsychotic activity and drug likeness similar to Clozapine.

5. The method as claimed in step (i) of claim 1, wherein training sets descriptors are selected from the group consisting of atom Count (all atoms), Bond Count (all bonds), Formal Charge, Conformation Minimum Energy (kcal/mole), Connectivity Index (order 0, standard), Dipole Moment (debye), Dipole Vector (debye), Electron Affinity (eV), Dielectric Energy (kcal/mole), Steric Energy (kcal/mole), Total Energy (Hartree), Group Count (aldehyde), Heat of Formation (kcal/mole), highest occupied molecular orbital (HOMO) Energy (eV), Ionization Potential (eV), Lambda Max Visible (nm), Lambda Max UV-Visible (nm), Log PLUMO Energy (eV), Molar Refractivity, Molecular Weight Polarizability, Ring Count (all rings), Size of Smallest Ring, Size of Largest Ring, Shape Index (basic kappa, order 1) and Solvent Accessibility Surface Area (angstrom square).

6. The method as claimed in step (i) of claim 1, wherein known antipsychotic drugs are selected from the group consisting of Bepridil, Cisapride, Citalopram, Desipramine, Dolasetron, Droperidol, E-4031, Flecainide, Fluoxetine, Granisetron, Haloperidol, Imipramine, Mesoridazine, Prazosin, Quetiapine, Risperidone, Gatifloxacin, Terazosin, Thioridazine, Vesnarinone, Mefloquine, Sparfloxacin, Ziprasidone, Norastemizole, Tamsulosinc levofloxacin, Moxifloxacin, Cocaine, Clozapine, Doxazosin.

7. The method as claimed in step (ii) of claim 1, wherein antipsychotic targets are selected from Dopamine D2 and Serotonin (5HT_{2A}) receptors.

8. The method as claimed in step (v) of claim 1, wherein the risk assessment includes mutagenicity, tumorogenicity, irritation and reproductive toxicity.

9. The method as claimed in step (v) of claim 1, wherein physiochemical properties are ClogP, solubility, drug likeness and drug score.

10. The method as claimed in claim 1, wherein test compounds show >60% inhibition in amphetamine induced hyperactivity mice model at 25 mg/kg.
